(19) United States
(12) Patent Application Publication
(10) Pub. No.: US 2024/0073842 A1
(43) Pub. Date: Feb. 29, 2024

(54) METHOD AND DEVICE FOR DETERMINING AND APPLYING TIMING ADVANCE IN COMMUNICATION SYSTEM

(71) Applicant: SAMSUNG ELECTRONICS CO., LTD., Suwon-si (KR)

(72) Inventors: Seho MYUNG, Suwon-si (KR); Jeongho YEO, Suwon-si (KR); Hyunseok RYU, Suwon-si (KR)

(21) Appl. No.: 18/495,349

(22) Filed: Oct. 26, 2023

Related U.S. Application Data
(63) Continuation of application No. PCT/KR2022/007380, filed on May 24, 2022.

(30) Foreign Application Priority Data
May 24, 2021 (KR) 10-2021-0066507

(51) Int. Cl. H04W 56/00; H04B 7/185

(52) U.S. Cl. CPC H04W 56/0045; H04B 7/18513

(57) ABSTRACT

An example method performed by a terminal in a non-terrestrial network (NTN) system may include receiving, from a base station, system information including position information about the base station and information about a common timing advance (TA) offset; determining the distance between the terminal and the base station based on the position information about the base station and position information about the terminal; determining a specific TA offset for the terminal based on the determined distance; determining a TA value on the basis of the common TA offset and the specific TA offset; determining the transmission start time point of a preamble based on the determined TA value; and transmitting the preamble to the base station based on the determined transmission start time point.

### CROSS-REFERENCE TO RELATED APPLICATIONS

This application is a continuation of PCT/KR2022/007380, designating the United States, filed May 24, 2022, in the Korean Intellectual Property Receiving Office, which claims priority to Korean Patent Application No. 10-2021-0066507, filed on May 24, 2021, in the Korean Intellectual Property Office. The contents of each of these applications are incorporated by reference herein in their entireties.

### BACKGROUND

### Field

The disclosure relates to a communication system. Specifically, in a case that a user equipment (UE) transmits or receives a signal to or from a base station through a satellite, correction for time offset may be required due to a long distance between the UE and the satellite. As such, the disclosure provides a method and a device wherein the base station indicates time offset information to the UE, the UE calculates and applies a portion of timing advance, the UE reports timing advance information to the base station, and the UE corrects the time offset by using the indicated information.

### Description of Related Art

5^{th} generation (5G) mobile communication technologies define broad frequency bands to provide higher transmission rates and new services, and can be implemented in “Sub 6 GHz” bands such as 3.5 GHz, and also in “above 6 GHz” bands, which may be referred to as mmWave bands including 28 GHz and 39 GHz. In addition, the implementation of 6^{th} generation 6G mobile communication technologies (e.g., beyond 5G systems) in terahertz bands (e.g., 95 GHz to 3 THz bands) has been proposed in order to achieve transmission rates fifty times faster than 5G mobile communication technologies and ultra-low latencies one-tenth of 5G mobile communication technologies.

Since the beginning of the development of 5G mobile communication technologies, in order to support various services and to satisfy performance requirements in connection with enhanced mobile broadband (eMBB), ultra reliable low latency communications (URLLC), and massive machine-type communications (mMTC), there has been ongoing standardization regarding beamforming and massive multi-input multi-output (MIMO) for mitigating radio-wave path loss and increasing radio-wave transmission distances in mmWave, supporting numerologies (e.g., operating multiple subcarrier spacings (SCSs)) for efficiently utilizing mmWave resources and dynamic operation of slot formats, initial access technologies for supporting multi-beam transmission and broadbands, definition and operation of a bandwidth part (BWP), new channel coding methods such as a low density parity check (LDPC) code for large amount of data transmission and a polar code for highly reliable transmission of control information, layer 2 (L2) pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio (NR)-Unlicensed (U) aimed at system operations conforming to various regulation-related requirements in unlicensed bands, NR UE power saving, non-terrestrial network (NTN), which is UE-satellite direct communication for providing coverage in an area in which communication with terrestrial networks is unavailable, and positioning.

There has also been ongoing standardization in air interface architecture/protocol regarding technologies such as industrial Internet of things (IIoT) for supporting new services through interworking and convergence with other industries, integrated access and backhaul (JAB) for providing a node for network service area expansion by supporting a wireless backhaul link and an access link in an integrated manner, mobility enhancement including conditional handover and dual active protocol stack (DAPS) handover, and two-step random access for simplifying random access procedures (2-step RACH for NR).

There also has been ongoing standardization in system architecture/service regarding a 5G baseline architecture (e.g., service based architecture or service based interface) for combining network functions virtualization (NFV) and software-defined networking (SDN) technologies, and mobile edge computing (MEC) for receiving services based on UE positions.

As 5G mobile communication systems are commercialized, an exponentially increasing number of connected devices will be connected to communication networks, and it is expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Such development of 5G mobile communication systems will serve as a basis for developing new waveforms for providing coverage in terahertz bands of 6G mobile communication technologies, multi-antenna transmission technologies such as full dimensional MIMO (FD-MIMO), array antennas and large-scale antennas, metamaterial-based lenses and antennas for improving coverage of terahertz band signals, high-dimensional space multiplexing technology using orbital angular momentum (OAM), and reconfigurable intelligent surface (RIS), and also full-duplex technologies for increasing frequency efficiency of 6G mobile communication technologies and improving system networks, AI-based communication technologies for implementing system optimization by utilizing satellites and AI from the design stage and internalizing end-to-end AI support functions, and next-generation distributed computing technologies for implementing services at levels of complexity exceeding the limit of UE operation capability by utilizing ultra-high-performance communication and computing resources.

In the late 2010s and 2020s, a drastic reduction in satellite launch costs has resulted in an increase in companies trying to provide communication services through satellites. Accordingly, satellite networks have emerged as next-generation network systems that complement existing terrestrial networks. A satellite network does not provide a user experience comparable to that of a terrestrial network, but has the advantage of being able to provide communication services in areas where it is difficult to establish a terrestrial network or in a disaster situation, and has secured economic feasibility due to the recent rapid decrease in satellite launch costs as noted above. Furthermore, several companies and 3GPP standards organizations are also promoting direct communication between smartphones and satellites.

### SUMMARY

In a case that a UE tries to connect to a base station through a satellite, there may be a large delay time for radio waves to arrive due to long distances of hundreds of kilometers, thousands of kilometers or more between the UE and the satellite, and the satellite and the base station on the ground. The large delay time becomes larger in case of direct communication between the UE and the base station in the terrestrial network. In addition, the delay time is variable over time because the satellite is constantly moving. All UEs have varying latencies with satellites or base stations.

Example embodiments of this disclosure relate to a communication system and specifically provide a method and a device, wherein in a case that a UE transmits or receives a signal to or from a base station through a satellite, the base station indicates a time offset to the UE to correct a time-varying delay time caused by a long distance to the satellite and according to movement of the satellite, and the UE corrects the delay time, based on this. Furthermore, example embodiments of the disclosure provide a method and a device, wherein the UE may calculate a portion of the time offset, based on locations of the UE and the satellite and time information, apply same, and report same to the base station.

According to an example embodiment, a method performed by a UE in a non-terrestrial network (NTN) system may include receiving, from a base station, system information including at least one of position information about the base station and information about a common timing advance (TA) offset, determining a specific TA offset corresponding to a distance between the UE and the base station, determining a TA value, based on at least one of the common TA offset and the specific TA offset, determining a transmission start time point of a preamble, based on the determined TA value, and transmitting the preamble to the base station, based on the determined transmission start time point.

Furthermore, according to an example embodiment, a UE in the NTN system may include a transceiver configured to transmit or receive a signal and a processor connected to the transceiver, wherein the processor is configured to receive, from a base station, system information including at least one of position information about the base station and information about a common TA offset, determine a specific TA offset corresponding to a distance between the UE and the base station, determine a TA value, based on at least one of the common TA offset and the specific TA offset, determine a transmission start time point of a preamble, based on the determined TA value, and transmit the preamble to the base station, based on the determined transmission start time point.

Furthermore, according to an example embodiment, a method performed by a base station in the NTN system may include transmitting, to a UE, system information including at least one of position information about the base station or information about a common timing advance (TA) offset and receiving a preamble from the UE, wherein the preamble may be transmitted to the UE according to a transmission start time point determined, based on a TA value, the transmission start time point may be determined based on at least one of the common TA offset or a specific TA offset with respect to the UE, and the specific TA offset may correspond to a distance between the base station and the UE.

As described above, according to the disclosure, a UE may access a base station through a satellite, the base station may indicate a time offset to the UE, and the UE may calculate and correct the time offset, thereby effectively exchanging a signal between the base station and the UE.

### BRIEF DESCRIPTION OF THE DRAWINGS

The above and/or other aspects of the disclosure will be more apparent by describing certain embodiments of the disclosure with reference to the accompanying drawings, in which:

FIG. 1 is a diagram illustrating a basic structure of a time-frequency domain corresponding to a radio resource domain in which the data or control channel is transmitted in a downlink or an uplink in an NR system;

FIG. 2 is a diagram illustrating a control region in which a downlink control channel is transmitted in a 5G wireless communication system;

FIG. 3 is a diagram illustrating an example in which eMBB, URLLC, and mMTC data are allocated in an entire system frequency band;

FIG. 4A is a diagram illustrating an example in which a system frequency band is divided and eMBB, URLLC, and mMTC data are allocated;

FIG. 4B is a diagram schematically illustrating an example message transferred from a MAC layer to a physical layer on a downlink in a communication system according to various embodiments;

FIG. 4C is a diagram schematically illustrating an example message transferred from a MAC layer to a physical layer on an uplink in a communication system according to various embodiments;

FIG. 5 is a diagram illustrating an example process in which one transport block is divided into multiple code blocks and a CRC is added;

FIG. 6 is a diagram illustrating that a synchronization signal (SS) and a physical broadcast channel (PBCH) in an NR system are mapped to frequency and time domains;

FIG. 7 is a diagram illustrating symbols on which an SS/PBCH block may be transmitted according to subcarrier spacings;

FIG. 8 is a diagram illustrating user equipment (UE) processing time according to timing advance when a UE receives a first signal and transmits a second signal in response thereto, in the 5G or NR system;

FIG. 9 is a diagram illustrating an example of scheduling multiple pieces of data (e.g., TBs) according to slots and transmitting the data, receiving a HARQ-ACK feedback with respect to the data, and performing retransmission according to the feedback, in a 5G system;

FIG. 10 is a diagram illustrating an example communication system using a satellite;

FIG. 11 is a diagram illustrating a revolution period of a communication satellite around the earth according to an altitude or height of the satellite;

FIG. 12 is a diagram illustrating a concept of a satellite-UE direct communication;

FIG. 13 is a diagram illustrating a utilization scenario of a satellite-UE direct communication;

FIG. 14 is a diagram illustrating an example of calculating an expected data rate (or throughput) in an uplink when an LEO satellite at an altitude of 1200 km and a UE on the ground perform direct communication;

FIG. 15 is a diagram illustrating an example of calculating an expected data rate (or throughput) in an uplink when a GEO satellite at an altitude of 35,786 km and a UE on the ground perform direct communication;

FIG. 16 is a diagram illustrating a path loss value according to a path loss model between a UE and a satellite, and a path loss according to a path loss model between the UE and a terrestrial network communication base station;

FIG. 17 is a diagram illustrating equations and results for calculating an amount of Doppler shift experienced by a signal which is transmitted from a satellite is received by a user of a UE on the ground according to an altitude and a location of the satellite, and a location of the user of the UE on the ground;

FIG. 18 is a diagram illustrating a speed of a satellite calculated at an altitude of the satellite;

FIG. 19 is a diagram illustrating Doppler shift experienced by different UEs in one beam transmitted by a satellite to the ground;

FIG. 20 is a diagram illustrating a difference in Doppler shift which occurs within one beam according to a location of a satellite determined from an elevation angle;

FIG. 21 is a diagram illustrating a delay time taken from a UE to a satellite and a round trip delay time among the UE, the satellite, and a base station according to a location of the satellite determined according to an elevation angle;

FIG. 22 is a diagram illustrating a maximum difference value of round trip delay times which varies according to a location of a user within one beam;

FIG. 23 is a diagram illustrating an example information structure of an RAR;

FIG. 24 is a diagram illustrating an example relationship between a PRACH preamble configuration resource and an RAR reception time point in an LTE system;

FIG. 25 is a diagram illustrating an example relationship between a PRACH preamble configuration resource and an RAR reception time point in a 5G NR system;

FIG. 26 is a diagram illustrating an example downlink frame timing and uplink frame timing in a UE;

FIG. 27A is a diagram illustrating an example continuous movement of a satellite with respect to a UE located on the ground or on the earth as the satellite revolves around the earth along a satellite orbit;

FIG. 27B is a diagram illustrating an example structure of an artificial satellite;

FIG. 27C is a diagram illustrating an example process in which a UE determines from an initial access;

FIG. 27D is a diagram illustrating an example process in which a UE determines N_{TA}, N_{TA,UE-specific}, and N_{TA,common} from an initial access, according to various embodiments;

FIG. 28 is a diagram illustrating an example initial access procedure of a UE according to various embodiments;

FIG. 29 is a diagram illustrating an example initial access procedure of a UE according to various embodiments;

FIG. 30A is a diagram illustrating an example operation of a base station for TA value report of a UE;

FIG. 30B is a diagram illustrating an example operation of a UE for TA value report of the UE;

FIG. 31 is a diagram illustrating an example of a difference of propagation delay between a terrestrial network and a satellite network;

FIG. 32 is a block diagram illustrating an internal structure of an example UE according to various embodiments;

FIG. 33 is a block diagram illustrating an internal structure of an example satellite according to various embodiments; and

FIG. 34 is a block diagram illustrating an internal structure of an example base station according to various embodiments.

### DETAILED DESCRIPTION

A new radio (NR) access technology which corresponds to a new 5G communication is designed so that various services are freely multiplexed in time and frequency resources, and accordingly waveform/numerology, a reference signal, etc. may be dynamically or freely allocated as necessary in the services. In order to provide an optimal service to a User Equipment (UE) in wireless communication, optimized data transmission via measurement of an interference amount and a channel quality is important, and therefore accurate channel state measurement is essential. However, unlike 4G communication in which channel and interference characteristics do not change significantly according to frequency resources, in the case of a 5G channel, channel and interference characteristics vary significantly depending on services, and it is thus necessary to support a subset of a frequency resource group (FRG) level, which enables measurement by division. In the NR system, types of supported services may be categorized into enhanced mobile broadband (eMBB), massive machine type communications (MMTC), ultra-reliable and low-latency communications (URLLC), and the like. eMBB may, for example, correspond to a service aiming for high-speed transmission of high-capacity data, mMTC is, for example, a service aiming for minimizing terminal power and accessing multiple terminals, and URLLC is, for example, a service aiming for high reliability and low latency. Different requirements may be applied depending on types of services applied to the terminal.

As such, multiple services may be provided to users in the communication system, and, in order to provide multiple services to users, there are required a method for providing the services in the same time interval suitable for characteristics thereof and a device using the method.

Hereinafter, embodiments of the disclosure will be described in detail with reference to the accompanying drawings.

In describing the embodiments, descriptions related to technical contents well-known in the art and not associated directly with the disclosure will be omitted. Such an omission of unnecessary descriptions is intended to prevent obscuring of the main idea of the disclosure and more clearly transfer the main idea.

For the same reason, in the accompanying drawings, some elements may be exaggerated, omitted, or schematically illustrated. Further, the size of each element does not necessarily reflect the actual size. In the drawings, identical or corresponding elements are provided with identical reference numerals.

The advantages and features of the disclosure and ways to achieve them will be apparent by making reference to embodiments as described below in detail in conjunction with the accompanying drawings. However, the disclosure is not limited to the embodiments set forth below, but may be implemented in various different forms. The following embodiments are provided only to completely disclose the disclosure and inform those skilled in the art of the scope of the disclosure, and the disclosure is defined only by the scope of the appended claims. Throughout the specification, the same or like reference numerals designate the same or like elements.

Herein, it will be understood that each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or non-transitory computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of operational steps to be performed on the computer or other programmable apparatus to produce a computer implemented process such that the instructions that execute on the computer or other programmable apparatus provide steps for implementing the functions specified in the flowchart block or blocks.

Furthermore, each block of the flowchart illustrations may represent a module, segment, or portion of code, which includes one or more executable instructions for implementing the specified logical function(s). It should also be noted that, in some alternative implementations, the functions noted in the blocks may occur in a different order. For example, two blocks shown in succession may in fact be executed substantially concurrently or the blocks may sometimes be executed in the reverse order, depending upon the functionality involved.

As used in embodiments of the disclosure, the “unit” refers to a software element or a hardware element, or a combination of both, such as a Field Programmable Gate Array (FPGA) or an Application Specific Integrated Circuit (ASIC), which performs a predetermined function. However, “unit” does not always have a meaning limited to software or hardware. A “unit” may be constructed either to be stored in an addressable storage medium or to execute one or more processors. Therefore, “unit” may include, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the “unit” may be either combined into a smaller number of elements, or a “unit”, or divided into a larger number of elements, or a “unit”. Moreover, the elements and “units” may be implemented to reproduce one or more CPUs within a device or a security multimedia card. Furthermore, the “unit” in the embodiments may include one or more processors (including, for example, processing circuitry).

A wireless communication system is advancing to a broadband wireless communication system for providing high-speed and high-quality packet data services using communication standards, such as high-speed packet access (HSPA) of 3GPP, LTE {long-term evolution or evolved universal terrestrial radio access (E-UTRA)}, LTE-Advanced (LTE-A), LTE-Pro, high-rate packet data (HRPD) of 3GPP2, ultra-mobile broadband (UMB), IEEE 802.16e, and the like, as well as typical voice-based services. Furthermore, as 5th generation (5G) wireless communication systems, 5G or new radio (NR) communication standards are under development.

As a typical example of the broadband wireless communication system, an NR system employs an orthogonal frequency division multiplexing (OFDM) scheme in a downlink (DL) and an uplink (UL). More specifically, however, the NR system employs a cyclic-prefix OFDM (CP-OFDM) scheme in a downlink and employs both the CP-OFDM scheme and a discrete Fourier transform spreading OFDM (DFT-S-OFDM) scheme in an uplink. The uplink may refer, for example, to a radio link through which a user equipment (UE) {or a mobile station (MS)} transmits data or control signals to a base station (BS) (eNode B), and the downlink may refer, for example, to a radio link through which the base station transmits data or control signals to the UE. The above multiple access scheme separates data or control information of respective users by allocating and operating time-frequency resources for transmitting the data or control information for each user to avoid overlapping each other, that is, to establish orthogonality.

The NR system adopts a hybrid automatic repeat request (HARQ) scheme which retransmits corresponding data in a physical layer, if a decoding failure occurs in initial transmission. In the HARQ scheme, in a case that a receiver fails to correctly decode the data, the receiver transmits information (negative acknowledgment (NACK)) notifying of the decoding failure to a transmitter to enable the transmitter to retransmit the data in the physical layer. The receiver improves data reception performance, by combining data, which is retransmitted by the transmitter, with the existing data for which decoding has failed. In addition, if the receiver correctly decodes the data, the receiver may transmit information (acknowledgment (ACK)) notifying of a success of decoding to the transmitter to enable the transmitter to transmit new data.

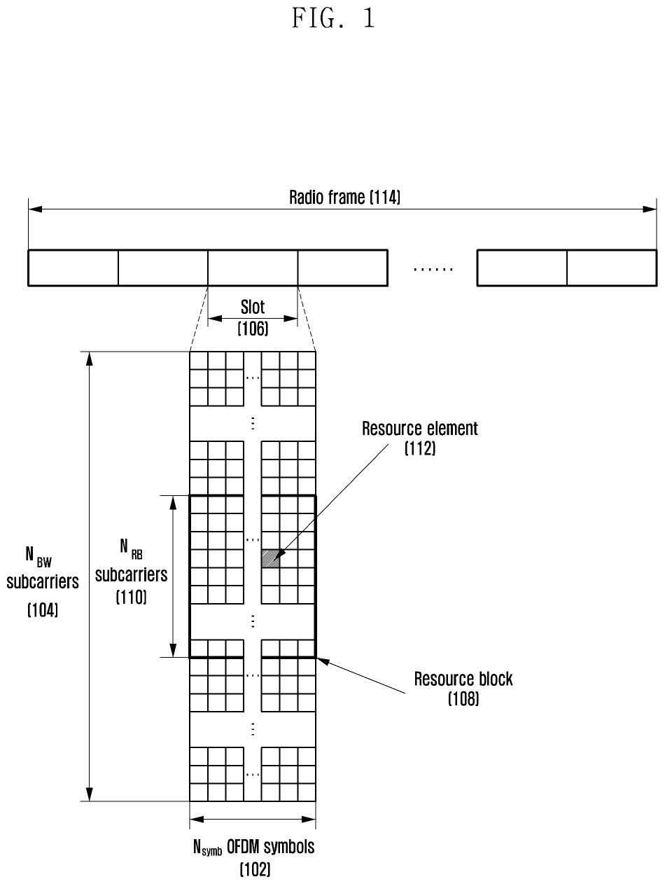

FIG. 1 is a diagram illustrating a basic structure of a time-frequency domain corresponding to a radio resource domain in which the data or control channel is transmitted in a downlink or an uplink in an NR system.

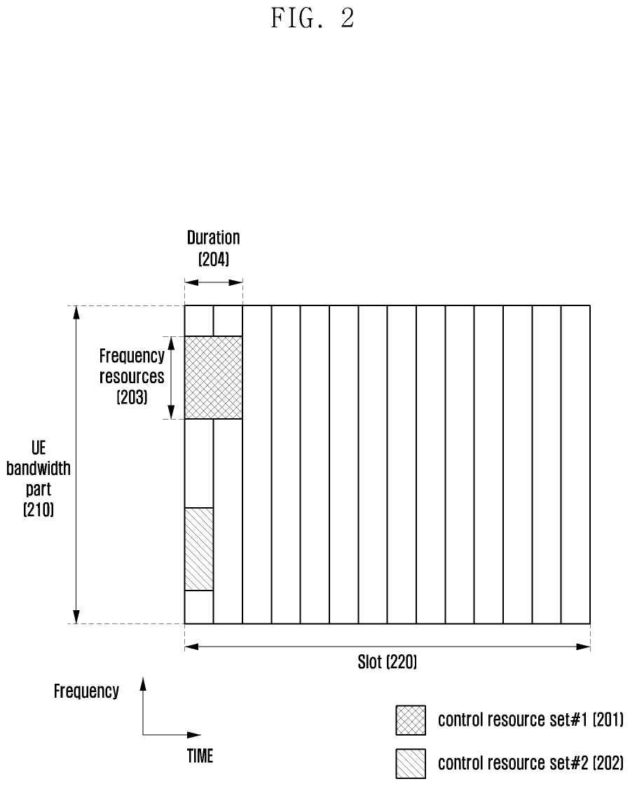

In FIG. 1, the horizontal axis represents a time domain, and the vertical axis represents a frequency domain. A minimum transmission unit in the time domain is an OFDM symbol, and N_{symb} OFDM symbols 102 are gathered to constitute one slot 106. A length of a subframe is defined to be 1.0 ms, and a length of a radio frame 114 is defined to be 10 ms. A minimum transmission unit in the frequency domain is a subcarrier, and a bandwidth of an entire system transmission bandwidth includes a total of N_{B}w subcarriers 104. One frame may be defined as 10 ms. One subframe may be defined as 1 ms, and thus, one frame may include a total of 10 subframes. One slot may be defined as 14 OFDM symbols (that is, the number of symbols per slot (N_{symb}^{slot})=14). One subframe may include one or more slots, and the number of the slots included in one subframe may vary according to p which is a subcarrier spacing configuration value. An example of FIG. 2 shows a case in which the subcarrier spacing configuration value corresponds to p=0 and a case in which the subcarrier spacing configuration value corresponds to p=1. In the case that p=0, one subframe may constitute one slot, and in case that p=1, two slots may constitute one subframe. That is, the number (Nₛₗₒₜ^{subframe,μ}) of slots per subframe may vary according to the configuration value p for subcarrier spacing, and accordingly, the number (Nₛₗₒₜ^{frame,μ}) of slots per frame may also vary. Nₛₗₒₜ^{subframe,μ} and Nₛₗₒₜ^{frame,μ} according to each subcarrier spacing configuration p may be defined as shown in Table 1 below.

TABLE 1

| μ | N_{symb}^{slot} | Nₛₗₒₜ^{frame, μ} | Nₛₗₒₜ^{subframe, μ} |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

The UE before the radio resource control (RRC) connection may receive a configuration of an initial bandwidth part (initial BWP) for initial access from the base station through a master information block (MIB). More specifically, the UE may receive configuration information for a search space and a control region (control resource set (CORESET)) in which a physical downlink Control Channel (PDCCH) for receiving system information (possibly corresponding to remaining system information (RMSI) or system information block 1 (SIB1)) required for initial access through the MIB may be transmitted in an initial access step. Each of the control region and the search space configured through the MIB may be considered as an identity (ID) 0. The base station may inform the UE of configuration information such as frequency allocation information for control region #0, time allocation information, numerology, and the like through the MIB. Furthermore, the base station may inform the UE of configuration information for a monitoring period and an occasion of control region #0, that is, configuration information for search space #0 through the MIB. The UE may consider a frequency region configured as control region #0 acquired from the MIB as an initial bandwidth part for initial access. Here, the ID of the initial BWP may be considered as 0. The MIB may include information as described below.

[74] -- ASN1START
[75] -- TAG-MIB-START
[76] MIB ::= SEQUENCE {
[77] systemFrameNumber BIT STRING (SIZE (6)),
[78] subCarrierSpacingCommon ENUMERATED {scs15or60,
scs30or120},
[79] ssb-SubcarrierOffset INTEGER (0..15),
[80] dmrs-TypeA-Position ENUMERATED {pos2, pos3},
[81] pdcch-ConfigSIB1 PDCCH-ConfigSIB1,
[82] cellBarred ENUMERATED {barred,
notBarred},
[83] intraFreqReselection ENUMERATED {allowed,
notAllowed},
[84] spare BIT STRING (SIZE (1))
[85] }
[86] -- TAG-MIB-STOP
[87] -- ASNISTOP

MIB Field Descriptions
cellBarred

Value barred means that the cell is barred, as defined in TS 38.304 [20].
dmrs-TypeA-Position

Position of (first) DM-RS for downlink (see TS 38.211 [16], clause 7.4.1.1.2) and uplink (see TS 38.211 [16], clause 6.4.1.1.3).
intraFreqReselection

Controls cell selection/reselection to intra-frequency cells when the highest ranked cell is barred, or treated as barred by the UE, as specified in TS 38.304 [20].
pdcch-ConfigSIB1

Determines a common ControlResourceSet (CORESET), a common search space and necessary PDCCH parameters. If the field ssb-SubcarrierOffset indicates that SIB1 is absent, the field pdcch-ConfigSIB1 indicates the frequency positions where the UE may find SS/PBCH block with SIB1 or the frequency range where the network does not provide SS/PBCH block with SIB1 (see TS 38.213 [13], clause 13).
ssb-SubcarrierOffset

Corresponds to kSSB (see TS 38.213 [13]), which is the frequency domain offset between SSB and the overall resource block grid in number of subcarriers. (See TS 38.211 [16], clause 7.4.3.1).

The value range of this field may be extended by an additional most significant bit encoded within PBCH as specified in TS 38.213 [13].

This field may indicate that this cell does not provide SIB1 and that there is hence no CORESET #0 configured in MIB (see TS 38.213 [13], clause 13). In this case, the field pdcch-ConfigSIB1 may indicate the frequency positions where the UE may (not) find a SS/PBCH with a control resource set and search space for SIB1 (see TS 38.213 [13], clause 13).
subCarrierSpacingCommon

Subcarrier spacing for SIB1, Msg.2/4 for initial access, paging and broadcast SI-messages. If the UE acquires this MIB on an FR1 carrier frequency, the value scs15or60 corresponds to 15 kHz and the value scs30or120 corresponds to 30 kHz. If the UE acquires this MIB on an FR2 carrier frequency, the value scs15or60 corresponds to 60 kHz and the value scs30or120 corresponds to 120 kHz.
systemFrameNumber

The 6 most significant bits (MSB) of the 10-bit System Frame Number (SFN). The 4 LSB of the SFN are conveyed in the PBCH transport block as part of channel coding (i.e., outside the MIB encoding), as defined in clause 7.1 in TS 38.212 [17].

In a method for configuring the bandwidth part, UEs before the RRC connection may receive configuration information for an initial bandwidth part through an MIB in an initial access step. More specifically, the UE may receive a configuration of a control region for a downlink control channel in which downlink control information (DCI) for scheduling an SIB may be transmitted from an MIB of a physical broadcast channel (PBCH). Here, a bandwidth of the control region configured as the MIB may be considered as an initial bandwidth part, and the UE may receive a physical downlink shared channel (PDSCH), in which the SIB is transmitted, through the configured initial bandwidth part. The initial bandwidth part may be used not only for reception of the SIB but also used for other system information (OSI), paging, or random access.

In a case that one or more bandwidth parts are configured in the UE, the base station may indicate a change in the bandwidth parts to the UE through a bandwidth part indicator field within the DCI.

A basic unit of a resource in the time-frequency domain is a resource element (RE) 112 and may be represented by an OFDM symbol index and a subcarrier index. A resource block (RB) (or physical resource block (PRB)) 108 is defined as N_{RB} consecutive subcarriers 110 in the frequency domain. In general, a minimum transmission unit of data is the RB unit. In the NR system, in general, N_{symb}=14, N_{RB}=12, and N_{BW} is proportional to a bandwidth of a system transmission band. A data rate may increase in proportion to the number of RBs scheduled for a UE.

In the NR system, in a case of an FDD system that operates by dividing a downlink and an uplink according to frequency, a downlink transmission bandwidth and an uplink transmission bandwidth may be different from each other. A channel bandwidth indicates an RF bandwidth corresponding to a system transmission bandwidth. Table 2 and Table 3 show parts of correspondence relationships between a channel bandwidth, subcarrier spacing, and a system transmission bandwidth defined in the NR system in a frequency band lower than 6 GHz and a frequency band higher than 6 GHz, respectively. For example, in the NR system having a channel bandwidth of 100 MHz with a subcarrier spacing of 30 kHz, a transmission bandwidth includes 273 RBs. In a description below, N/A may be a bandwidth-subcarrier combination that is not supported by the NR system.

TABLE 2

| | 5 | 10 | 15 | 20 | 25 | 30 | 40 | 50 | 60 | 80 | 90 | 100 |
|---|---|---|---|---|---|---|---|---|---|---|---|---|
| SCS | MHz | MHz | MHz | MHz | MHz | MHz | MHz | MHz | MHz | MHz | MHz | MHz |
| (kHz) | N_{RB} | N_{RB} | N_{RB} | N_{RB} | N_{RB} | N_{RB} | N_{RB} | N_{RB} | N_{RB} | N_{RB} | N_{RB} | N_{RB} |
| 15 | 25 | 52 | 79 | 106 | 133 | 160 | 216 | 270 | N/A | N/A | N/A | N/A |
| 30 | 11 | 24 | 38 | 51 | 65 | 78 | 106 | 133 | 162 | 217 | 245 | 273 |
| 60 | N/A | 11 | 18 | 24 | 31 | 38 | 51 | 65 | 79 | 107 | 121 | 135 |

TABLE 3

| Channel | | | | | |
|---|---|---|---|---|---|
| bandwidth | | | | | |
| BW_{Channel} | Subcarrier | | | | |
| [MHz] | width | 50 MHZ | 100 MHZ | 200 MHZ | 400 MHZ |
| Transmission | 60 kHz | 66 | 132 | 264 | N/A |
| bandwidth | | | | | |
| configuration | 120 kHz | 32 | 66 | 132 | 264 |
| N_{R}B | | | | | |

FR1 and FR2m, which are frequency ranges in the NR system, may be separately defined as Table 4 below.

TABLE 4

| Frequency range designation | Corresponding frequency range |
|---|---|
| FR1 | 450 MHz-7125 MHz |
| FR2 | 24250 MHz-52600 MHz |

In the above, it may be possible for ranges of FR1 and FR2 to be changed and applied differently. For example, the frequency range of FR1 may be changed from 450 MHz up to 6000 MHz to be applied.

Subsequently, a synchronization signal (SS)/PBCH block in 5G will be described.

An SS/PBCH block may correspond to a physical layer channel block including a primary SS (PSS), a secondary SS (SSS), and a PBCH. A detailed description thereof is given below.
PSS: is a signal which is a reference of downlink time/frequency synchronization and provides partial information of a cell ID.
SSS: is a reference of downlink time/frequency synchronization and provides the remaining cell ID information which is not provided by the PSS. Additionally, the SSS may serve as a reference signal for demodulation of a PBCH.
PBCH: provides essential system information necessary for the UE to transmit and receive a data channel and a control channel. The essential system information may include search space-related control information indicating radio resource mapping information for a control channel and scheduling control information for a separate data channel for transmitting system information.
SS/PBCH block: includes a combination of PSS, SSS, and PBCH. One or multiple SS/PBCH blocks may be transmitted within a time of 5 ms, and each of the transmitted SS/PBCH blocks may be distinguished with an index.

The UE may detect the PSS and the SSS in an initial access stage and decode the PBCH. The UE may acquire an MIB from the PBCH and receive a configuration of control region #0 (possibly corresponding to a control region having control region index 0) therefrom. The UE may perform monitoring on control region #0, assuming that the selected SS/PBCH block and the demodulation reference signal (DMRS) transmitted in control region #0 are quasi-co-located (QCLed). The UE may receive system information through downlink control information transmitted in control region #0. The UE may acquire configuration information related to a random access channel (RACH) required for initial access from the received system information. The UE may transmit a physical RACH (PRACH) to the base station in consideration of the selected SS/PBCH block index, and the base station having received the PRACH may acquire information for the SS/PBCH block index selected by the UE. Through this process, the base station may know which block has been selected by the UE from among the SS/PBCH blocks and that control region #0 related thereto is monitored.

Next, downlink control information (DCI) in the 5G system will be described in detail.

In the 5G system, scheduling information on uplink data (or a physical uplink shared channel (PUSCH)) or downlink data (or a physical downlink shared channel (PDSCH)) is transferred through DCI from the base station to the UE. The UE may monitor a fallback DCI format and a non-fallback DCI format for the PUSCH or the PDSCH. The fallback DCI format may be configured with a fixed field pre-defined between the base station and the UE, and the non-fallback DCI format may include a configurable field. The DCI may include other various formats and, it may be known whether the DCI is one for power control or one for slot format indicator (SFI) depending on the format.

DCI may be transmitted through the PDCCH, which is a physical downlink control channel, via channel coding and modulation. A cyclic redundancy check (CRC) may be attached to a DCI message payload, and the CRC may be scrambled by a radio network temporary identifier (RNTI) corresponding to the identity of the UE. Different types of RNTIs may be used according to the purpose of a DCI message, for example, UE-specific (UE-specific) data transmission, a power control command, a random access response, or the like. That is, an RNTI may not be explicitly transmitted, and may be transmitted after being included in a CRC calculation process. If the UE has received a DCI message transmitted on a PDCCH, the UE may identify a CRC using an allocated RNTI, and if a CRC identification result is correct, the UE may identify that the message has been transmitted to the UE. The PDCCH is mapped and transmitted in a control resource set (CORESET) configured in the UE.

For example, DCI scheduling the PDSCH for system information (SI) may be scrambled by a SI-RNTI. DCI scheduling the PDSCH for a random access response (RAR) message may be scrambled by an RA-RNTI. DCI scheduling the PDSCH for a paging message may be scrambled by a P-RNTI. DCI notifying of a slot format indicator (SFI) may be scrambled by an SFI-RNTI. DCI notifying of a transmit power control (TPC) may be scrambled by a TPC-RNTI. DCI scheduling a UE-specific PDSCH or PUSCH may be scrambled by a cell RNTI (C-RNTI).

DCI format 0_0 may be used for fallback DCI scheduling a PUSCH, and in this case, a CRC may be scrambled by a C-RNTI. DCI format 0_0 having a CRC scrambled by a C-RNTI may include, for example, the information below.

TABLE 5
- Identifier for DCI formats - [1] bit
- Frequency domain resource assignment -[┌log₂(N_{RB}^{UL, BWP}(N_{RB}^{UL, BWP} + 1)/2)┐ ] bits
- Time domain resource assignment - X bits
- Frequency hopping flag - 1 bit
- Modulation and coding scheme - 5 bits
- New data indicator - 1 bit
- Redundancy version - 2 bits
- HARQ process number - 4 bits
- Transmit power control (TPC) command for scheduled PUSCH - [2] bits
- Uplink (UL)/supplementary UL (SUL) indicator - 0 or 1 bit

DCI format 0_1 may be used for non-fallback DCI scheduling a PUSCH, and in this case, a CRC may be scrambled by a C-RNTI. DCI format 0_1 having a CRC scrambled by a C-RNTI may include, for example, the information below.

```
TABLE 6
  Carrier indicator - 0 or 3 bits
  UL/SUL indicator - 0 or 1 bit
  Identifier for DCI formats - [1] bits
  Bandwidth part indicator - 0, 1 or 2 bits
  Frequency domain resource assignment
For resource allocation type 0, ┌N_{RB}^{UL,BWP}/P┐ bits
For resource allocation type 1, ┌log₂(N_{RB}^{UL,BWP}(N_{RB}^{UL,BWP} + 1)/2)┐ bits
  Time domain resource assignment - 1, 2, 3, or 4 bits
  Virtual resource block (VRB)-to- physical resource block (PRB)
mapping) - 0 or 1 bit, only for resource allocation type 1.
0 bit if only resource allocation type 0 is configured;
1 bit otherwise.
  Frequency hopping flag - 0 or 1 bit, only for resource allocation
  type 1.
0 bit if only resource allocation type 0 is configured;
1 bit otherwise.
  Modulation and coding scheme - 5 bits
  New data indicator - 1 bit
  Redundancy version - 2 bits
  HARQ process number - 4 bits
  1st downlink assignment index - 1 or 2 bits
1 bit for semi-static HARQ-ACK codebook;
2 bits for dynamic HARQ-ACK codebook with single
HARQ-ACK codebook.
  2nd downlink assignment index - 0 or 2 bits
2 bits for dynamic HARQ-ACK codebook with two HARQ-ACK
sub-codebooks;
0 bit otherwise.
  TPC command for scheduled PUSCH - 2 bits
    $SRS resource indicator ⌈ log ( {\sum }_{k = 1}^{{t}_{max}} ( \begin{matrix}{N}_{SRS} \\ k\end{matrix} ) ) ⌉ or ⌈ {log}_{2} ( {N}_{SRS} ) ⌉ bits$
$⌈ log ( {\sum }_{k = 1}^{{L}_{max}} ( \begin{matrix}{N}_{SRS} \\ k\end{matrix} ) ) ⌉ bits for non - codebook based PUSCH$
transmission;
  ┌log₂(N_{SRS})┐ bits for codebook based PUSCH transmission.
  Precoding information and number of layers -up to 6 bits
  Antenna ports - up to 5 bits
  SRS request - 2 bits
  Channel state information (CSI) request - 0, 1, 2, 3, 4, 5, or 6 bits
  Code block group (CBG) transmission information - 0, 2, 4, 6, or
  8 bits
  Phase tracking reference signal (PTRS)-demodulation reference
signal (DMRS) association - 0 or 2 bits.
  beta_offset indicator - 0 or 2 bits
  DMRS sequence initialization - 0 or 1 bit
```

DCI format 10 may be used for fallback DCI scheduling a PDSCH, and in this case, a CRC may be scrambled by a C-RNTI. DCI format 1_0 having a CRC scrambled by a C-RNTI may include, for example, the information below.

TABLE 7
- Identifier for DCI formats - [1] bit
- Frequency domain resource assignment -[ ┌ log₂(N_{RB}^{DL, BWP}(N_{RB}^{DL, BWP} + 1)/2 ┐ ] bits
- Time domain resource assignment - X bits
- VRB-to-PRB mapping - 1 bit.
- Modulation and coding scheme - 5 bits
- New data indicator - 1 bit
- Redundancy version - 2 bits
- HARQ process number - 4 bits
- Downlink assignment index - 2 bits
- TPC command for scheduled PUCCH - [2] bits
- Physical uplink control channel (PUCCH) resource indicator - 3 bits
- PDSCH-to-HARQ feedback timing indicator - [3] bits

DCI format 1_1 may be used for non-fallback DCI scheduling a PDSCH, and in this case, a CRC may be scrambled by a C-RNTI. DCI format 1_1 having a CRC scrambled by a C-RNTI may include, for example, the information below.

TABLE 8
- Carrier indicator - 0 or 3 bits
- Identifier for DCI formats - [1] bits
- Bandwidth part indicator - 0, 1 or 2 bits
- Frequency domain resource assignment

•For resource allocation type 0, ┌ N_{RB}^{DL, BWP}/P ┐ bits
•For resource allocation type 1, ┌ log₂(N_{RB}^{DL, BWP}(N_{RB}^{DL, BWP} + 1)/2 ┐ bits

- Time domain resource assignment -1, 2, 3, or 4 bits
- VRB-to-PRB mapping - 0 or 1 bit, only for resource allocation type 1.

•0 bit if only resource allocation type 0 is configured;
•1 bit otherwise.

- Physical resource block (PRB) bundling size indicator - 0 or 1 bit
- Rate matching indicator - 0, 1, or 2 bits
- Zero power (ZP) channel state information (CSI)-reference signal (RS) trigger - 0, 1, or 2 bits
For transport block 1:
- Modulation and coding scheme - 5 bits
- New data indicator - 1 bit
- Redundancy version - 2 bits
For transport block 2:
- Modulation and coding scheme - 5 bits
- New data indicator - 1 bit
- Redundancy version - 2 bits
- HARQ process number - 4 bits
- Downlink assignment index - 0 or 2 or 4 bits
- TPC command for scheduled PUCCH - 2 bits
- PUCCH resource indicator - 3 bits
- PDSCH-to-HARQ_feedback timing indicator - 3 bits
- Antenna ports - 4, 5 or 6 bits
- Transmission configuration indication - 0 or 3 bits
- SRS request - 2 bits
- CBG transmission information - 0, 2, 4, 6, or 8 bits
- Code block group (CBG) flushing out information - 0 or 1 bit
- DMRS sequence initialization - 1 bit

Hereinafter, a time domain resource allocation method for a data channel in the 5G communication system will be described.

The base station may configure, for the UE via higher layer signaling (e.g., RRC signaling), a table for time domain resource allocation information on a downlink data channel (PDSCH) and an uplink data channel (PUSCH). A table including up to 16 entries (maxNrofDL−Allocations=16) may be configured for the PDSCH, and a table including up to 16 entries (maxNrofUL−Allocations=16) may be configured for the PUSCH. The time domain resource allocation information may include, for example, a PDCCH-to-PDSCH slot timing (corresponding to a time interval in units of slots between a time point at which a PDCCH is received and a time point at which a PDSCH scheduled by the received PDCCH is transmitted, and denoted as K0), a PDCCH-to-PUSCH slot timing (corresponding to a time interval in units of slots between a time point at which a PDCCH is received and a time point at which a PUSCH scheduled by the received PDCCH is transmitted, and denoted as K2), information on a position and length of a start symbol in which the PDSCH or PUSCH is scheduled within a slot, a mapping type of the PDSCH or PUSCH, or the like. For example, information described in Table 9 and Table 10 may be notified to the UE from the base station.

TABLE 9
PDSCH-TimeDomainResourceAllocationList information element

| | | |
|---|---|---|
| PDSCH-TimeDomainResourceAllocationList | ::= SEQUENCE | (SIZE(1..maxNrofDL- |

Allocations)) OF PDSCH-TimeDomainResourceAllocation

| | |
|---|---|
| PDSCH-TimeDomainResourceAllocation ::= | SEQUENCE { |

| | |
|---|---|
| k0 | INTEGER(0..32) |

OPTIONAL, -- Need S
(PDCCH-to-PDSCH timing, slot unit)

| | |
|---|---|
| mappingType | ENUMERATED {typeA, typeB}, |

(PDSCH mapping type)

| | |
|---|---|
| startSymbolAndLength | INTEGER (0..127) |

(Start symbol and length of PDSCH)
}

TABLE 10
PUSCH-TimeDomainResourceAllocation information element

| | | |
|---|---|---|
| PUSCH-TimeDomainResourceAllocationList ::= | SEQUENCE | (SIZE(1..maxNrofUL- |

Allocations)) OF PUSCH-TimeDomainResourceAllocation

| | |
|---|---|
| PUSCH-TimeDomainResourceAllocation ::= | SEQUENCE { |

| | |
|---|---|
| k2 | INTEGER(0..32) |

OPTIONAL, -- Need S
(PDCCH-to-PUSCH timing, slot unit)

| | |
|---|---|
| mappingType | ENUMERATED {typeA, typeB}, |

(PUSCH mapping type)

| | |
|---|---|
| startSymbolAndLength | INTEGER (0..127) |

(Start symbol and length of PUSCH)
}

The base station may notify of one among the entries in the tables for the time domain resource allocation information to the UE via L1 signaling (e.g., DCI) (e.g., the entry may be indicated by a “time domain resource allocation” field in the DCI). The UE may acquire the time domain resource allocation information for the PDSCH or PUSCH, based on the DCI received from the base station.

The downlink control channel in the 5G communication system will be described below in more detail with reference to the drawings.

FIG. 2 is a diagram illustrating an example of a control region in which a downlink control channel is transmitted in a 5G wireless communication system. FIG. 2 illustrates an example in which a UE bandwidth part 210 is configured in the frequency axis and two control regions (control region #1 201 and control region #2 202) are configured within one slot 220 in the time axis. The control regions 201 and 202 may be configured in a specific frequency resource 203 within the entire UE bandwidth part 210 on the frequency axis. The control region may be configured as one or multiple OFDM symbols in the time axis, which may be defined as a control region duration (control resource set duration) 204. Referring to the example illustrated in FIG. 2, control region #1 201 may be configured as a control region duration of 2 symbols, and control region #2 202 may be configured as a control region duration of 1 symbol.

The aforementioned control region in 5G may be configured in the UE by the base station via higher layer signaling (e.g., system information, an MIB, and RRC signaling). Configuring a control region in a UE refers to providing information, such as an identity of the control region, a frequency position of the control region, and a symbol length of the control region. For example, the higher layer signaling may include the information set forth in Table 11 below.

TABLE 11

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(Control region identity)

| | |
|---|---|
| frequency DomainResources | BIT STRING (SIZE |

(45)),
(Frequency-axis source allocation information)

| | |
|---|---|
| duration | INTEGER |

```
(1..maxCoReSetDuration),
  (Time-axis source allocation information)
    cce-REG-MappingType
    CHOICE {
  (CCE-to-REG mapping scheme)
      interleaved
    SEQUENCE {
          reg-BundleSize
    ENUMERATED {n2, n3, n6},
    (REG bundle size)
          precoderGranularity
    ENUMERATED {sameAsREG-bundle, allContiguousRBs},
          interleaverSize
    ENUMERATED {n2, n3, n6}
          (Interleaver size)
          shiftIndex
      INTEGER(0..maxNrofPhysicalResourceBlocks-1)
              OPTIONAL
        (Interleaver shift)
    },
```

| | |
|---|---|
| nonInterleaved | NULL |

```
    },
    tci-StatesPDCCH
    SEQUENCE(SIZE (1..maxNrofTCI-StatesPDCCH)) OF TCI-StateId
          OPTIONAL,
  (QCL configuration information)
```

| | |
|---|---|
| tci-PresentInDCI | ENUMERATED |

{enabled}

| | |
|---|---|
| OPTIONAL, | -- Need S |

}

In Table 11, tci-StatesPDCCH (simply referred to as transmission configuration indication (TCI) state) configuration information may include information for one or more SS/PBCH block indexes QCLed with the DMRS transmitted in a corresponding control region or channel state information reference signal (CSI-RS) index information. For example, each piece of control information included in DCI format 1_1 that is scheduling control information (DL grant) for downlink data may be as follows.
Carrier indicator: indicates which carrier the data scheduled by DCI is transmitted on—0 or 3 bits
Identifier for DCI formats: indicates the DCI format, and, specifically, an indicator for identifying whether the corresponding DCI is for downlink or uplink. —[1] bits
Bandwidth part indicator: indicates a change in bandwidth part, if any—0, 1 or 2 bits
Frequency domain resource assignment: Resource allocation information indicating frequency domain resource allocation. The resource expressed varies depending on whether the resource allocation type is 0 or 1.
Time domain resource assignment: Resource allocation information indicating time domain resource allocation. This may indicate one configuration of a predefined PDSCH time domain resource allocation list or higher layer signaling—1, 2, 3, or 4 bits
VRB-to-PRB mapping: indicates a mapping relationship between the virtual resource block (VRB) and the physical resource block (PRB)—0 or 1 bit
PRB bundling size indicator: indicates the size of physical resource block bundling assuming that the same precoding is applied—0 or 1 bit
Rate matching indicator: indicates which rate match group is applied among the rate match groups configured via a higher layer applied to PDSCH—0, 1, or 2 bits
ZP CSI-RS trigger: triggers the zero power channel state information reference signal—0, 1, or 2 bits
Transport block (TB)-related configuration information: indicates modulation and coding scheme (MCS), new data indicator (NDI), and redundancy version (RV) for one or two TBs.
Modulation and coding scheme (MCS): indicates the coding rate and modulation scheme used for data transmission. That is, this may indicate the coding rate value that may indicate TBS and channel coding information along with information for whether it is QPSK, 16QAM, 64QAM, or 256QAM.
New data indicator: indicates whether HARQ initial transmission or re-transmission.
Redundancy version: indicates the redundancy version of HARQ.
   HARQ process number: indicates HARQ process number applied to PDSCH-4 bits
   Downlink assignment index: An index for generating a dynamic HARQ-ACK codebook when reporting HARQ-ACK for PDSCH-0 or 2 or 4 bits
   TPC command for scheduled PUCCH: Power control information applied to PUCCH for HARQ-ACK report for PDSCH-2 bits
   PUCCH resource indicator: Information indicating the resource of PUCCH for HARQ-ACK report for PDSCH-3 bits
   PDSCH-to-HARQ_feedback timing indicator: Configuration information for the slot in which PUCCH for HARQ-ACK report for PDSCH is transmitted—3 bits
   Antenna ports: Information indicating the antenna port of the PDSCH DMRS and the DMRS CDM group in which the PDSCH is not transmitted—4, 5 or 6 bits
   Transmission configuration indication: Information indicating beam-related information for PDSCH—0 or 3 bits
   SRS request: Information requesting SRS transmission—2 bits
   CBG transmission information: Information indicating which code block group (CBG) of data is transmitted through PDSCH when code block group-based retransmission is configured—0, 2, 4, 6, or 8 bits
   CBG flushing out information: Information indicating whether the code block group previously received by the terminal may be used for HARQ combining—0 or 1 bit
   DMRS sequence initialization: indicates DMRS sequence initialization parameter—1 bit

In the case of data transmission through PDSCH or PUSCH, time domain resource assignment may be transferred by information for a slot in which PDSCH/PUSCH is transmitted and the number L of symbols in which PDSCH/PUSCH is mapped with the start symbol position S in the slot. Here, S may be a relative position from the start of the slot, L may be the number of contiguous symbols, and S and L may be determined from a start and length indicator value (SLIV) defined as in Equation 1 below.

if (L−1)≤7 then

SLIV=14·(L−1)+S

else

SLIV=14·(14−L+1)+(14−1−S)

where 0<L≤14−S [Equation 1]

In the NR system, the UE may be configured with information for the slot in which PDSCH/PUSCH is transmitted and PDSCH/PUSCH mapping type and SLIV value in one row via RRC configuration (e.g., the information may be configured in the form of a table). Thereafter, in the time domain resource allocation of the DCI, the base station may transfer, to the UE, information for the slot in which PDSCH/PUSCH is transmitted and PDSCH/PUSCH mapping type and SLIV value by indicating the index value in the configured table.

In the NR system, type A and type B are defined as PDSCH mapping types. In PDSCH mapping type A, the first symbol among DMRS symbols is located in the second or third OFDM symbol of the slot. In PDSCH mapping type B, the first symbol among DMRS symbols is located in the first OFDM symbol in the time domain resource allocated by PUSCH transmission.

Downlink data may be transmitted on a PDSCH that is a physical channel for downlink data transmission. The PDSCH may be transmitted after the control channel transmission interval, and scheduling information, such as a specific mapping position in the frequency domain and a modulation scheme, is determined based on the DCI transmitted through the PDCCH.

The base station notifies the UE of the modulation scheme applied to the PDSCH to be transmitted and a size (e.g., a transport block size (TBS)) of data to be transmitted, through the MCS among the control information constituting the DCI. In an embodiment, the MCS may be composed of 5 bits or more or fewer bits. The TBS corresponds to the size before applying channel coding for error correction to the data (transport block; TB) to be transmitted by the base station.

In the disclosure, a transport block (TB) may include a medium access control (MAC) header, a MAC control element, one or more MAC service data units (SDUs), and padding bits. Alternatively, the TB may indicate a MAC protocol data unit (PDU) or a unit of data to be delivered from a MAC layer to a physical layer.

Modulation schemes supported by the NR system are quadrature phase shift keying (QPSK), 16 quadrature amplitude modulation (QAM), 64QAM, and 256 QAM, and each modulation order (Qₘ) may correspond to 2, 4, 6, and 8. In other words, QPSK, 16QAM, 64QAM, and 256QAM may transmit 2 bits per symbol, 4 bits per symbol, 6 bits per symbol, and 8 bits per symbol, respectively.

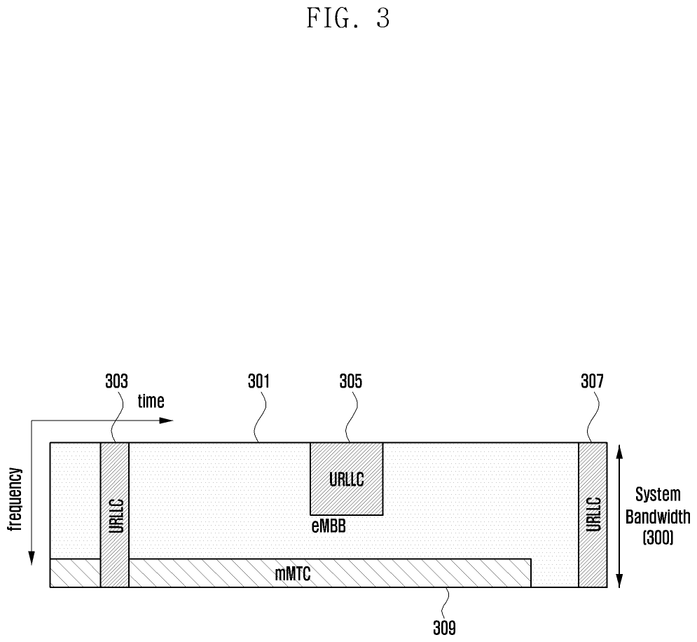

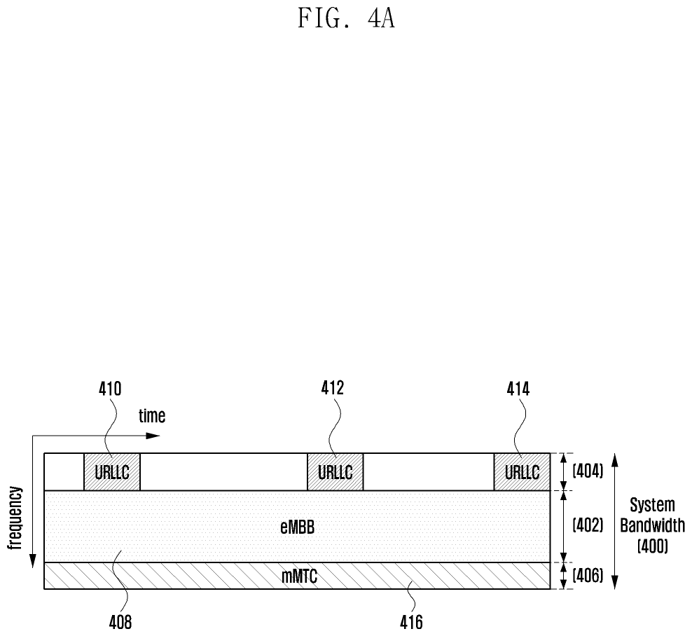

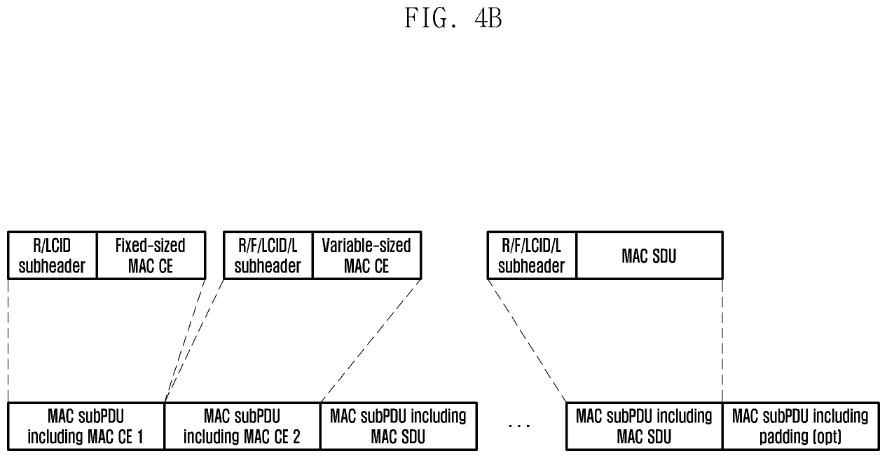

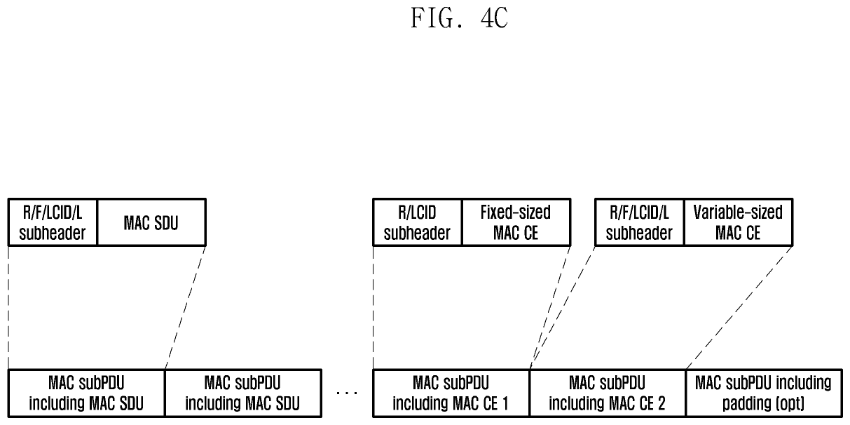

FIG. 3 and FIG. 4A are diagrams illustrating an example in which pieces of data of eMBB, URLLC, and mMTC data, which are services considered in 5G or NR systems, are allocated in frequency-time resources.

Referring to FIGS. 3 and 4A, a scheme by which frequency and time resources are allocated for information transmission in each system may be identified.

FIG. 3 is a diagram illustrating an example in which eMBB, URLLC, and mMTC data are allocated in an entire system frequency band. FIG. 3 illustrates an example in which data for eMBB, URLLC, and mMTC is allocated in the entire system frequency band 300. In a case that URLLC data 303, 305, and 307 is generated and needs to be transmitted while eMBB 301 and mMTC 309 are allocated in a specific frequency band and transmitted, URLLC data 303, 305, and 307 may be transmitted with the portions, in which eMBB 301 and mMTC 309 have already been allocated, emptied or not transmitted. Among the above services, URLLC requires a decrease in delay time and thus, URLLC data may be allocated (303, 305, and 307) in the portion of the resource 301, in which eMBB has been allocated, to be transmitted. Of course, in a case that the URLLC is additionally allocated and transmitted in the resources to which the eMBB is allocated, the eMBB data may not be transmitted in an overlapping frequency-time resource, and therefore transmission performance of the eMBB data may be lowered. That is, in this case, a transmission failure of the eMBB data may occur due to allocation of resources for the URLLC.

FIG. 4A is a diagram illustrating an example in which a system frequency band is divided and eMBB, URLLC, and mMTC data are allocated thereto. Referring to FIG. 4A, the entire system frequency band 400 may be divided into subbands 402, 404, and 406 which may be used for transmitting data and services. The information related to configuration of the subbands may be predetermined, and the information may be transmitted from the base station to the UE through higher level signaling. Alternatively, the system frequency band may be divided into the subbands by the base station or a network node in an arbitrary manner, so that services may be provided without transmitting separate subband configuration information to the UE. FIG. 4A illustrates that subbands 402, 404, and 406 are used for transmission of eMBB data, URLLC data, and mMTC data, respectively.

To describe the methods and devices proposed in an embodiment, the terms “physical channel” and “signal” in the NR system may be used. However, the content of the disclosure may be applied to wireless communication systems other than the NR system.

Hereinafter, example embodiments of the disclosure will be described in detail with reference to the accompanying drawings. In the following description of the disclosure, a detailed description of related functions or configurations incorporated herein will be omitted when it is determined that the description may make the subject matter of the disclosure unnecessarily unclear. The terms which will be described below are terms defined in consideration of the functions in the disclosure, and may be different according to users, intentions of the users, or customs. Therefore, the definitions of the terms should be made based on the contents throughout the specification.

According to the disclosure, downlink (DL) may, for example, refer to a wireless transmission path of a signal transmitted from the base station to the terminal, and uplink (UL) may, for example, refer to a wireless transmission path of a signal transmitted from the terminal to the base station.

Hereinafter, an embodiment of the disclosure will be described using a NR system as an example, but the disclosure may be applied to other communication systems having a similar technical background or channel type. Accordingly, the embodiments of the disclosure may be applied to other communication systems through some modifications without significantly departing from the scope of the disclosure as determination made by a person skilled in the art.

In the disclosure, the terms “physical channel” and “signal” may be used interchangeably with “data” or “control signal.” For example, a PDSCH is a physical channel through which data is transmitted, but in the disclosure, a PDSCH may be data.

As used herein, the term “higher layer signaling” may refer, for example, to a method for transmitting signals from the base station to the UE using a downlink data channel of the physical layer or from the UE to the base station using an uplink data channel of the physical layer, and may be interchangeably used with “RRC signaling” or MAC control element (CE).”

In various embodiments of the disclosure, the TA may be transmitted through a MAC control element (CE), for example, a timing advance command MAC CE, an absolute timing advance command MAC CE, or the like.

Meanwhile, a message transmitted from the MAC layer to a physical layer, for example, a MAC PDU may include one or more MAC subPDUs. Each MAC subPDU may include one of the following.
Only MAC subheader (including padding)
MAC subheader and MAC SDU
MAC subheader and MAC CE
MAC subheader and padding

The MAC SDUs may have variable sizes, and each MAC subheader may correspond to the MAC SDU, MAC CE, or padding.

Meanwhile, a message transmitted from the MAC layer to a physical layer, for example, a MAC PDU may be configured as shown in FIG. 4B and FIG. 4C in cases of a downlink and a uplink, respectively.

First, an example of a message transferred from a MAC layer to a physical layer on a downlink in a communication system according to various example embodiments of the disclosure will be described with reference to FIG. 4B.

FIG. 4B is a diagram schematically illustrating an example of a message transferred from a MAC layer to a physical layer on a downlink in a communication system according to various example embodiments of the disclosure.

Referring to FIG. 4B, an example of a message transferred from the MAC layer to the physical layer on the downlink may correspond to a downlink MAC PDU (DL MAC PDU). Referring to FIG. 4B, an MAC subPDU including MAC CE 1 includes R/LCID subheader and a fixed-sized MAC CE, and an MAC subPDU including MAC CE 2 includes R/F/CID/L subheader and a variable-sized MAC CE. Furthermore, an MAC subPDU including a MAC SDU includes R/F/CID/L subheader and the MAC SDU.

In FIG. 4B, the LCID represents a logical channel ID field, the LCID indicates an instance of a corresponding MAC SDU, a type of a corresponding MAC CE, or padding, and a description thereof will be given in Table A and Table B below. Here, Table A below indicates LCID values with respect to DL-SCH, and Table B indicates LCID values with respect to UL-SCH. One LCID field exists for each MAC subheader and the LCID field has a size of 6 bits. In a case the LCID field is configured to be “34”, for example, one additional octet exists in the MAC subheader including an eLCID field and the one additional octet follows the octet including the LCID field. In a case the LCID field is configured to be “33”, for example, two additional octets exist in the MAC subheader including an eLCID field and the two octets follows the octet including the LCID field.

The eLCID indicates, for example, an extended logical channel ID field, and indicates, for example, a logical channel instance of the corresponding MAC SDU or a type of the corresponding MAC CE. The eLCID field has a size of 8 bits or 16 bits.

Here, L denotes a length field and the length field indicates a length of a corresponding MAC SDU or variable-sized MAC CE. One length field exists for each MAC subheader excluding subheaders corresponding to MAC SDUs including the fixed-sized MAC CEs, padding, or UL common control channel (CCCH). The size of the length field is indicated by an F field.

Furthermore, F represents a format field and indicates a size of a length field. One F field exists for each MAC subheader excluding MAC SDUs including fixed-sized MAC CEs, padding, and UL CCCH. The F field has a size of 1 bit, a value of 0 indicates 8 bits of the length field as one example, and a value of 1 indicates 16 bits of the length field as another example.

In addition, R is a reserved bit and is configured to be “0”, for example.

As shown in FIG. 4B, MAC CEs, e.g., MAC CE 1 and MAC CE 2 are arranged together, and a MAC subPDU (subPDUs) including a MAC CE (CEs) is arranged before a MAC subPDU including a MAC SDU and a MAC subPDU including padding. Here, the padding may have a size of 0.

Next, an example of a message transferred from a MAC layer to a physical layer on an uplink in a communication system according to various embodiments of the disclosure will be described with reference to FIG. 4C.

FIG. 4C is a diagram schematically illustrating an example of a message transferred from a MAC layer to a physical layer on an uplink in a communication system according to various embodiments of the disclosure.

Referring to FIG. 4C, an example of a message transferred from the MAC layer to the physical layer on the uplink may correspond to an uplink MAC PDU (UL MAC PDU). Referring to FIG. 4C, an MAC subPDU including MAC CE 1 includes R/LCID subheader and a fixed-sized MAC CE, and an MAC subPDU including MAC CE 2 includes R/F/CID/L subheader and a variable-sized MAC CE. Furthermore, an MAC subPDU including a MAC SDU includes R/F/CID/L subheader and the MAC SDU.

As shown in FIG. 4C, MAC CEs, e.g., MAC CE 1 and MAC CE 2 are arranged together, and a MAC subPDU (subPDUs) including a MAC CE (CEs) is arranged after a MAC subPDU including a MAC SDU and before a MAC subPDU including padding. Here, the padding may have a size of 0.

In FIG. 4B and FIG. 4C, the LCID included in the MAC layer, that is, the logical channel ID or the extended logical channel ID may indicate a type of the MAC CE or the MAC SDU to be transmitted. Mapping between an index of the LCID and a type of the MAC SDU or the MAC CE may be as shown in, for example, [Table A] below, and an index of the eLCID and the type of the MAC SDU or the MAC CE may be as shown in, for example, [Table B] below. In various embodiments of the disclosure, the LCID may indicate an instance of a logical channel of the MAC SDU, a type of the MAC CE, or padding information of a downlink shared channel (DL-SCH) and an uplink shared channel (UL-SCH). One LCID may be mapped to one MAC subheader, and the LCID may be implemented by, for example, 6 bits.

TABLE A
LCID values for DL-SCH

| Codepoint/Index | LCID values |
|---|---|
| 0 | CCCH |
| 1-32 | Identity of the logical channel |
| 33 | Extended logical channel ID field (two-octet eLCID |
| | field) |
| 34 | Extended logical channel ID field (one-octet eLCID |
| | field) |
| 35-46 | Reserved |
| 47 | Recommended bit rate |
| 48 | SP ZP CSI-RS Resource Set |
| | Activation/Deactivation |
| 49 | PUCCH spatial relation Activation/Deactivation |
| 50 | SP SRS Activation/Deactivation |
| 51 | SP CSI reporting on PUCCH |
| | Activation/Deactivation |
| 52 | TCI State Indication for UE-specific PDCCH |
| 53 | TCI States Activation/Deactivation for UE-specific |
| | PDSCH |
| 54 | Aperiodic CSI Trigger State Subselection |
| 55 | SP CSI-RS/CSI-IM Resource Set |
| | Activation/Deactivation |
| 56 | Duplication Activation/Deactivation |
| 57 | SCell Activation/Deactivation (four octets) |
| 58 | SCell Activation/Deactivation (one octet) |
| 59 | Long DRX Command |
| 60 | DRX Command |
| 61 | Timing Advance Command |
| 62 | UE Contention Resolution Identity |
| 63 | Padding |

TABLE B
eLCID values for DL- SCH

| Codepoint | Index | LCID values |
|---|---|---|
| 0 to 244 | 64 to 308 | Reserved |
| 245 | 309 | Serving Cell Set based SRS |
| | | Spatial Relation Indication |
| 246 | 310 | PUSCH Pathloss Reference RS |
| | | Update |
| 247 | 311 | SRS Pathloss Reference RS |
| | | Update |
| 248 | 312 | Enhanced SP/AP SRS Spatial |
| | | Relation Indication |
| 249 | 313 | Enhanced PUCCH Spatial Relation |
| | | Activation/Deactivation |
| 250 | 314 | Enhanced TCI States |
| | | Activation/Deactivation for UE- |
| | | specific PDSCH |
| 251 | 315 | Duplication RLC |
| | | Activation/Deactivation |
| 252 | 316 | Absolute Timing Advance |
| | | Command |
| 253 | 317 | SP Positioning SRS |
| | | Activation/Deactivation |
| 254 | 318 | Provided Guard Symbols |
| 255 | 319 | Timing Delta |

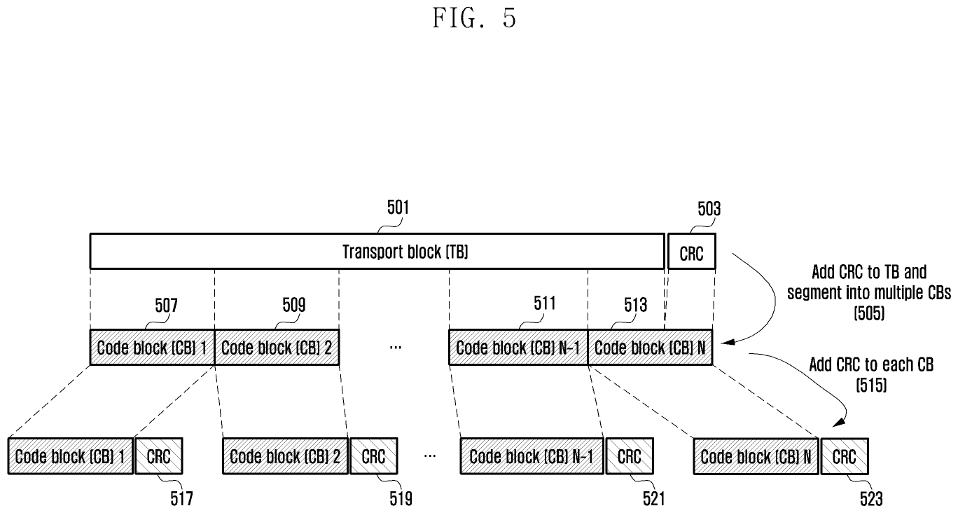

FIG. 5 is a diagram illustrating an example process in which one transport block is divided into multiple code blocks and a CRC is added.

Referring to FIG. 5, a CRC 503 may be added to the head or tail of one transport block (TB) 501 which is to be transmitted on an uplink or downlink. The CRC 503 may have 16 bits, 25 bits, or a pre-fixed number of bits, or a variable number of bits depending on channel context, and be used to determine whether channel coding succeeds. The CRC 503-added TB 501 may be divided into multiple code blocks (CBs) 507, 509, 511, and 513 (505). The maximum sizes of the code blocks may be previously determined before division and, in this case, the last code block 513 may be smaller than the other code blocks 507, 509, and 511. However, this is only an example, and according to another example, 0, a random value, or 1 may be inserted into the last code block 513, so that the last code block 513 and the other code blocks 507, 509, and 511 may have the same length.

CRCs 517, 519, 521, and 523 may be added to the code blocks 507, 509, 511, and 513, respectively (515). The CRC may have 16 bits, 24 bits, or a pre-fixed number of bits, and be used to determine whether channel coding succeeds.

The TB 501 and a cyclic generator polynomial may be used to generate the CRC 503, and the cyclic generator polynomial may be defined in various ways. For example, assuming that a cyclic generator polynomial for a 24-bit CRC is gCRC24A(D)=D²⁴+D²³+D¹⁸+D¹⁷+D¹⁴+D¹¹+D¹⁰+D⁷+D⁶+D⁵+D⁴+D³+D+1, and L=24, for TB data a₀, a₁, a₂, a₃ . . . , a_{A-1}, the CRC p₀, p₁, p₂, p₃ . . . p_{L-1}, may be determined as the value whose remainder is 0 when a₀D^{A+23}+a₁D^{A+22}+ . . . +a_{A-2}D²⁴+p₀D²³+p₁D²²+ . . . +p₂₂D¹+p₂₃ is divided by gCRC24A(D). In the above-described example, it is assumed that the CRC length L is 24 as an example, but the CRC length L may be determined to have a different value, e.g., 12, 16, 24, 32, 40, 48, or 64.

After the CRC is added to the TB through the process, TB+CRC may be segmented into N CBs 507, 509, 511, and 513. CRCs 517, 519, 521, and 523 may be added to the segmented CBs 507, 509, 511, and 513, respectively (515). The CRCs added to the CBs may have different lengths from that when the CRC added to the TB is generated, or another cyclic generator polynomial may be used to generate the CRC. Furthermore, the CRC 503 added to the TB and the CRCs 517, 519, 521, and 523 added to the codeblocks may be omitted depending on the type of channel code to be applied to the codeblocks. For example, in case that an LDPC code, not turbo code, is applied to the codeblocks, the CRCs 517, 519, 521, and 523 to be added to the codeblocks may be omitted.

However, even when the LDPC is applied, the CRCs 517, 519, 521, and 523 may be added to the codeblocks. Further, when a polar code is used, the CRCs may also be added or omitted.

As described with reference to FIG. 5, the maximum length of one codeblock is determined depending on the type of channel coding applied to the TB to be transmitted, and depending on the maximum length of the codeblock, the TB and the CRC added to the TB may be segmented into codeblocks.

In legacy LTE systems, CB CRCs are added to the segmented CBs, and the data bits of the CBs and the CRCs are encoded with channel code, so that coded bits are determined, and the number of bits to be rate-matched is determined as previously agreed on coded bits.

In the NR system, the TB size (TBS) may be calculated via the following steps.

Step 1: N′_{RE} which is the number of REs allocated for PDSCH mapping in one PRB in the allocated resource is calculated. N′_{RE} May be calculated as N_{sc}^{RB}·N_{symb}^{sh}−N_{DMNRS}^{PRB}−Nₛₕ^{PRB}. Here, N_{sc}^{RB} is 12, and N_{symb}^{sh} may indicate the number of OFDM symbols allocated to the PDSCH. N_{DMNRS}^{PRB} is the number of REs in one PRB occupied by DMRSs of the same CDM group. Nₛₕ^{PRB} is the number of REs occupied by the overhead in one PRB configured by higher signaling, and may be configured to one of 0, 6, 12, and 18. Thereafter, the total number N_{RE} of REs allocated to the PDSCH may be calculated. N_{RE} is calculated as min(156,N′_{RB})·n_{PRB}, and n_{PRB} denotes the number of PRBs allocated to the UE.

Step 2: N_{info}, which is the number of bits of temporary information, may be calculated as N_{RE}*R*Qₘ*v. Here, R is the code rate, Qₘ is the modulation order, and information for this value may be transmitted using the MCS bit field of DCI and a pre-agreed table. Here, v is the number of allocated layers. If N_{info}≤3824 the TBS may be calculated through step 3 below. Otherwise, the TBS may be calculated through step 4.

Step 3: Through equations of

$${N}_{info}^{′} = max ( 24 , {2}^{{n}_{*}} ⌊ \frac{{N}_{info}}{{2}^{n}} ⌋ )$$

and n=max(3, └log₂(N_{info}) ┘−6), N′_{info} may be calculated. The TBS may be determined to be a value closest to N′_{info} among values not smaller than N′_{info} in Table 12 below.

TABLE 12

| Index | TBS |
|---|---|
| 1 | 24 |
| 2 | 32 |
| 3 | 40 |
| 4 | 48 |
| 5 | 56 |
| 6 | 64 |
| 7 | 72 |
| 8 | 80 |
| 9 | 88 |
| 10 | 96 |
| 11 | 104 |
| 12 | 112 |
| 13 | 120 |
| 14 | 128 |
| 15 | 136 |
| 16 | 144 |
| 17 | 152 |
| 18 | 160 |
| 19 | 168 |
| 20 | 176 |
| 21 | 184 |
| 22 | 192 |
| 23 | 208 |
| 24 | 224 |
| 25 | 240 |
| 26 | 256 |
| 27 | 272 |
| 28 | 288 |
| 29 | 304 |
| 30 | 320 |
| 31 | 336 |
| 32 | 352 |
| 33 | 368 |
| 34 | 384 |
| 35 | 408 |
| 36 | 432 |
| 37 | 456 |
| 38 | 480 |
| 39 | 504 |
| 40 | 528 |
| 41 | 552 |
| 42 | 576 |
| 43 | 608 |
| 44 | 640 |
| 45 | 672 |
| 46 | 704 |
| 47 | 736 |
| 48 | 768 |
| 49 | 808 |
| 50 | 848 |
| 51 | 888 |
| 52 | 928 |
| 53 | 984 |
| 54 | 1032 |
| 55 | 1064 |
| 56 | 1128 |
| 57 | 1160 |
| 58 | 1192 |
| 59 | 1224 |
| 60 | 1256 |
| 61 | 1288 |
| 62 | 1320 |
| 63 | 1352 |
| 64 | 1416 |
| 65 | 1480 |
| 66 | 1544 |
| 67 | 1608 |
| 68 | 1672 |
| 69 | 1736 |
| 70 | 1800 |
| 71 | 1864 |
| 72 | 1928 |
| 73 | 2024 |
| 74 | 2088 |
| 75 | 2152 |
| 76 | 2216 |
| 77 | 2280 |
| 78 | 2408 |
| 79 | 2472 |
| 80 | 2536 |
| 81 | 2600 |
| 82 | 2664 |
| 83 | 2728 |
| 84 | 2792 |
| 85 | 2856 |
| 86 | 2976 |
| 87 | 3104 |
| 88 | 3240 |
| 89 | 3368 |
| 90 | 3496 |
| 91 | 3624 |
| 92 | 3752 |
| 93 | 3824 |

Step 4: Through equations of

$${N}_{info}^{′} = max ( 3840 , {2}^{n} \times round ( \frac{{N}_{info} - 24}{{2}^{n}} ) )$$

n=└log₂(N_{info}−24)┘−5, N′_{info} may be calculated. The TBS may be determined by N′_{info} and [pseudo-code 1] below. In the following, C corresponds to the number of code blocks included in one TB.

[Start of Pseudo-Code 1]

```
    if R ≤ 1/4
        $TBS = 8 * C * ⌈ \frac{{N}_{info}^{′} + 24}{8 * C} ⌉ - 24 , where C = ⌈ \frac{{N}_{info}^{′} + 24}{3816} ⌉$
      else
        if N′_{info} > 8424
          $TBS = 8 * C * ⌈ \frac{{N}_{info}^{′} + 24}{8 * C} ⌉ - 24 , where C = ⌈ \frac{{N}_{info}^{′} + 24}{8424} ⌉$
        else
          $TBS = 8 * ⌈ \frac{{N}_{info}^{′} + 24}{8} ⌉ - 24$
        end if
      end if
```

[End of Pseudo-Code 1]

When one CB is input to the LDPC encoder in the NR system, it may be output, with parity bits added. In this case, the number of parity bits may vary depending on an LDCP base graph. A method for sending all parity bits generated by LDPC coding with respect to a specific input may be referred to as full buffer rate matching (FBRM), and a method of limiting the number of transmittable parity bits may be referred to as limited buffer rate matching (LBRM). In a case that resources are allocated for data transmission, an output of the LDPC encoder is made to a circular buffer, and bits of the buffer are repeatedly transmitted as many times as the number of the allocated resources, and a length of the circular buffer may be called N_{cb}.

Assuming that the number of all of the parity bits generated by LDPC coding is N, N_{cb}=N in the FBRM method. In the LBRM method, N_{cb} corresponds to min(N,N_{ref}), N_{ref} is given as

$$⌊ \frac{{TBS}_{LBRM}}{C \cdot {R}_{LBRM}} ⌋ ,$$

and R_{LBRM} and may be determined to be ⅔. To obtain TBS_{LBRM}, the above-described method for acquiring TBS is used, assuming the maximum number of layers and maximum modulation order supported by the UE in the cell, and the maximum modulation order Qₘ is assumed to be 8, if an MCS table supporting 256QAM is used for at least one BWP in the cell, or otherwise, 6 (64QAM). The code rate is assumed to be the maximum code rate, i.e., 948/1024. The calculation is performed assuming that N_{RE} is 156·n_{PRB}, and n_{PRB} is n_{PRB,LBRM}, n_{PRB,LBRM} may be given in Table 13 below.

TABLE 13

| Maximum number of PRBs across all configured | |
|---|---|
| BWPs of a carrier | n_{PRB,LBRM} |
| Less than 33 | 32 |
| 33 to 66 | 66 |
| 67 to 107 | 107 |
| 108 to 135 | 135 |
| 136 to 162 | 162 |
| 163 to 217 | 217 |
| Larger than 217 | 273 |

The maximum data rate supported by the UE in the NR system may be determined through Equation 2 below.

$$data rate ( in Mbps ) = {10}^{- 6} \cdot {\sum }_{i = 1}^{J} ( {v}_{Layers}^{( j )} \cdot {Q}_{m}^{( j )} \cdot {f}^{( j )} \cdot {R}_{max} \cdot \frac{{N}_{PRB}^{BW ( j ) , μ} \cdot 12}{{T}_{s}^{μ}} \cdot ( 1 - {OH}^{( j )} ) ) \qquad [ Equation 2 ]$$

In Equation 2, J may indicate the number of carriers bound by carrier aggregation, Rmax=948/1024, v_{Layers}^{(j)} may indicate the maximum number of layers, Qₘ^{(j)} may indicate a maximum modulation order, f^{(j)} may indicate a scaling index, and μ may indicate a subcarrier spacing. The UE may report f^{(j)} as one value among 1, 0.8, 0.75, and 0.4, and μ may be given as shown in Table 14 below.

TABLE 14

| μ | Δf = 2^{μ} · 15[kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Tₛ^{μ} is an average OFDM symbol length, Tₛ^{μ} may be calculated based on

$$\frac{1 {0}^{- 3}}{14 \cdot {2}^{μ}} ,$$

and N_{PRB}^{BW(j),μ} is the maximum number of RBs in BW(j). OH^{j} is an overhead value, may be given as 0.14 in a downlink of FR1 (a band equal to or lower than 6 GHz) and given as 0.18 in an uplink thereof, and may be given as 0.08 in a downlink of FR2 (a band over 6 GHz) and given as 0.10 in an uplink thereof. Through Equation 2, the maximum data rate in a downlink in a cell having a 100 MHz frequency bandwidth at a 30 kHz subcarrier spacing may be calculated as Table 15 below.

TABLE 15

| f^{(j)} | v [symbol] ^{(j)} | Qₘ^{(j)} | Rmax | N_{PRB} [symbol] | Tₛ^{μ} | OH^{(j)} | data rate |
|---|---|---|---|---|---|---|---|
| 1 | 4 | 8 | 0.92578125 | 273 | 3.57143E−05 | 0.14 | 2337.0 |
| 0.8 | 4 | 8 | 0.92578125 | 273 | 3.57143E−05 | 0.14 | 1869.6 |
| 0.75 | 4 | 8 | 0.92578125 | 273 | 3.57143E−05 | 0.14 | 1752.8 |
| 0.4 | 4 | 8 | 0.92578125 | 273 | 3.57143E−05 | 0.14 | 934.8 |

[symbol]

indicates data missing or illegible when filed

In contrast, the actual data rate that the UE may measure in actual data transmission may be a value acquired by dividing the amount of data by the data transmission time. This may be a value acquired by dividing TBS by the TTI length for 1 TB transmission or dividing the sum of TBSs by the TTI length for 2 TB transmission. By way of example, as assumed to acquire Table 15, the maximum actual data rate in the downlink in the cell having the 100 MHz frequency band in the 30 kHz subcarrier spacing may be determined as shown in Table 16 according to the number of PDSCH symbols allocated.

TABLE 16

| | | | | | | | | | TTI | |
|---|---|---|---|---|---|---|---|---|---|---|
| | | | | | | | | | length | data rate |
| N_{symb}^{sh} | N_{DMRS}^{PRB} | N_{RE} | N_{RE} | N_{info} | n | N_{info} | C | TBS | (ms) | (Mbps) |
| 3 | 8 | 28 | 7644 | 226453.5 | 12 | 225,280 | 27 | 225,480 | 0.107143 | 2,104.48 |
| 4 | 8 | 40 | 10920 | 323505.0 | 13 | 319,488 | 38 | 319,784 | 0.142857 | 2,238.49 |
| 5 | 8 | 52 | 14196 | 420556.5 | 13 | 417,792 | 50 | 417,976 | 0.178571 | 2,340.67 |
| 6 | 8 | 64 | 17472 | 517608.0 | 13 | 516,096 | 62 | 516,312 | 0.214286 | 2,409.46 |
| 7 | 8 | 76 | 20748 | 614659.5 | 14 | 622,592 | 74 | 622,760 | 0.250000 | 2,491.04 |
| 8 | 8 | 88 | 24024 | 711711.0 | 14 | 704,512 | 84 | 704,904 | 0.285714 | 2,467.16 |
| 9 | 8 | 100 | 27300 | 808762.5 | 14 | 802,816 | 96 | 803,304 | 0.321429 | 2,499.17 |
| 10 | 8 | 112 | 30576 | 905814.0 | 14 | 901,120 | 107 | 901,344 | 0.357143 | 2,523.76 |
| 11 | 8 | 124 | 33852 | 1002865.5 | 14 | 999,424 | 119 | 999,576 | 0.392857 | 2,544.38 |
| 12 | 8 | 136 | 37128 | 1099917.0 | 15 | 1,114,112 | 133 | 1,115,048 | 0.428571 | 2,601.78 |
| 13 | 8 | 148 | 40404 | 1196968.5 | 15 | 1,212,416 | 144 | 1,213,032 | 0.464286 | 2,612.68 |
| 14 | 8 | 160 | 43680 | 1294020.0 | 15 | 1,277,952 | 152 | 1,277,992 | 0.500000 | 2,555.98 |

The maximum data rate supported by the UE may be identified via Table 15, and the actual data rate following the allocated TBS may be identified via Table 16. In this case, the actual data rate may be larger than the maximum data rate depending on scheduling information.

In a wireless communication system, particularly, the 5G NR system, a data rate supportable by a terminal may be mutually agreed upon between a base station and the terminal. The data rate may be calculated using a maximum frequency band supported by the terminal, a maximum modulation order, the maximum number of layers, and the like. However, the calculated data rate may be different from a value calculated from a length of a transmission time interval (TTI) and a transport block side (TBS) of a transport block (TB) used for actual data transmission.

Thus, the UE may be allocated with a larger TBS than the value corresponding to the data rate supported by the UE and, to prevent this, a limit may be imposed on the TBS schedulable depending on the data rate supported by the UE.

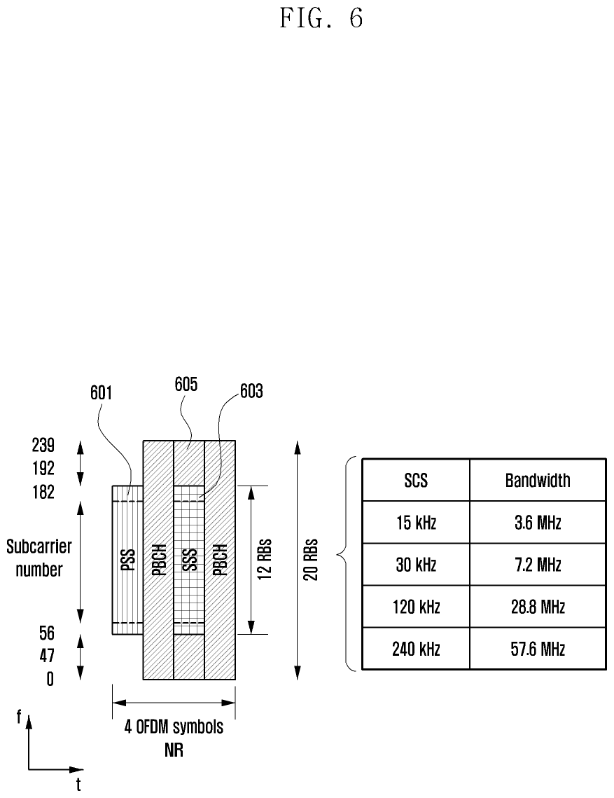

FIG. 6 is a diagram illustrating that a synchronization signal (SS) and a physical broadcast channel (PBCH) in an NR system are mapped to frequency and time domains.

A primary synchronization signal (PSS) 601, a secondary synchronization signal (SSS) 603, and a PBCH 605 are mapped over 4 OFDM symbols, and the PSS and SSS are mapped to 12 RBs, and the PBCH is mapped to 20 RBs. A table in FIG. 6 shows how a frequency band of 20 RBs is changed according to subcarrier spacing (SCS). The resource region in which the PSS, SSS, and PBCH are transmitted may be referred to as an SS/PBCH block. The SS/PBCH block may be referred to as an SSB block.

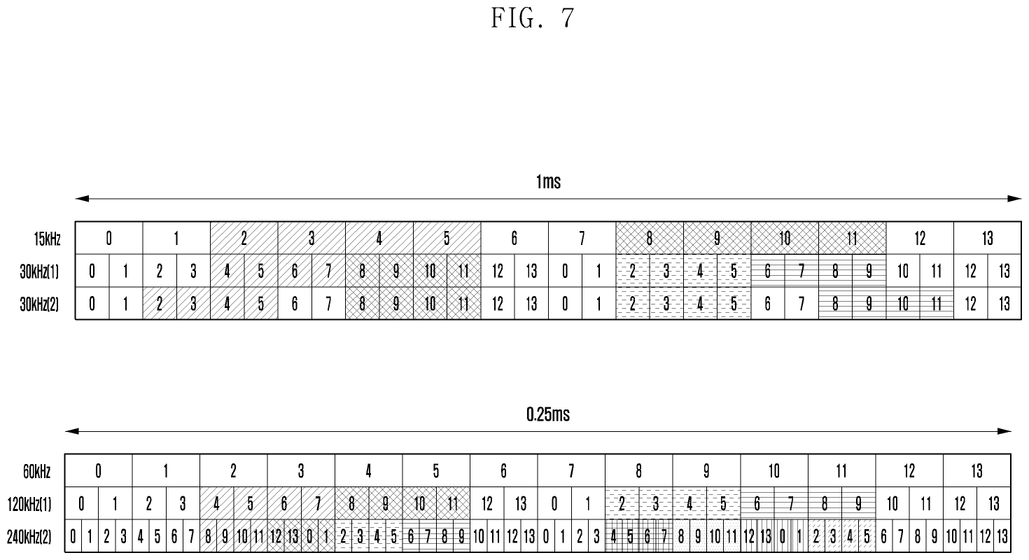

FIG. 7 is a diagram illustrating symbols on which an SS/PBCH block may be transmitted according to subcarrier spacings.

Referring to FIG. 7, the subcarrier spacing may be configured to 15 kHz, 30 kHz, 120 kHz, or 240 kHz, and the position of the symbol in which the SS/PBCH block (or SSB block) may be positioned may be determined according to each subcarrier spacing. FIG. 7 illustrates the position of the symbol in which the SSB may be transmitted according to the subcarrier spacing in the symbols within 1 ms, and the SSB does not have to be always transmitted in marked areas of FIG. 7. The position in which the SSB block is transmitted may be configured in the UE through system information or dedicated signaling.

Since the UE is generally far from the base station, the signal transmitted from the UE is received by the base station after a propagation delay. The propagation delay time is a value acquired by dividing the path through which a radio wave is transmitted from the UE to the base station by the speed of light, and may typically be a value acquired by dividing the distance between the UE and the base station by the speed of light. In an embodiment, if the UE is located 100 km away from the base station, a signal transmitted from the UE is received by the base station after about 0.34 msec. The signal transmitted from the base station is also received by the UE after about 0.34 msec. As described above, the arrival time of a signal transmitted from the UE to the base station may vary depending on the distance between the UE and the base station. Therefore, when multiple UEs in different locations transmit signals simultaneously, the times when the signals arrive at the base station may differ from each other. To allow the signals from several UEs to simultaneously arrive at the base station, the time of transmission of an uplink signal may be rendered to differ per UE. In 5G, NR and LTE systems, this is called timing advance.

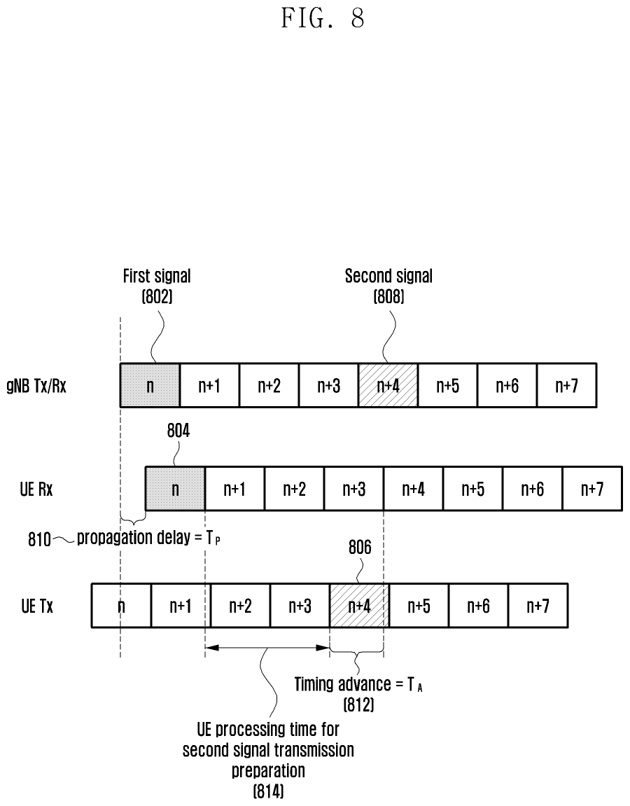

FIG. 8 is a diagram illustrating user equipment (UE) processing time according to timing advance when a UE receives a first signal and transmits a second signal in response thereto, in the 5G or NR system.

Hereinafter, the processing time of the UE according to the timing advance is described in detail. In a case that the base station transmits an uplink scheduling grant (UL grant) or a downlink control signal and data (DL grant and DL data) to the UE at slot n 802, the UE may receive the uplink scheduling grant or downlink control signal and data at slot n 804. In this case, the UE may receive the signal, a propagation delay (Tₚ) 810 later than the time the base station transmits the signal. In an embodiment, when the UE receives a first signal at slot n 804, the UE transmits a second signal at slot n+4 806. When the UE transmits a signal to the base station, the UE may transmit HARQ ACK/NACK for the uplink data or downlink data at a timing 806 which is a timing advance (TA) 812 earlier than slot n+4 for the signal received by the UE to allow the signal to arrive at the base station at a specific time. Therefore, in the embodiment, the time during which the UE may prepare to transmit uplink data after receiving the uplink scheduling grant or prepare to transfer HARQ ACK or NACK after receiving downlink data may be a time corresponding to 3 slots excluding TA (814).

To determine the above-described timing, the base station may calculate an absolute value of the TA of the corresponding UE. When the terminal initially accesses the base station, the base station may calculate the absolute value of the TA by adding or subtracting variation in the subsequent TA values transferred via higher layer signaling to or from the TA first transferred to the UE in the random access stage. In an embodiment, the absolute value of the TA may be a value acquired by subtracting a start time of a nth TTI for reception by the UE from a start time of a nth TTI for transmission by the UE.

Meanwhile, one of the important references of the performance of a cellular wireless communication system is packet data delay time (latency). In LTE systems, signal transmission/reception is performed in units of subframes which have a transmission time interval (TTI) of 1 ms. The LTE system operated as described above may support UEs (e.g., short-TTI UEs) having a shorter TTI than 1 ms. Meanwhile, in 5G or NR systems, the TTI may be shorter than 1 ms. Short-TTI UEs are suitable for services, such as voice over LTE (VoLTE) services and remote control services where the delay time (latency) is important. Furthermore, the short-TTI UE becomes a means capable of realizing mission-critical Internet of things (IoT) on a cellular basis.

In the 5G or NR system, in a case that the base station transmits a PDSCH including downlink data, DCI for scheduling the PDSCH indicates a K1 value which is a value corresponding to timing information for the UE to transmit HARQ-ACK information of the PDSCH. When transmission of HARQ-ACK information including the timing advance earlier than the symbol L1 is not indicated, the UE may transmit the HARQ-ACK information to the base station. That is, with the timing advance included, the HARQ-ACK information may be transmitted from the UE to the base station at a time point identical to or later than the symbol L1. In a case that the HARQ-ACK information with the timing advance included therein is indicated to be transmitted earlier than the symbol L1, the HARQ-ACK information may not be valid HARQ-ACK information in the HARQ-ACK transmission from the UE to the base station.

The symbol L1 may be a first symbol at which cyclic prefix (CP) starts after T_{proc,1} from the last time point of the PDSCH. T_{proc,1} may be calculated as in [Equation 3] below.

T_{proc,1}=((N₁+d_{1,1}+d_{1,2})(2048+144)·κ2^{-μ})·T_{C} [Equation 3]

In the aforementioned Equation 3, N₁, d_{1,1}, d_{1,2}, κ, μ, and TC may be defined as follows.
In a case that HARQ-ACK information is transmitted via a PUCCH (uplink control channel), d_{1,1}=0, and in a case that HARQ-ACK information is transmitted via a PUSCH (uplink shared channel, data channel), d_{1,1}=1.
in a case that the UE receives a configuration of multiple activated configuration carriers or carriers, a maximum timing difference between carriers may be reflected in the second signal transmission.
For PDSCH mapping type A, that is, in a case that a first DMRS symbol position is a third or a fourth OFDM symbol in a slot, if a position index i of the last OFDM symbol is less than 7, d_{1,2}=7−i.
For PDSCH mapping type B, that is, in a case that the first DMRS symbol position is a first symbol of the PDSCH, d_{1,2}=3 if the PDSCH has a length of 4 symbols, and d_{1,2}=3+d if the PDSCH has a length of 2 symbols, wherein d is the number of symbols in which the PDSCH and the PDCCH including a control signal for scheduling of the PDSCH overlap.
N₁ is defined according to p as in Table 17 below. Here, p=0, 1, 2, and 3 refer to subcarrier spacings of 15 kHz, 30 kHz, 60 kHz, and 120 kHz, respectively.

TABLE 17

PDSCH decoding time N₁ [symbols]

| | No additional PDSCH | Additional PDSCH |
|---|---|---|
| μ | DM-RS configured | DM-RS configured |
| 0 | 8 | 13 |
| 1 | 10 | 13 |
| 2 | 17 | 20 |
| 3 | 20 | 24 |

For the N₁ value provided in Table 17 above, a different value may be used according to UE capability.
T_{c}=1/(Δfₘₐₓ·N_{f}), Δfₘₐₓ=480·10³ Hz, N_{f}=4096, κ=Tₛ/T_{c}=64, Tₛ=1/(Δf_{ref}·N_{f,ref}), Δf_{ref}=15·10³ Hz, N_{f,ref}=2048
are defined respectively. Although, it is fixedly described that a parameter for determining a T_{C} value is Δfₘₐₓ=480·10³ Hz and N_{f}=4096 in the disclosure for convenience of the description, the parameters may vary depending on systems. The N_{f} value typically indicates a FFT size or a value corresponding thereto, and the Δfₘₐₓ as value may be configured to a value related to an oversampling frequency of the system and may be typically configured as a value equal to or larger than the maximum SCS. For example, in a case of the 5G NR system, the maximum SCS value is 240*10³ Hz, and the Δfₘₐₓ a value above may be configured to an integer multiple of the maximum value.

In the 5G or NR system, in a case that the base station transmits control information including uplink scheduling approval, the UE may indicate a K₂ value corresponding to timing information for uplink data or PUSCH transmission.

The UE may transmit the PUSCH to the base station in a case that the PUSCH having timing advance included therein is not indicated to be transmitted earlier than OFDM symbol L2. That is, with the timing advance included, the PUSCH may be transmitted from the UE to the base station at a time point identical to or later than that for symbol L2. In a case that the PUSCH having timing advance included therein is indicated to be transmitted earlier than symbol L2, the UE may disregard uplink scheduling grant control information from the base station.

Symbol L2 may be a first symbol at which CP of a PUSCH symbol to be transmitted starts after T_{proc,2} from the last time point of the PDCCH including a scheduling grant. T_{proc,2} may be calculated as in Equation 4 below.

T_{proc,2}=((N₂+d_{2,1})(2048+144)·κ2^{-μ})·T_{C} [Equation 4]

In the aforementioned [Equation 4], N₂, d_{2,1}, κ, μ, and T_{C} may be defined as follows.
in a case that a first symbol among symbols allocated to the PUSCH includes only a DMRS, d_{2,1}=0, otherwise, d_{2,1}=1.
in a case that the UE receives a configuration of multiple activated configuration carriers or carriers, a maximum timing difference between carriers may be reflected in the second signal transmission.
   N₂ is defined according to μ as in Table 18 below. Here, μ=0, 1, 2, and 3 refer to subcarrier spacings of 15 kHz, 30 kHz, 60 kHz, and 120 kHz, respectively.

TABLE 18

| μ | PUSCH preparation time N₂ [symbols] |
|---|---|
| 0 | 10 |
| 1 | 12 |
| 2 | 23 |
| 3 | 36 |

For the N₂ value provided in Table 18 above, a different value may be used according to UE capability.
T_{c}=1/(Δfₘₐₓ·N_{f}), Δfₘₐₓ=480·10³ Hz, N_{f}=4096, κ=Tₛ/T_{c}=64, Tₛ=1/(Δf_{ref}·N_{f,ref}), Δf_{ref}=15·10³ Hz, N_{f,ref}=2048 are defined respectively.

The 5G or NR system may configure a frequency band part (BWP) within one carrier to allow a specific UE to transmit and receive within the configured BWP. This may be so intended to reduce power consumption of the UE. The base station may configure multiple BWPs and change activated BWPs in control information. A time available by the UE to change the BWPs may be defined as shown in Table 19 below.

TABLE 19

| Frequency range | Scenario | Type 1 delay (μs) | Type 2 delay (μs) |
|---|---|---|---|
| 1 | 1 | 600 | 2000 |
| | 2 | 600 | 2000 |
| | 3 | 600 | 2000 |
| | 4 | 400 | 950 |
| 2 | 1 | 600 | 2000 |
| | 2 | 600 | 2000 |
| | 3 | 600 | 2000 |
| | 4 | 400 | 950 |

In Table 19, frequency range FR 1 may indicate a frequency band equal to lower than 6 GHz, and frequency range FR 2 may indicate a frequency band higher than or equal to 6 GHz, or the frequency ranges may be distinguished as shown in Table 4. In general, FR 2 refers a high frequency band close to a mmWave band, and FR 1 refers to a frequency band relatively lower than FR 2. In an embodiment, type 1 and type 2 may be determined according to UE capability. In an embodiment, scenarios 1, 2, 3, and 4 are configured as shown in Table 20 below.

TABLE 20

| | Change in center | Unchanged in center |
|---|---|---|
| | frequency | frequency |
| Change in frequency | Scenario 3 | Scenario 2 |
| bandwidth | | |
| Unchanged in frequency | Scenario 1 | Scenario 4, if subcarrier |
| bandwidth | | spacing is changed |

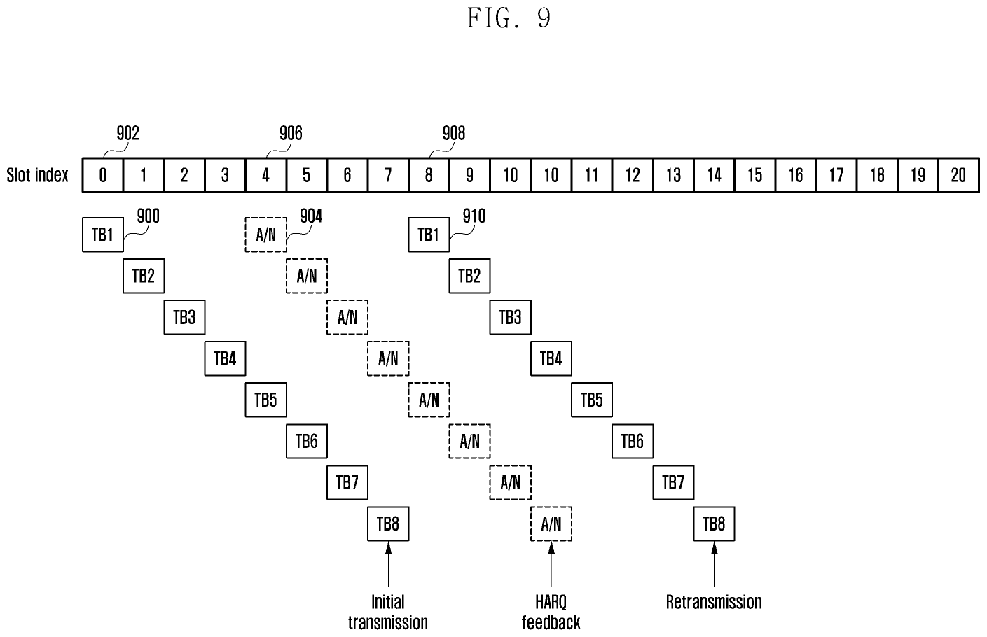

FIG. 9 is a diagram illustrating an example of scheduling multiple pieces of data (e.g., TBs) according to slots and transmitting the data, receiving a HARQ-ACK feedback with respect to the data, and performing retransmission according to the feedback, in a 5G system. In FIG. 9, TB1 900 is initially transmitted in slot0 902, and an ACK/NACK feedback 904 therefor is transmitted in slot4 906. If the initial transmission of TB1 fails and a NACK is received, retransmission 910 for TB1 may be performed in slot 8 908. In the description above, the time point at which the ACK/NACK feedback is transmitted and the time point at which the retransmission is performed may be predetermined or may be determined according to a value indicated by control information and/or higher layer signaling.

FIG. 9 illustrates an example in which TB1 to TB8 are sequentially scheduled and transmitted starting from slot 0. For example, TB1 to TB8 may be transmitted, with HARQ process ID 0 to HARQ process ID 7 assigned thereto, respectively. If only four HARQ process IDs may be used by the base station and the UE, it may be impossible to consecutively transmit eight different TBs.

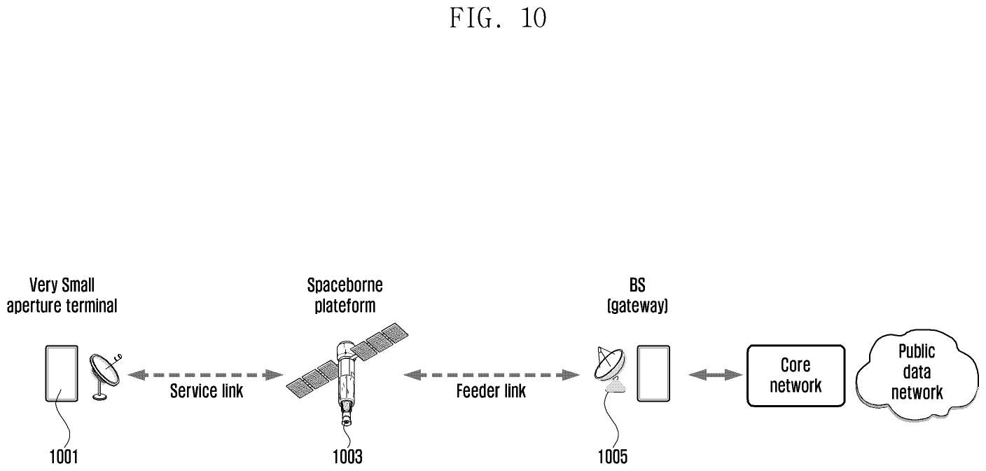

FIG. 10 is a diagram illustrating an example communication system using a satellite. For example, when a UE 1001 transmits a signal to a satellite 1003, the satellite 1003 may transmit the signal to a BS 1005, and the BS 1005 may process the received signal and transmit the signal including a request for a subsequent operation therefor to the UE 1001 through the satellite 1003 again. A distance between the UE 1001 and the satellite 1003 is long, and a distance between the satellite 1003 and the base station 1005 is also long, and thus a time required for data transmission and reception from the UE 1001 to the base station 1005 may become long.

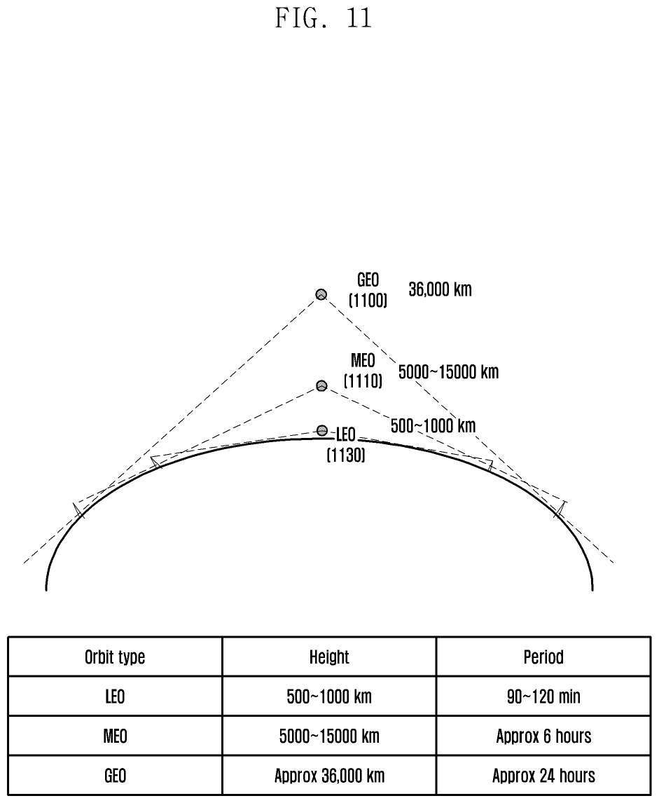

FIG. 11 is a diagram illustrating a revolution period of a communication satellite around the earth according to an altitude or height of the satellite. Satellites for communication may be divided into a low earth orbit (LEO), a middle earth orbit (MEO), a geostationary earth orbit (GEO), and the like according to orbits of the satellites. In general, the GEO 1100 refers to a satellite having an altitude of 36000 km, the MEO 1110 refers to a satellite having an altitude from 5000 to 15000 km, and the LEO refers to a satellite having an altitude from 500 to 1000 km. The revolution period around the earth varies depending on the altitude, and the GEO 1100 has the revolution period around the earth of about 24 hours, the MEO 1110 has about 6 hours, and the LEO 1130 has about 90 to 120 minutes. A low orbit (up to 2,000 km) satellite has a relatively low altitude, and has an advantage over a geostationary orbit (36,000 km) satellite in terms of propagation delay time (which may be understood as time it takes for a signal transmitted from a transmitter to reach a receiver) and loss.

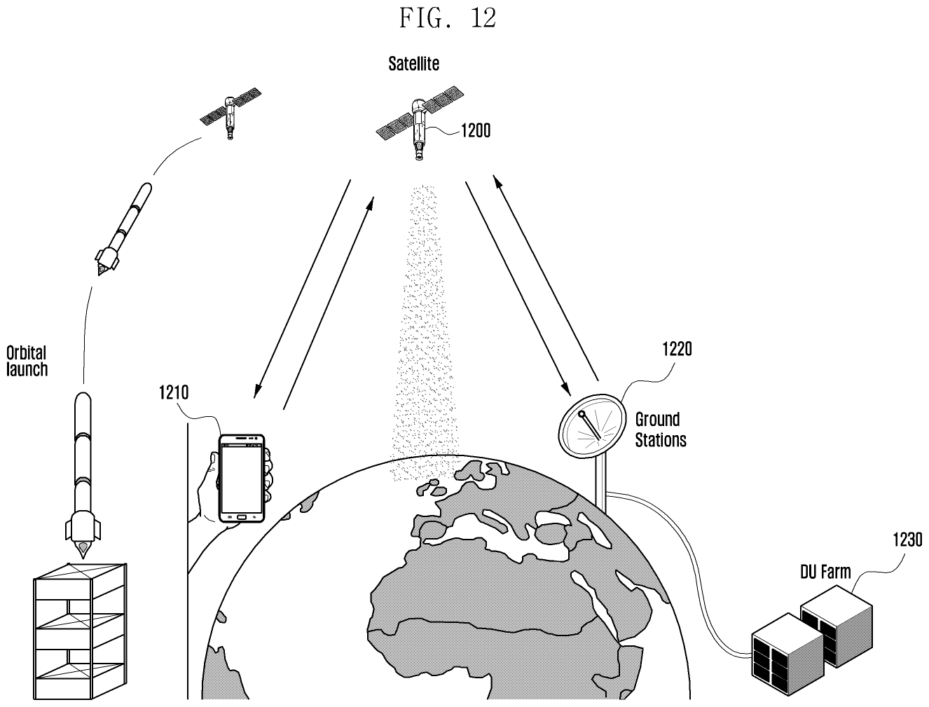

FIG. 12 is a diagram illustrating a concept of a satellite-UE direct communication. A satellite 1200 located at a place higher than or equal to altitude 100 km by a rocket transmits and receives a signal to and from the UE 1210 on the ground and also transmits and receives a signal to and from a ground station 1220 connected to a ground base station (DU farms) 1230.

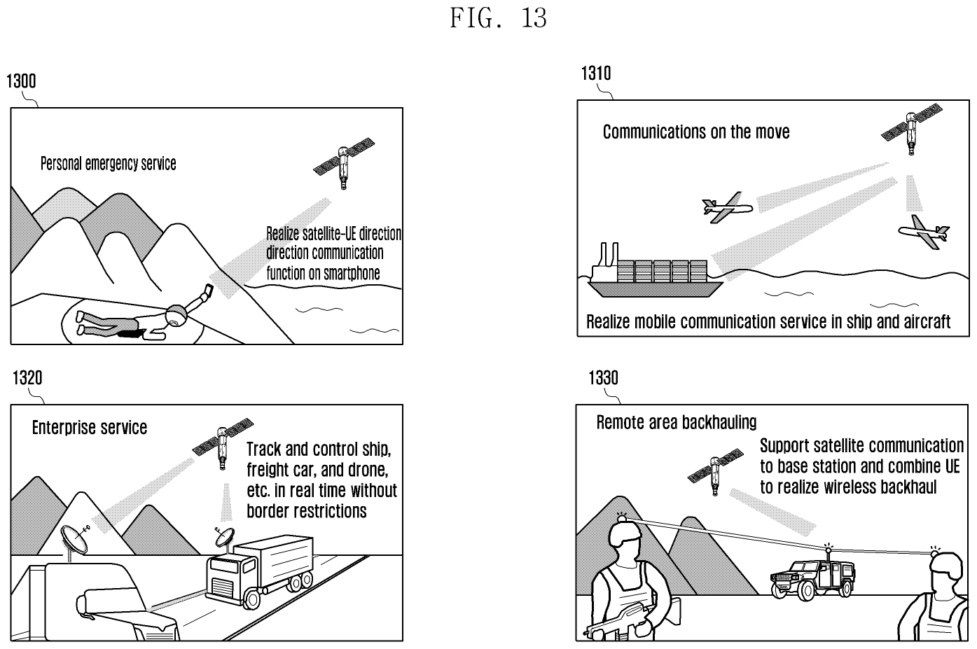

FIG. 13 is a diagram illustrating a utilization scenario of a satellite-UE direct communication. The satellite-UE direct communication may support a communication service with a specialized purpose in a form of supplementing a coverage limit of a terrestrial network. For example, by implementing a satellite-UE direct communication function in the UE, it is possible to transmit and receive an emergency rescue of a user and/or a disaster signal in a place which is not a terrestrial network coverage (1300), to provide a mobile communication service to the user at an area where a terrestrial network communication is impossible such as a ship and/or an air plane (1310), to track and control a location of a ship, a freight car, a drone, and/or the like in real time without border restrictions (1320), and to perform a backhaul function in a physically remote area by supporting a satellite communication function in the base station and functioning as a backhaul of the base station (1330).

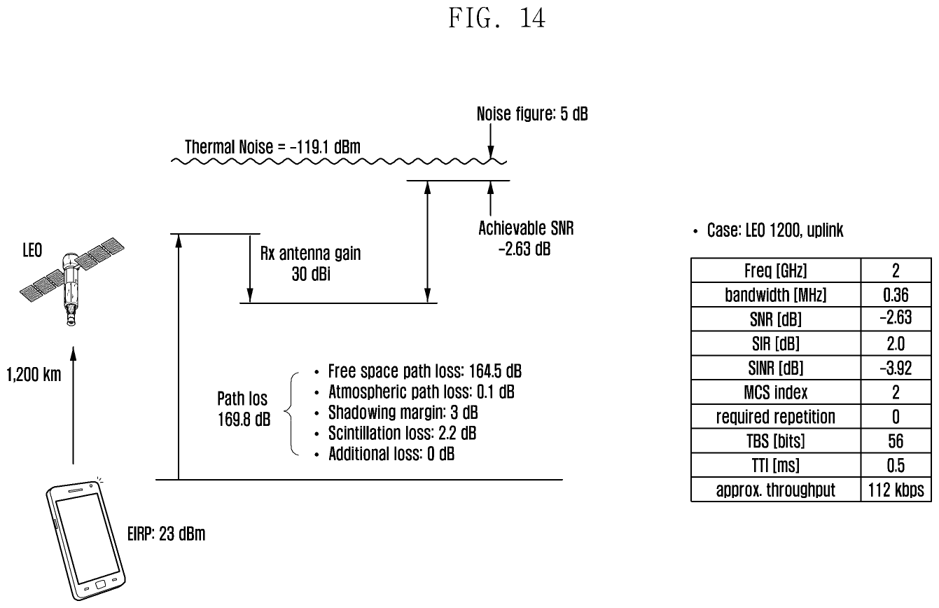

FIG. 14 is a diagram illustrating an example of calculating an expected data rate (or throughput) in an uplink when an LEO satellite at an altitude of 1200 km and a UE on the ground perform direct communication. Assuming that effective isotropic radiated power (EIRP) of the ground UE in the uplink is 23 dBm, a path loss of a radio channel to the satellite is 169.8 dB, and a satellite reception antenna gain is 30 dBi, an achievable signal-to-noise ratio (SNR) is estimated as −2.63 dB. In this case, the path loss may include a path loss in the space, a path loss in the atmosphere, and the like. Assuming a signal-to-interference ratio (SIR) of 2 dB, a signal-to-interference and noise ratio (SINR) is calculated as −3.92 dB, and in this case, if 30 kHz subcarrier spacing and a frequency resource of one PRB are used, it may be possible to achieve a data rate of 112 kbps.

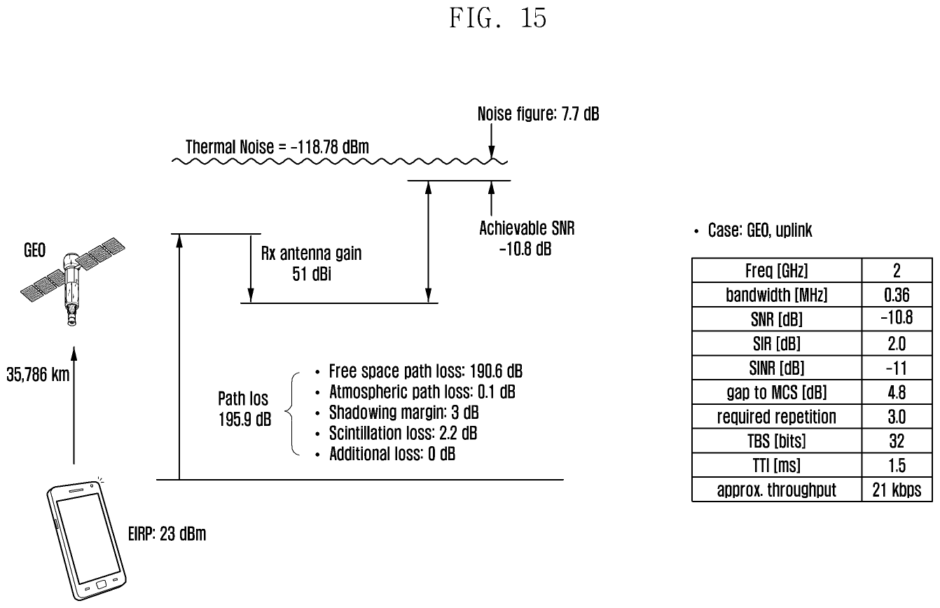

FIG. 15 is a diagram illustrating an example of calculating an expected data rate (or throughput) in an uplink when a GEO satellite at an altitude of 35,786 km and a UE on the ground perform direct communication. Assuming that effective isotropic radiated power (EIRP) of the ground UE in the uplink is 23 dBm, a path loss of a radio channel to the satellite is 195.9 dB, and a satellite reception antenna gain is 51 dBi, an achievable signal-to-noise ratio (SNR) is estimated as −10.8 dB. In this case, the path loss may include a path loss in the space, a path loss in the atmosphere, and the like. Assuming that the SIR is 2 dB, the SINR is calculated as −11 dB, and in this case, a transmission rate of 21 kbps may be achieved when subcarrier spacing of 30 kHz and frequency resources of 1 PRB are used, which is the result of 3 repeated transmissions.

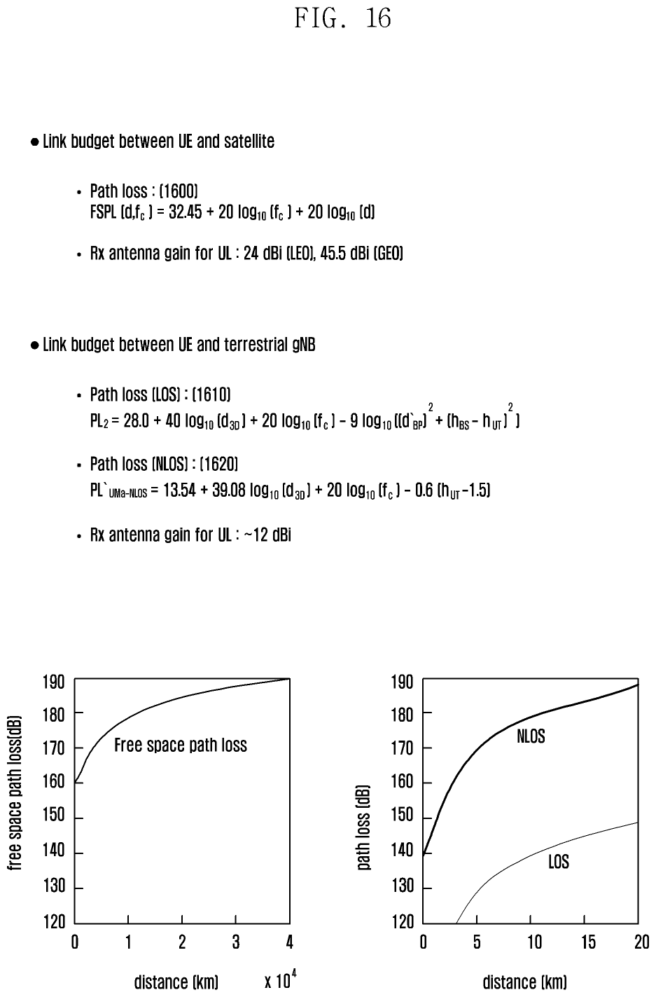

FIG. 16 is a diagram illustrating a path loss value according to a path loss model between a UE and a satellite, and a path loss according to a path loss model between the UE and a terrestrial network communication base station. In FIG. 16, d corresponds to a distance and f_{c} corresponds to a frequency of a signal. A path loss (FSPL) 1600 in a free space in which communication between the UE and the satellite is performed is inversely proportional to the square of the distance, but path losses (PL₂, PL′_{Uma-NLOS}) 1610 and 1620 on the ground on which air exists and communication between the UE and a terrestrial network communication base station (terrestrial gNB) is performed is inversely proportional almost to 4th power of the distance. Here, d_{3D} indicates a straight-line distance between the UE and the base station, h_{BS} indicates a height of the base station, and h_{UT} indicates a height of the UE. It is calculated that d′_{BP}=4×h_{BS}×h_{UT}×f_{c}/c. Here, fc indicates a central frequency in units of Hz and c indicates a speed of light in units of m/s.

In satellite communication (or non-terrestrial network (NTN)), Doppler shift, that is, frequency movement (offset) of a transmission signal is generated due to continuous fast movement of the satellite.

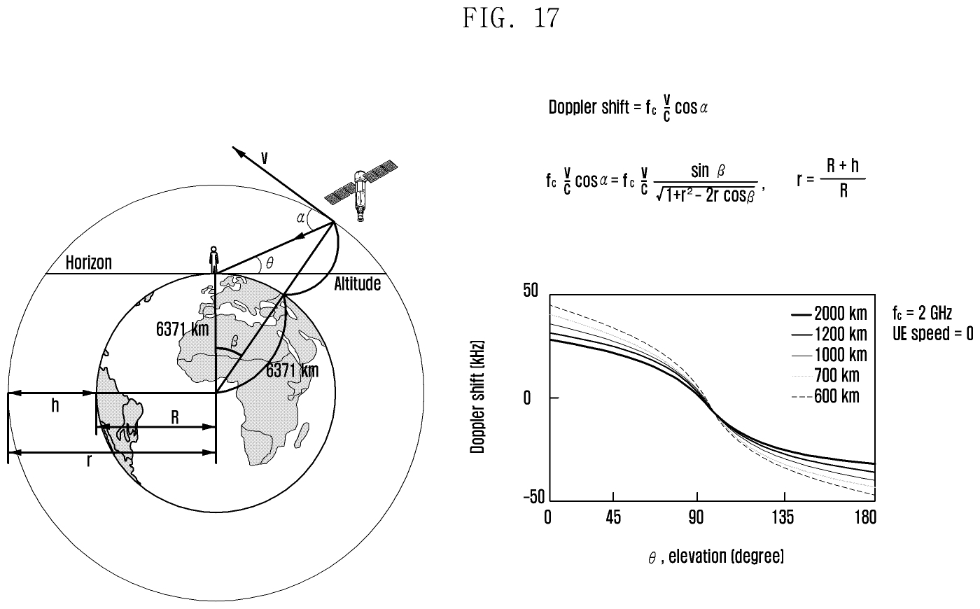

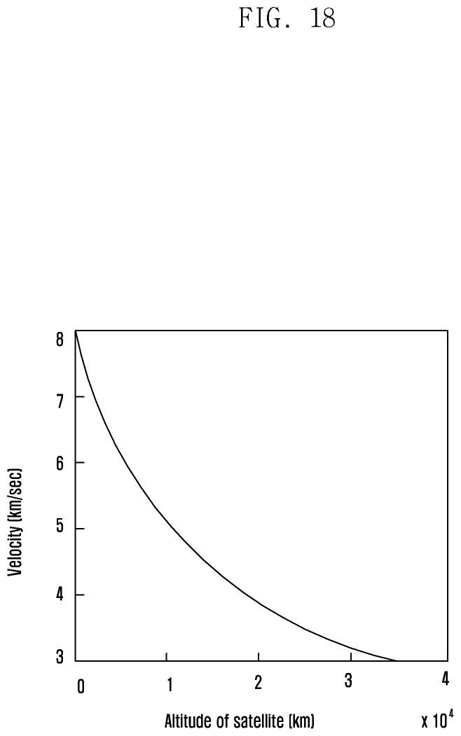

FIG. 17 is a diagram illustrating equations and results for calculating an amount of Doppler shift experienced by a signal which is transmitted from a satellite is received by a user of a UE on the ground according to an altitude and a location of the satellite, and a location of the user of the UE on the ground. An earth radius is R, h is an altitude of the satellite, v is a speed of revolution of the satellite around the earth, and f_{c} is a frequency of a signal. The speed of the satellite may be calculated from the altitude of the satellite, which corresponds to a speed making the gravity, which is the force that the earth pulls the satellite, the same as the centripetal force generated according to the revolution of the satellite, and may be calculated as shown in FIG. 18. FIG. 18 is a diagram illustrating a speed of a satellite calculated at an altitude of the satellite. As identified in FIG. 17, an angle α is determined by an elevation angle Θ, and thus a value of Doppler shift is determined according to the elevation angle Θ.

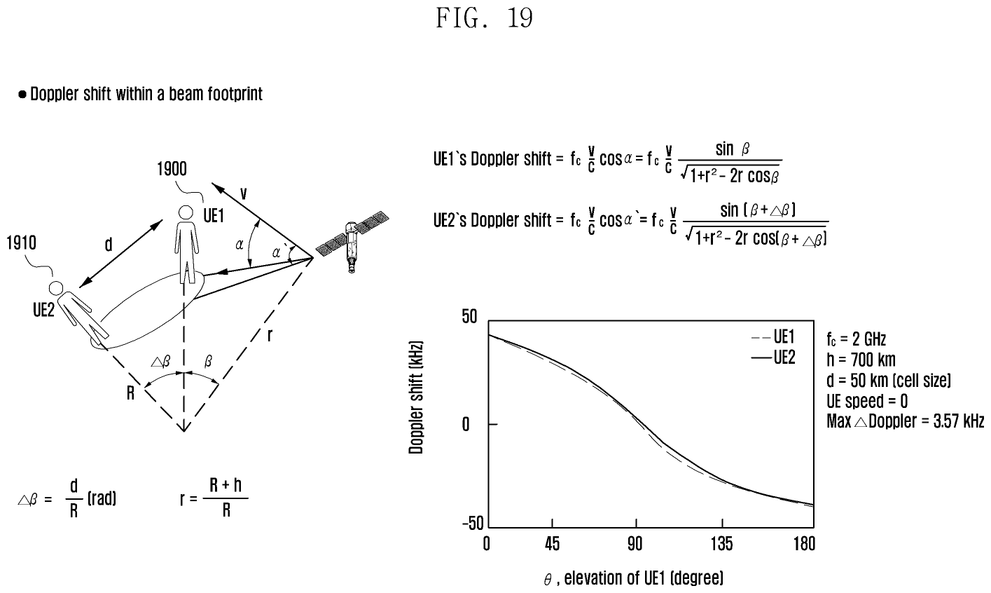

FIG. 19 is a diagram illustrating Doppler shift experienced by different UEs in one beam transmitted by a satellite to the ground. Referring to FIG. 19, Doppler shift experienced by a UE 1 1900 and Doppler shift experienced by a UE 2 1910 according to an elevation angle Θ are calculated. Such Doppler shift is a result of an assumption that a center frequency is 2 GHz, a satellite altitude is 700 km, a diameter of one beam is 50 km on the ground, and a speed of a UE is 0. Further, the Doppler shift calculated in the disclosure ignores an effect according to a speed of earth rotation, which may be considered as small influence because the speed is slow compared to the speed of the satellite.

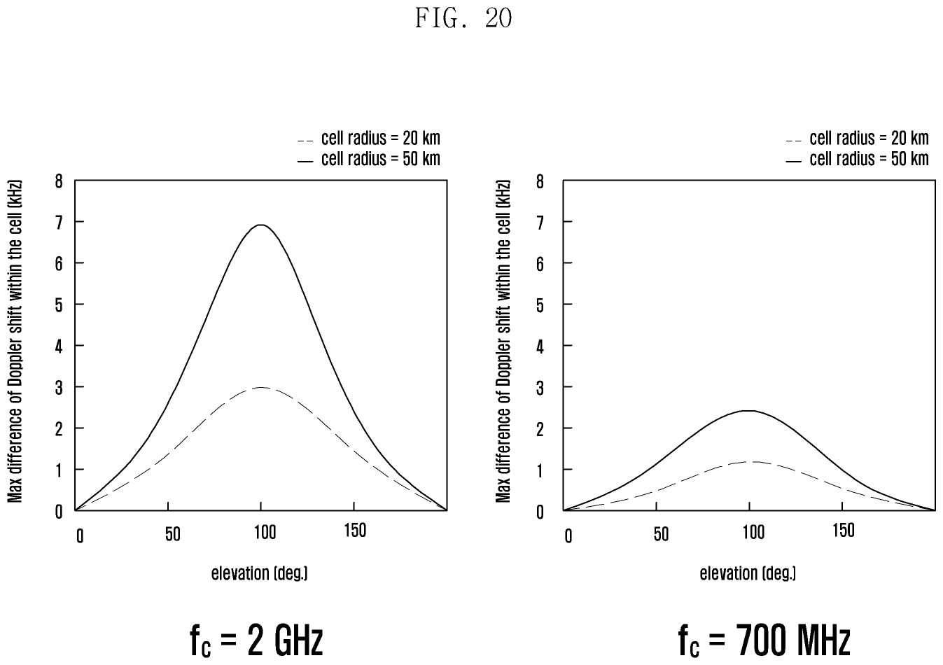

FIG. 20 is a diagram illustrating a difference in Doppler shift which occurs within one beam according to a location of a satellite determined from an elevation angle. When the satellite is located directly above a beam, that is, when an elevation angle is 90 degrees, the difference between Doppler shifts is the largest within the beam (or cell). This may be because when the satellite is above the center of the beam, Doppler shift values at one end of the beam and at the other end of the beam have positive and negative values, respectively.

Meanwhile, in a satellite communication, a satellite is far from a user on the ground, so a large delay time occurs compared to a terrestrial network communication.

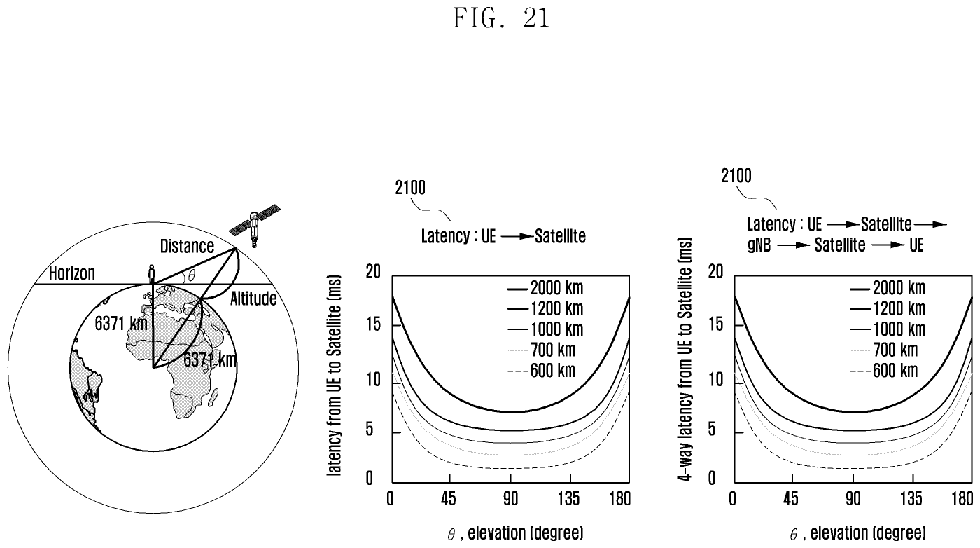

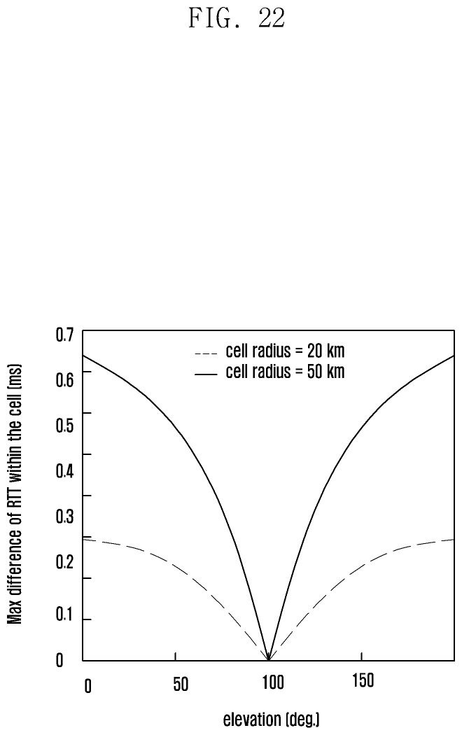

FIG. 21 is a diagram illustrating a delay time taken from a UE to a satellite and a round trip delay time among the UE, the satellite, and a base station according to a location of the satellite determined according to an elevation angle. Reference numeral 2100 indicates a delay time from the UE to the satellite, and reference numeral 2110 indicates a round trip delay time between the UE, the satellite, and the base station. Here, it is assumed that the delay time between the satellite and the base station and the delay time between the UE and the satellite are equal to each other. FIG. 22 is a diagram illustrating a maximum difference value of round trip delay times which varies according to a location of a user within one beam. For example, if a beam radius (or a cell radius) is 20 km, it may be regarded that a difference in round trip times to a satellite which UEs whose locations are different within a beam differently experience may be equal to or less than about 0.28 ms.

In a satellite communication, a case that a UE transmits and receives a signal to and from a base station may be a case that the signal is delivered via a satellite. That is, the satellite may serve to receive a signal having been transmitted by the base station to the satellite, and then transmit the signal to the UE in the downlink, and may serve to receive a signal having been transmitted by the UE to the satellite, and then transmit the signal to the BS in the uplink. The satellite may receive the signal and then transmit the signal after performing only frequency shift or may perform signal processing such as decoding and re-encoding, etc., based on the received signal and then transmit the signal.

In a case of LTE or NR, a UE may access a base station according to the following procedure.
Step 1: The UE receives a synchronization signal (or synchronization signal block (SSB) which may include a broadcasting signal) from the base station. The synchronization signal may include a primary synchronization signal (PSS), a secondary synchronization signal (SSS), and a physical broadcast channel (PBCH). The synchronization signal may include information such as a slot boundary of a signal transmitted by the base station, a frame number, downlink and uplink configuration, and the like. Further, through the synchronization signal, the UE may acquire a subcarrier offset, scheduling information for transmitting system information, and the like.
Step 2: The UE receives system information (system information block (SIB)) from the base station. The SIB may include information for performing initial access and random access. Information for performing random access may include resource information for transmitting a random access preamble.
Step 3: A random access preamble (or message 1 (msg1)) is transmitted in random access resources configured in step 2. The preamble may be a signal determined based on the information configured in step 2 using a predetermined progression. The base station receives the random access preamble transmitted by the UE. The base station may attempt to receive the random access preamble via a resource configured by the base station without knowing which UE transmits the random access preamble, and when the reception is successful, may know that at least one UE transmitted the preamble.

Step 4: If the random access preamble is received in Step 3, the base station transmits a random access response (RAR) (or a message 2 (msg2)) in response to the random access preamble. The UE which has transmitted the random access preamble in Step 3 may attempt to receive the RAR transmitted by the base station in Step 4. The RAR is transmitted on a PDSCH, and a PDCCH scheduling the PDSCH is transmitted together or in advance. A CRC scrambled by an RA-RNTI value is added to DCI for scheduling the RAR, and the DCI (and CRC) is channel-coded and then mapped to the PDCCH and transmitted. The RA-RNTI may be determined based on time and frequency resources via which the preamble in Step 3 is transmitted.

Maximum limit time until the UE which transmits the random access preamble in Step 3 receives the RAR in Step 4 may be configured in the SIB transmitted in Step 2. The maximum limit time may be configured limitedly, for example, up to 10 ms, 40 ms, or the like. That is, if the UE which transmits the random access preamble in Step 3 does not receive the RAR within a time determined based on, for example, 10 ms which is the configured maximum limit time, the UE may retransmit the random access preamble. The RAR may include scheduling information for allocating a resource of a signal to be transmitted by the terminal in Step 5, which is the subsequent step.

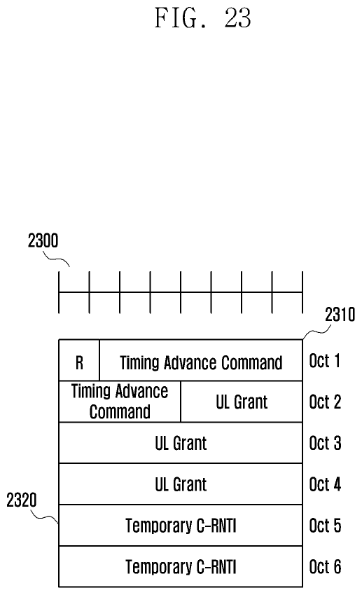

FIG. 23 is a diagram illustrating an example of an information structure (MAC payload) of an RAR. This may be a MAC payload format (fallback RAR) of Msg B. An RAR 2300 may be, for example, a MAC PDU, and may include information 2310 on timing advance (TA) to be applied by the UE and a temporary C-RNTI value 2320 to be used in the following step.
R field: is a reserved bit and may be configured as, for example, “0”.
Timing advance command field 2310: indicates an index value T_{A} used to control an amount of timing control which should be applied by the MAC entity. The size of the timing advance command field is, for example, 12 bits.
UL grant field: indicates resources to be used in the uplink, wherein the size of the UL grant field is, for example, 27 bits.
Temporary C-RNTI field 2320: indicates a temporary identifier used by the MAC entity during random access, wherein the size of the temporary C-RNTI field is, for example, 16 bits.
Step 5: The UE receiving the RAR in step 4 transmits message 3 (msg3) to the base station according to scheduling information included in the RAR. The UE may include a unique ID value of the terminal into the msg3 to transmit the msg3. The base station may attempt reception of msg3 according to the scheduling information which the base station transmitted in step 4.
Step 6: after receiving msg3 and identifying ID information of the UE, the base station generates message 4 (msg4) including the ID information of the UE and transmits same to the UE. The UE transmitting msg3 in step 5 may attempt to receive msg4 to be transmitted in step 6 thereafter. The UE having received msg4 may compare the ID included in msg4 with the ID which the UE transmitted in step 5 and identify whether msg3 which the UE has transmitted is received by the base station. There may be a constraint on time from the time at which the UE transmits the msg3 in Step 5 to the time at which the UE receives the msg4 in Step 6, and a maximum time may be configured by the SIB in step 2.

When the initial access procedure using the steps is applied to satellite communication, a propagation delay time in the satellite communication may cause a problem. For example, an interval (random access window) from transmission of the random access preamble (or PRACH preamble) by the UE in step 3 to reception of the RAR in step 4, that is, a maximum time to the reception thereof may be configured through ra-ResponseWindow, and the maximum time in the conventional LTE or 5G NR system may be configured up to a maximum of 10 ms.

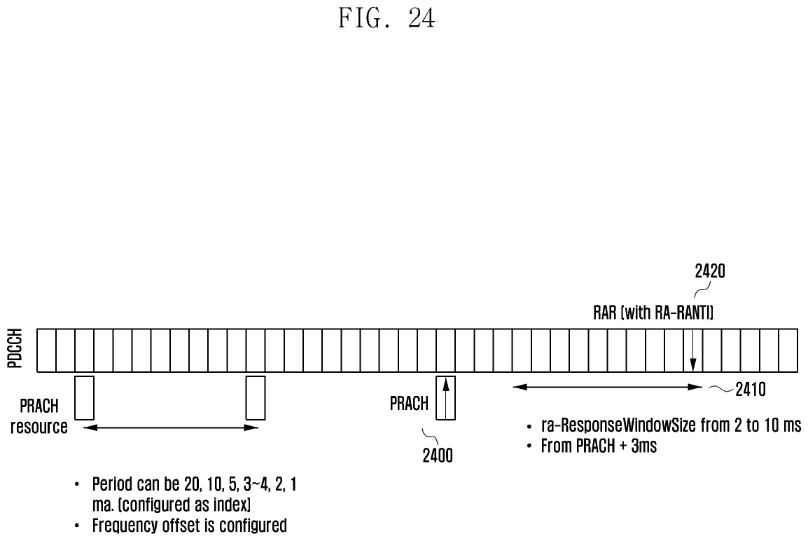

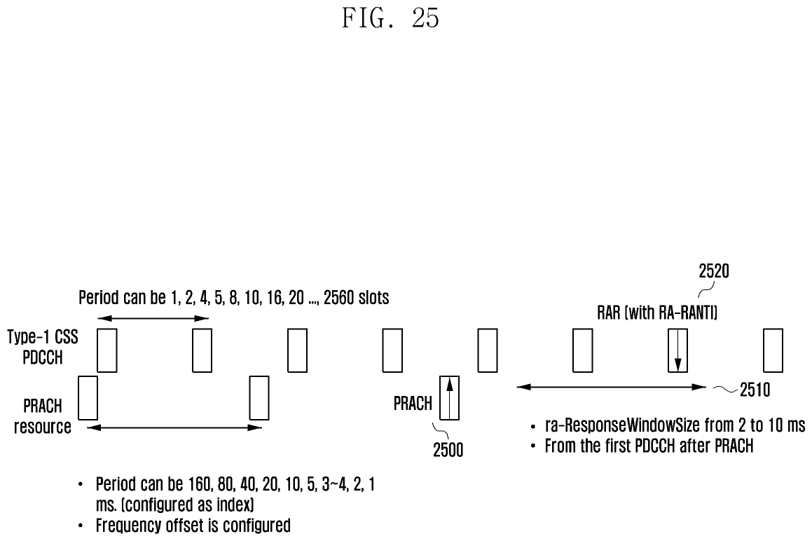

FIG. 24 is a diagram illustrating an example relationship between a PRACH preamble configuration resource and an RAR reception time point in an LTE system, and FIG. 25 is a diagram illustrating an example relationship between a PRACH preamble configuration resource and an RAR reception time point in a 5G NR system. Referring to FIG. 24, in the case of LTE, a random access window 2410 starts at a time point after 3 ms from transmission 2400 of a PRACH (random access preamble), and when the UE receives an RAR within the random access window (2420), it may be determined that transmission of the PRACH preamble is successful. Referring to FIG. 25, in the case of NR, a random access window 2510 starts from a control information area for RAR scheduling that first appears after transmission 2500 of the PRACH (random access preamble). When the UE receives the RAR within the random access window (2520), it may be determined that transmission of the PRACH preamble is successful.

By way of example, a TA for uplink transmission timing in a 5G NR system may be determined as follows. First, it is determined that T_{c}=1/(Δfₘₐₓ·N_{f}), wherein Δfₘₐₓ=480·10³ Hz and N_{f}=4096. Further, κ=Tₛ/T_{c}=64 and it may be defined that Tₛ=1/(Δf_{ref}·N_{f,ref}), Δf_{ref}=15·10³ Hz, and N_{f,ref}=2048.

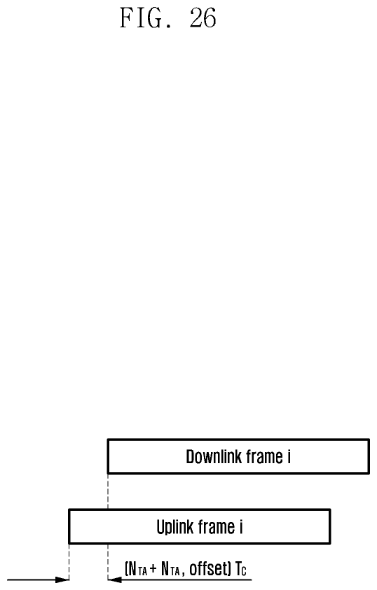

FIG. 26 is a diagram illustrating an example of downlink frame timing and uplink frame timing in a UE. The UE may advance an uplink frame by T_{TA}=(N_{TA}+N_{TA,offset})T_{c}, based on the time point of a downlink frame and perform uplink transmission. In the above, a value of N_{TA} may be transmitted through an RAR or may be determined based on a MAC CE, and N_{TA,offset} may be a value configured in the UE or determined based on a predetermined value.

An RAR of a 5G NR system may indicate a T_{A} value, and in this case, T_{A} may indicate one of 0, 1, 2, . . . , 3846. In this case, when subcarrier spacing (SCS) of the RAR is 2^{μ}·15 kHz, N_{TA} is determined as N_{TA}=T_{A}·16·64/2^{μ}. After the UE completes the random access process, a change value of TA may be indicated from the base station through a MAC CE or the like. T_{A} information indicated through the MAC CE may indicate one of 0, 1, 2, . . . , 63, which may be used to calculate a new TA value through addition to or subtraction from the existing TA value, and the resultant TA value may be newly calculated as N_{TA}_{_{≠w}}=N_{TA}_{_{old}}+(T_{A}−31)·16·64/2^{μ}. The indicated TA value may be applied to uplink transmission by the UE after a predetermined time.

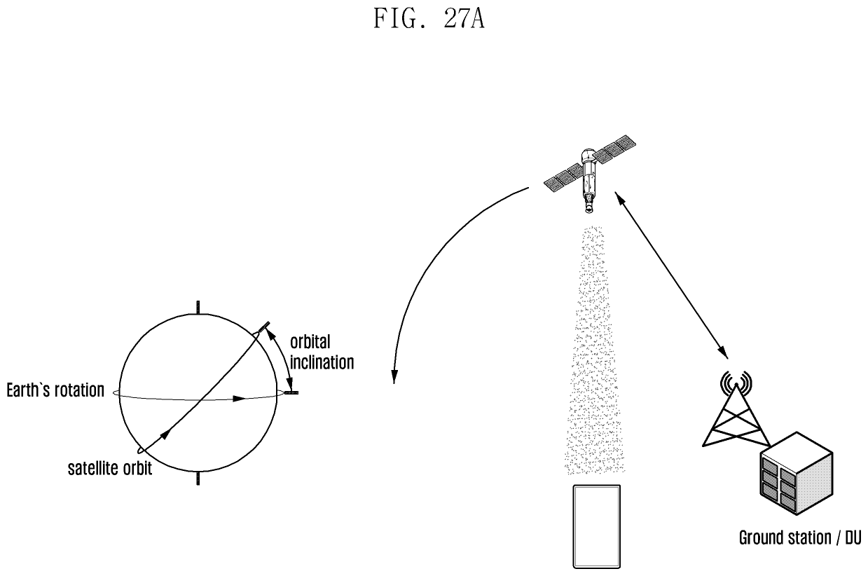

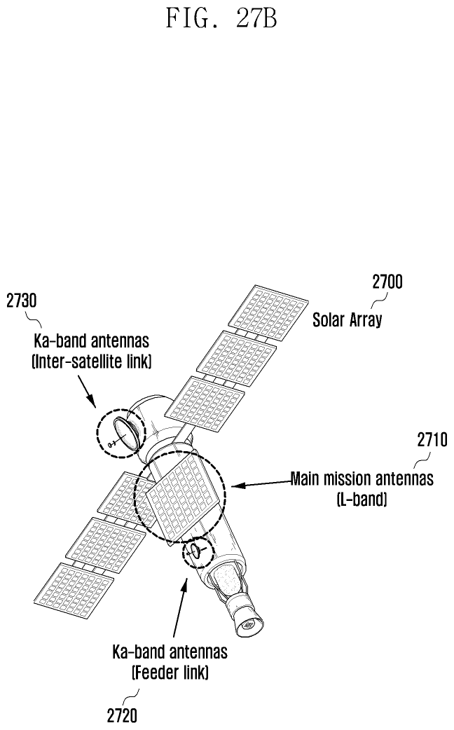

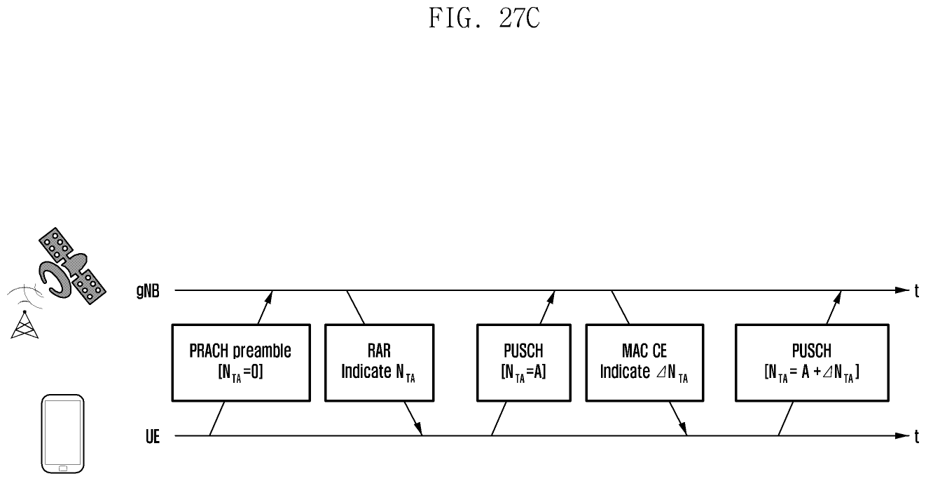

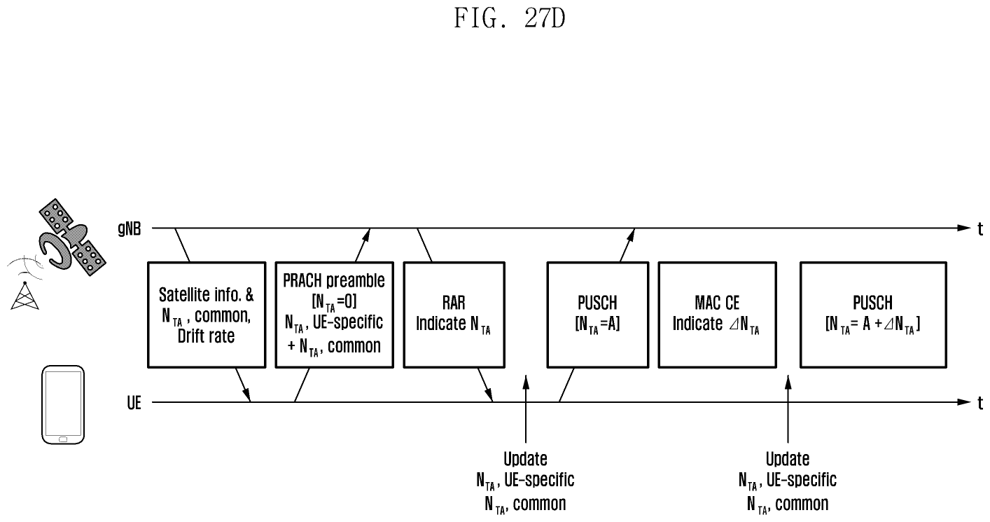

FIG. 27A is a diagram illustrating an example of continuous movement of a satellite with respect to a UE located on the ground or on the earth as the satellite revolves around the earth along a satellite orbit. Since the distance between the UE and the satellite varies depending on an elevation angle at which the UE views the satellite, the propagation delay between the UE, the satellite, and the base station may be different.

FIG. 27B is a diagram illustrating an example structure of an artificial satellite. The satellite may include a solar panel or a solar array 2700 for photovoltaic or solar power generation, a transmission and reception antenna (main mission antenna) 2710 for communication with the UE, a transmission and reception antenna (feeder link antenna) 2720 for communication with the ground station, a transmission and reception antenna (inter-satellite link) 2730 for communication between satellites, and a processor for controlling transmission and reception and processing a signal. When communication between satellites is not supported according to the satellite, the antenna for signal transmission and reception between satellites may not be arranged. Although FIG. 27B illustrates that an L band of 1 to 2 GHz is used for communication with the UE, a K band (18 to 26.5 GHz), a Ka band (26.5 to 40 GHz), and a Ku band (12 to 18 GHz) corresponding to high-frequency bands may be used.

Furthermore, in various embodiments of the disclosure, the term “base station (BS)” may refer to a predetermined component (or a set of components) configured to provide wireless access, such as a transmission point (TP), a transmit-receive point (TRP), an enhanced node B (eNodeB or eNB), a 5G base station (gNB), a macrocell, a femtocell, Wi-Fi access point (AP), or other wireless-enabled devices, based on the type of the wireless communication system. Base stations may provide wireless access according to one or more radio protocols, for example, 5G 3GPP new radio interface/access (NR), long-term evolution (LTE), LTE advanced (LTE-A), high-speed packet access (HSPA), or Wi-Fi 802.11a/b/g/n/ac.

Furthermore, in various embodiments of the disclosure, the term “terminal” may refer to a predetermined component, such as “user equipment (UE),” “mobile station,” “subscriber station,” “remote terminal,” “wireless terminal,” “receive point,” or “user device.” For convenience, the term “UE” is used to refer to a device that accesses a base station regardless of whether it needs to be considered as a mobile device (such as a mobile phone or a smartphone) or a stationary device (such as a desktop computer or vending machine).

In various embodiments of the disclosure, the term “TA” may be used interchangeably with “TA information”, “TA value”, “TA index”, or the like.

In various embodiments of the disclosure, data or control information which the base station transmits to the UE may be referred to as a first signal, and an uplink signal associated with the first signal may be referred to as a second signal. For example, the first signal may include DCI, a UL grant, a PDCCH, a PDSCH, an RAR, and the like, and the second signal associated with the first signal may include a PUCCH, a PUSCH, msg 3, and the like.

Furthermore, there may be association between the first signal and the second signal. By way of example, when the first signal is a PDCCH including a UL grant for uplink data scheduling, the second signal corresponding to the first signal may be a PUSCH including uplink data. Meanwhile, a difference (gap) between time points at which the first signal and the second signal are transmitted and received may be a predetermined value between the UE and the base station. Alternatively, a difference between time points at which the first signal and the second signal are transmitted and received may be determined by an indication of the BS or determined by a value transmitted through higher layer signaling.

Since the distance between the UE and the satellite and the distance between the satellite and the base station and are long and the satellite continuously moves, a time offset may be generated due to a delay time in direct communication when the UE or the base station receives a signal which the base station or the UE transmits. Accordingly, the disclosure provides a method and a device in which, in order to correct the time offset, the base station indicates time offset information and the UE corrects the time offset according to the time offset information. The following example embodiments are described based on the assumption of communication between the UE, and the satellite and the ground base station, but do not exclude a case in which the satellite base station communicates with the UE. In the disclosure, the time offset may be interchangeably used with timing advance. The method and the device provided by various embodiments of the disclosure may be applied not only to a satellite communication system but also to a grand communication system.

### First Example Embodiment

A first embodiment of the disclosure provides a scheme in which a UE directly determines (e.g., calculates) a TA value when the UE transmits an uplink signal to a satellite or a base station, and applies the determined TA value. Further, the first embodiment of the disclosure provides a method and a device in which the base station or the satellite indicates a TA value to be applied to the UE when the UE transmits an uplink signal to the satellite or the base station and the UE applies the indicated TA value to transmit the uplink signal. In addition, the first embodiment of the disclosure provides a method and a device in which the UE adaptively determines the TA value to be applied when the UE transmits an uplink signal to the satellite or the base station. More specifically, the first example embodiment of the disclosure provides a method by which the UE determines the TA value by itself and a method and a device in which the BS or the satellite indicates the TA value to the UE as described above and the UE adaptively selects one of the methods of applying the indicated TA value and determines the TA value.

First, the UE may compare an uplink transmission time point with a downlink reception time point for uplink synchronization and advance the uplink transmission time point by T_{TA} from the downlink reception time point, based on the comparison result. T_{TA} calculated for TA in satellite communication may be expressed as shown in Equation 5 below.

T_{TA}=(N_{TA}+N_{TA,UE-specific}+N_{TA,common}+N_{TA,offset})×T_{c} [Equation 5]

In Equation 5 above, T_{c} may be T_{c}=1/(Δfₘₐₓ·N_{f}), and Δfₘₐₓ=480·10³ Hz and N_{f}=4096. In [Equation 5] above, T_{TA} may be a value determined based on a TA value or the like included in an RAR or a MAC CE received from the base station, and N_{TA,offset} may be a pre-fixed or pre-agreed value. In Equation 5 above, N_{TA,UE-specific} may be a TA correction value measured by the UE, based on locations of the UE and the satellite (or reference location), and N_{TA,common} may be a TA correction value configured or indicated using higher signaling or a physical layer signal.

Equation 5 above may be an equation to which parameters N_{TA,UE-specific} and N_{TA,common} are added compared to Equation 6 below that is the conventional TA application method.

T_{TA}=(N_{TA}+N_{TA,offset})×T_{c} [Equation 6]

FIG. 27C is a diagram illustrating an example process in which a UE determines N_{TA} from an initial access. FIG. 27D is a diagram illustrating an example process in which a UE determines N_{TA}, N_{TA,UE-specific}, and N_{TA,common} from an initial access, which is a method provided by the disclosure.

T_{TA} may be determined as N_{TA}=T_{A} 16·64/2^{μ}, based on T_{A}=0, 1, 2, . . . , 3846, which is transmitted on a RAR or msg B. T_{A}=0, 1, 2, . . . , 63 may be transmitted through a MAC CE and may be updated to N_{TA_new}=N_{TA_old}+(T_{A}−31)·16·64/2^{μ}. Further, Δfₘₐₓ,Nⱼ, T_{A} transmitted through the RAR or msgB, the T_{A} value transmitted through the MAC CE, and the like may be changed according to a communication system. In a case that the UE performs the TA update like N_{TA_new}=T_{TA_old}+(T_{A}−M)·16·64/2^{μ}, based on T_{A} transmitted from the MAC CE, the M value may be a value larger than or equal to 31 if a maximum value of T_{A} is larger than 63 and the M value may be a value equal to or smaller than 31 if the maximum value of T_{A} is smaller than 63, and the UE may determine the updated N_{TA} value N_{TA_new} on the basis thereof.

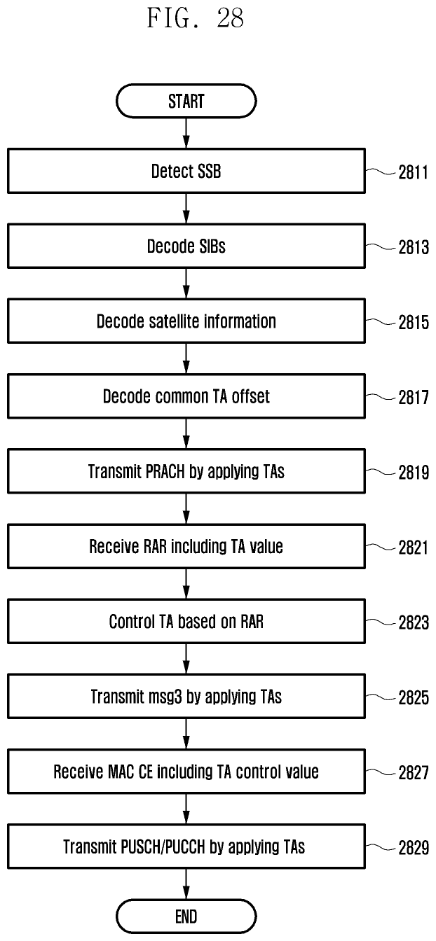

Another example of an operation process of a UE in a communication system according to various embodiments of the disclosure will be described with reference to FIG. 28.

FIG. 28 is a diagram schematically illustrating an example operation process of the UE in a communication system according to various embodiments of the disclosure.

Referring to FIG. 28, the UE may perform an initial access procedure according to a process described with reference to FIG. 28 and determine TA after performing the initial access procedure, which is described below in detail.

In operation 2811, the UE detects a synchronization signal and PBCH block (SSB) received from the base station. In operation 2813, the UE decodes system information blocks (SIBs), based on the detected SSB. The UE may detect information on random access channel (RACH) resources by decoding the SIBs.

In operation 2815, the UE acquires (or decodes) satellite information by decoding the SIBs. The satellite information may include at least one of various parameters, such as location information of the satellite. In operation 2815, the UE may acquire a UE-specific T_{A} correction value, for example, N_{TA,UE-specific}, based on the locations (or reference location) of the UE and the satellite, based on the acquired location information. In operation 2817, the UE acquires (or decodes) a common T_{A} offset, for example, N_{TA,common} by decoding the SIBs.

In operation 2819, the UE may calculate TAs based on N_{TA,UE-specific} and N_{TA,common} and transmit a PRACH to the base station by applying the calculated TAs. In operation 2821, the UE receives an RAR including a TA value in response to transmission of the PRACH. In operation 2823, the UE controls TA, based on the received RAR.

In operation 2825, the UE transmits msg3 to the base station by applying TA. Here, msg3 is a part of the random access procedure, and indicates a message which includes a C-RNTI MAC CE or a CCCH SDU and is transmitted in the UL-SCH, and may be first scheduled transmission of the random access procedure. In operation 2827, the UE receives a MAC CE including the TA control value form the base station. In operation 2829, the UE applies TA, based on the TA control value included in the MAC CE and transmits a PUSCH/PUCCH. Transmission of PUSCH/PUCCH may represent transmission of at least one of the PUSCH and the PUCCH in various embodiments of the disclosure.

The operation process of the UE as described with reference to FIG. 28, that is, the process of performing the initial access procedure and determining TA after performing the initial access procedure may be compared to an operation process of the UE according to an embodiment of the disclosure summarized as shown in Table 21 below.

TABLE 21

| UE operation process | UE operation process based on FIG. 28 |
|---|---|
| 1. Detect SSB2. Decode SIBs (detect RACH | 1. Detect SSB |
| resource information) | 2. Decode SIBs (detect RACH resource |
| 3. Transmit PRACH | information) |
| 4. Receive RAR including TA value | 3. Decode satellite information (location |
| 5. Control TA on the basis of RAR | information or the like) and acquire |
| 6. Transmit msg3 by applying TA | N_{TA, UE-specific} |
| 7. Receive MAC CE including TA control | 4. Decode common TA offset and acquire |
| value | N_{TA, common} |
| 8. Transmit PUSCH/PUCCH by applying TA, | 5. Transmit PRACH by applying TAs |
| based on TA control value | 6. Receive RAR including TA value |
| | 7. Control TA, based on RAR |
| | 8. Transmit msg3 by applying TA |
| | 9. Receive MAC CE including TA control |
| | value |
| | 10. Transmit PUSCH/PUCCH by |
| | applying TA |

Further, the order of some operations in the operation process of the UE described with reference to FIG. 28 may be changed, and for example, the order of the operation of decoding satellite information and the operation of decoding the common TA offset may be changed.

Although the operation process of the UE in the communication system according to various embodiments of the disclosure has been described with reference to FIG. 28, it should be noted that various modifications may be made with respect to FIG. 28. For example, consecutive steps are illustrated in FIG. 28, but the steps of FIG. 28 may overlap each other or may be performed in parallel, the order thereof may be changed, or one or more steps may be performed several times.

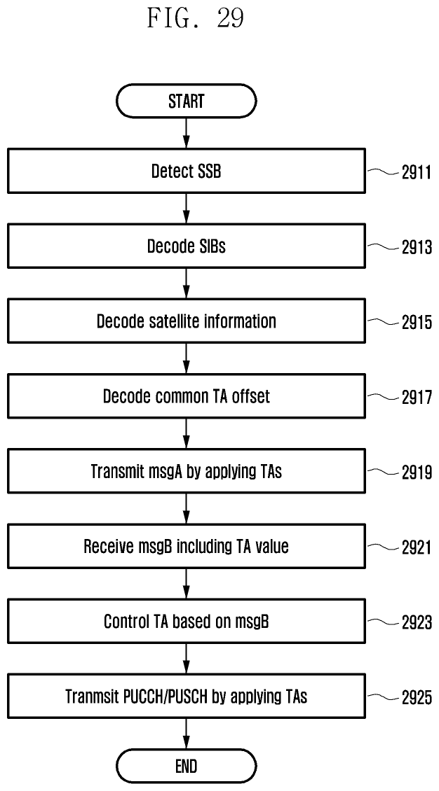

Next, an example operation process of a UE in a communication system according to various embodiments of the disclosure will be described with reference to FIG. 29.

FIG. 29 is a diagram schematically illustrating an example operation process of the UE in a communication system according to various embodiments of the disclosure.

Referring to FIG. 29, the UE may perform an initial access procedure according to a process described with reference to FIG. 29 and determine TA after performing the initial access procedure, which is described below in detail. Particularly, the operation process of the UE illustrated in FIG. 29 may be an operation process of the UE, based on a random access procedure for a 2-step RA type while FIG. 29 illustrates the operation process of the UE, based on the random access procedure for a 4-step random access (RA) type.

First, in operation 2911, the UE detects an SSB received from the base station. In operation 2913, the UE decodes SIBs, based on the detected SSB. Here, the UE may acquire information on RACH resources by decoding the SIBs.

In operation 2915, the UE acquires (or decodes) satellite information by decoding the SIBs. The satellite information may include at least one of various parameters, such as location information of the satellite. In operation 2915, the UE may acquire a UE-specific TA correction value, for example, N_{TA,UE-specific} based on the locations (or reference location) of the UE and the satellite, based on the decoded location information. In operation 2917, the UE acquires (or decodes) a common TA offset, for example, N_{TA,common} by decoding the SIBs.

In operation 2919, the UE may calculate TAs, based on N_{TA,UE-specific} and N_{TA,common} and transmit msgA to the base station by applying the calculated TAs. Here, msgA may be transmission of a preamble and payload in the random access procedure for the 2-step random access (RA) type. In operation 2921, the UE receives msgB including the TA value from the base station. Here, msgB is a response to msgA in the random access procedure for the 2-step RA type and may include a response (responses) to contention resolution, fallback indication(s), and backoff indication. In operation 2923, the UE controls TA, based on the TA control value included in msgB. In operation 2925, the UE transmits a PUSCH/PUCCH by applying the controlled TA.

The operation process of the UE as described with reference to FIG. 29, that is, the process of performing the initial access procedure and determining TA after performing the initial access procedure may be compared to an operation process of the UE according to an embodiment of the disclosure summarized as shown in Table 22 below.

TABLE 22

| UE operation process | UE operation process based on FIG. 29 |
|---|---|
| 1. Detect SSB2. Decode SIBs (detect RACH | 1. Detect SSB |
| resource information) | 2. Decode SIBs (detect RACH resource |
| 3. Transmit MsgA (PRACH + Msg3) | information) |
| 4. Receive MsgB including TA value | 3. Decode satellite information (location |
| 5. Control TA, based on MsgB | information or the like) and acquire |
| 6. Transmit PUCCH/PUSCH by applying TA | N_{TA, UE-specific} |
| | 4. Decode common TA offset and acquire |
| | N_{TA, common} |
| | 5. Transmit MsgA by applying TAs |
| | 6. Receive MsgB including TA value |
| | 7. Control TA, based on MsgB |
| | 8. Transmit PUCCH/PUSCH by applying |
| | TA |

Further, the order of some operations in the operation process of the UE described with reference to FIG. 29 may be changed, and for example, the order of the operation of decoding satellite information and the operation of decoding the common T_{A} offset may be changed.

Although the operation process of the UE in the communication system according to various embodiments of the disclosure has been described with reference to FIG. 29, it should be noted that various modifications may be made with respect to FIG. 29. For example, consecutive steps are illustrated in FIG. 29, but the steps of FIG. 29 may overlap each other or may be performed in parallel, the order thereof may be changed, or one or more steps may be performed several times.

N_{TA,UE-specific} used in embodiments of the disclosure is a value calculated and applied by the UE. Accordingly, the base station may not know the value of N_{TA,UE-specific} calculated by the UE. Further, the value of N_{TA,UE-specific} calculated by the UE may change over time due to movement of the UE or the satellite.

Therefore, in embodiments of the disclosure, the base station may need to control T_{A} of the UE in consideration of the value of N_{TA,UE-specific} which may change over time, and thus the UE may need to configure a time point to update the value of N_{TA,UE-specific}. The UE may update the value of N_{TA,UE-specific}, based on one of the following methods, for example, method T1 to method T6 or a method of combining at least two of method T1 to method T6.
Method T1: The UE always updates N_{TA,UE-specific} at every time point at which the SIB including satellite information (e.g., including satellite information and the like) is received. Method T1 may be applied to a case in which the UE determines that the SIB is received from the base station or a case in which the UE determines that a paging signal indicating an SIB update is received from the base station.
Method T2: The base station may separately indicate a change rate of TA, for example, N_{TA,UE-specific}, and configure a period and an offset for calculating the TA value again according to the change rate of the TA, for example, updating the TA value. Here, the UE may update the TA, for example, N_{TA,UE-specific} at a time point determined according to the period and the offset, and an amount of the TA updated by the UE may be determined according to the change rate of the TA. In various embodiments of the disclosure, the base station may indicate the change rate of the TA, based on an explicit method or an implicit method.
Method T3: The base station may configure an update period and offset for updating N_{TA,UE-specific} by the UE, based on the location of the satellite and the location of the UE. Here, the UE may update the TA at the corresponding time point determined according to the update period and offset configured by the base station. In various embodiments of the disclosure, the base station may indicate the update period and offset, based on an explicit method or an implicit method.
Method T4: The UE may always update and apply N_{TA,UE-specific} at a corresponding time point, for example, at a corresponding slot time point in every case of at least some cases in which uplink transmission (e.g., PUCCH/PUSCH, PRACH, and SRS transmission) is performed (in every performance case, according to a regular period, and at an irregular performance time point).
Method T5: The UE updates N_{TA,UE-specific}, based on a time point at which a TA command transmitted by the base station through a MAC CE expires. For example, the UE updates N_{TA,UE-specific} at the time point at which TA expires. The expiration may refer, for example, to a time value reaching a specific time point, based on a timer for the TA command. The timer may be configured as timeAlignmentTimer and may be a parameter indicating how long the uplink time is synchronized. When receiving a new TA command, the UE may start or restart timeAlignmentTimer. When timeAlignmentTimer expires, the UE may empty an HARQ buffer and newly make an RRC configuration or the like.
Method T6: A new timer timeAlignmentTimer_UEspecific related to N_{TA,UE-specific} has been introduced, and the UE may update N_{TA,UE-specific}, based on the new timer timeAlignmentTimer_UEspecific. Here, timeAlignmentTimer_UEspecific may start or restart when the UE newly calculates N_{TA,UE-specific} or information on NA, UE-specific is transmitted to the base station. When timeAlignmentTimer_UEspecific expires, the UE may newly calculate N_{TA,UE-specific} to update the same, configure N_{TA,UE-specific} as 0, or perform PRACH transmission.

### Second Example Embodiment

The second example embodiment provides a method and a device for transmitting (reporting) a timing advance (TA) value which the UE is applying or has applied, to the base station or the satellite. In the disclosure, the satellite may include an object located high above the ground and correspond to the concept including an aircraft, an airship, or the like.

The UE may perform an operation of transmitting, to the base station, the TA value which the UE is applying. This is to inform the base station of the applied TA value when the UE applies the TA value without any separate indication from the base station or to identify or determine how the UE applies the TA value indicated by the base station. For example, the operation may be performed to identify, when the satellite connected to the UE is changed, the TA value of the UE by the satellite newly connected to the UE. By way of example, the UE may apply the TA calculated based on the locations of the UE and the satellite by itself.

The UE may use one or a combination of at least two of the following methods in order to report the TA value to the base station.
Method 1: The base station may trigger a TA value report of the UE through DCI. The base station may trigger the TA value report through some bit field values of DCI or a combination of the bit field values. When a field indicating triggering of the TA value report is included in DCI and the field of the received DCI is configured as a specific value, the UE may understand that the TA value report is triggered. Alternatively, when values of one or more fields (e.g., for another purpose) included in DCI are configured as predetermined values, the UE may understand that the TA value report is triggered. The UE may transmit the TA value at a specific time point based on the time point at which DCI is received to the base station.
Method 2: The base station may trigger a TA value report of the UE through a MAC CE. The base station may trigger the TA value report by using some bit values of the MAC CE or a value of a bit field, and the UE may transmit a TA value at a time point at which the MAC CE is received or a time point after a predetermined time from the time point at which the MAC CE is received to the base station.
Method 3: The base station may indicate which TA value should be reported by the UE through an RRC configuration. For example, the base station may configure a period and an offset value for the TA report through higher signaling or/and a specific condition for reporting the TA value by the UE and determine a time point when the UE reports the TA value, in which case, a TA value application time which is a reference (that is, a time at which the TA value to be reported is applied, which may be referred to as a TA value reference time point) may be designated. The specific condition for reporting the TA value by the UE may be, for example, a case in which the TA value is larger than or equal to a predetermined value or a case in which the distance between the UE and the satellite is longer than or equal to a predetermined value, and the predetermined values may be information or fixed values configured through higher signaling or transmitted through the SIB or the like.
Method 4: the UE may report the TA value without a separate trigger from the base station. For example, method 4 may correspond to transmission of information indicating the TA value according to the specific condition from the UE to the base station, and the specific condition (without signaling such as DCI, MAC CE, or RRC for triggering from the base station) is a condition for a time at which the TA value report is performed or a comparison result between the TA value applied by the UE and a specific threshold value or the like and may be predetermined.

In a case that the TA value is transmitted as described above, the UE may transmit the TA value through a physical channel such as a PUCCH or a PUSCH or may transfer TA value information to the base station through higher signaling. In a case that the UE transmits TA value information through the physical channel, resources to be used for reporting the TA value information may be configured through higher signaling.

The TA value report may refer, for example, to reporting a value of T_{TA} or a value of N_{TA,UE-specific} in the equation. Alternatively, which one of T_{TA} and N_{TA,UE-specific} is reported may be configured in the UE by the base station through the SIB or higher signaling.

The reference time point at which TA value reported by the UE is determined and the time point at which the TA value is reported may be determined based on a time point at which the UE performs the TA value report and a time point at which the TA value report is triggered. For example, when the TA value report is triggered in slot n through DCI, the UE may report a TA value applied or calculated in slot n-K or may report the TA value to the base station in slot n+N. K and N may be values determined according to subcarrier spacing or a UE capability, a DL/UL configuration of the slot, and a PUCCH resource configuration, etc.

K may be 0. K=0 may refer, for example, to the TA value being reported based on a time point at which a TA value report triggering signal is received. Further, K may be smaller than 0 and, in this case, for example, report information may be generated and reported by pre-calculating the TA value at the time point at which the UE reports the TA value. In addition, K may be an integer larger than 0. This may refer, for example, to the UE reporting the TA value at a time point earlier than the time point at which the UE reports the TA value (for example, slot n+N), which may be considered that the TA value is reported at the earlier time point since a time is needed to encode information to be reported by the UE and prepare transmission.

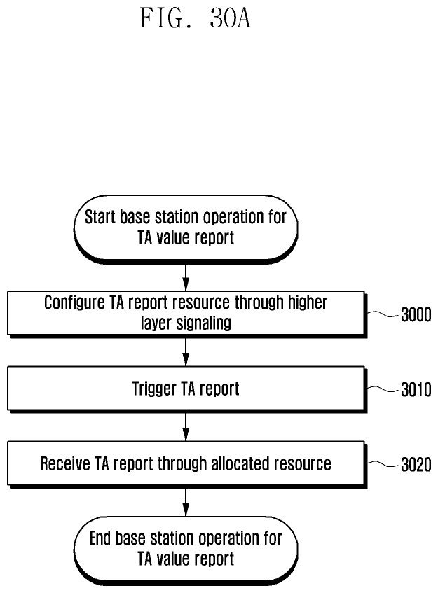

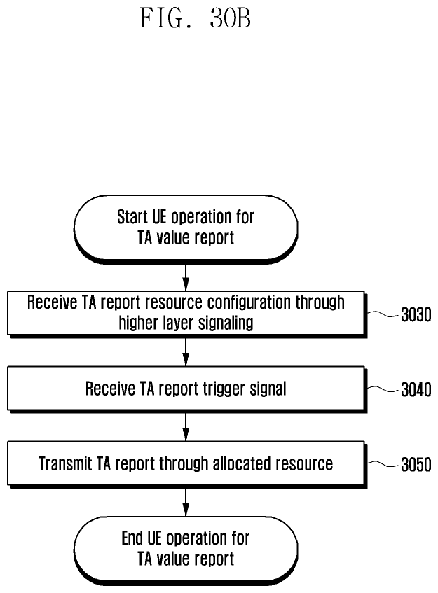

FIGS. 30A and 30B are diagrams illustrating example operations of a base station and a UE for TA value report of the UE. In the TA value report according to the disclosure, the TA value applied by the UE may be indicated in units of ms, slots, or symbols, or may be provided as information including a value after a decimal point rather than an integer. The TA value report according to the disclosure may include an absolute value of the TA, and may include a TA value previously indicated by the base station, a relative TA value except for a predetermined TA value, or a change in the TA value (e.g., a TA change for a predetermined time).

FIG. 30A illustrates an example operation of the base station. The base station transmits configuration information related to a TA report through higher signaling (3000). The configuration information may include, for example, at least one piece of information for configuring the TA report, such as a period and offset for performing the TA report, a TA report trigger condition, TA value reference time point information, a type of TA information to be reported, or resource configuration information for performing the TA report. The base station triggers the TA report to the UE (3010). The trigger may be performed through, for example, higher signaling or DCI as the above-described specific content or may be omitted. The base station receives the TA report transmitted by the UE according to transmitted configuration information (3020).

FIG. 30B illustrates an example operation of the UE. The UE receives configuration information related to the TA report transmitted by the base station through higher signaling (3030). The configuration information may include, for example, at least one piece of information for configuring the TA report, such as a period and offset for performing the TA report, a TA report trigger condition, TA value reference time point information, a type of TA information to be reported, or resource configuration information for performing the TA report. The UE receives a signal for triggering the TA report transmitted by the base station (3040). The trigger may be performed through, for example, higher signaling or DCI as the above-described specific content or may be omitted. The UE transmits the TA report according to the received configuration information (3050). For example, when receiving TA report resource information, the UE transmits the TA report in the configuration resources. The order of respective operations disclosed in FIG. 30A and FIG. 30B may be changed and applied, or another operation(s) may be added or omitted.

### Third Example Embodiment

The third example embodiment provides a method by which the UE calculates, determines, and reports N_{TA,UE-specific} described through the first example embodiment and the second example embodiment. A value of N_{TA,UE-specific} may be calculated based on the distance between the UE and a non-terrestrial network (NTN) satellite. The UE may calculate its own location by receiving signals from navigation satellites in a satellite navigation system, and the navigation satellite may be different from the NTN satellite.

The UE may estimate a delay time between the satellite and the UE, based on the location of the UE and the location of the satellite, and correct the estimated delay time value by itself to perform uplink transmission. For example, the satellite may transmit information on the location of the satellite through broadcast information, and the UE may receive the information on the location of the satellite transmitted by the satellite and compare the information on the location with its own location. The location of the UE may be known using one of various types of global positioning systems (GPSs) or independently using information from the base station or a combination thereof. The UE may calculate an uplink transmission time by estimating a time required for a radio wave to be transferred to the satellite through the comparison.

For example, assuming that the UE receives a downlink signal in a slot n via a downlink at a specific time point and needs to transmit an uplink signal corresponding to the received downlink signal in a slot n+k, the uplink transmission may be transmitted earlier than the time point of slot n+k by 2*Td. Td may be a delay time from the UE to the satellite, calculated based on location information of the satellite and the UE or may be a value corresponding thereto. The delay time Td may be a value obtained by dividing the distance between the UE and the satellite or a value corresponding thereto by the speed of light or a value corresponding thereto. For example, the location of the satellite may be a value calculated based on slot n+k in which the UE performs uplink transmission. This is because the location of the satellite in slot n and the location of the satellite in slot n+k may be different depending on movement of the satellite.

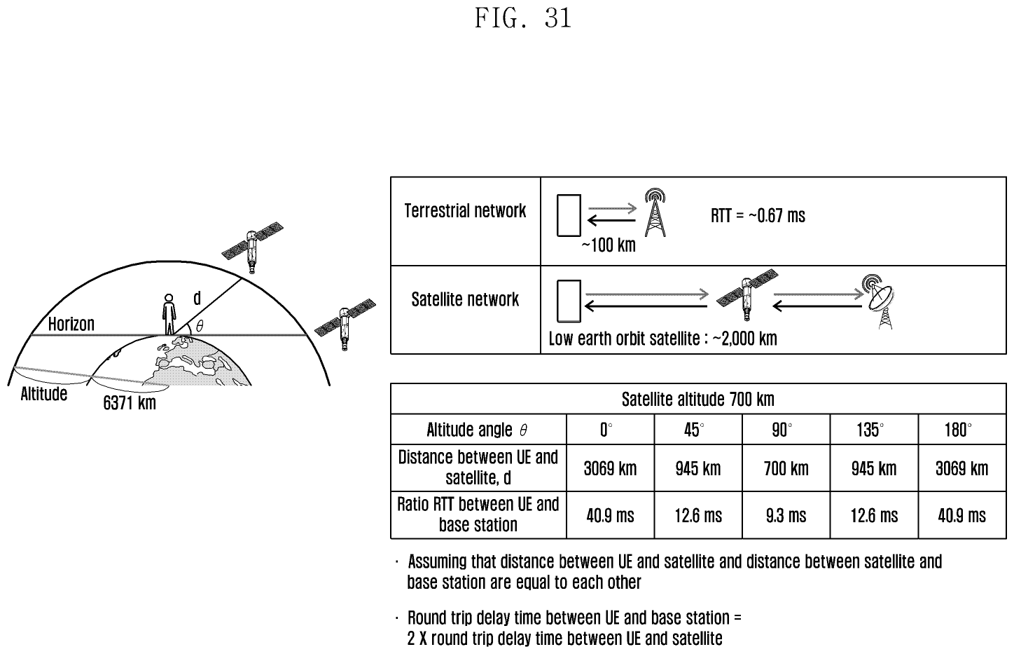

A propagation delay time equal to or less than 1 ms may be generated in the terrestrial network in consideration of the distance to the base station within a maximum of about 100 km, but the distance to the satellite may be thousands of km and the distance between the satellite and the base station may also be thousands of km in the satellite network and thus a delay time in the satellite network may be significantly longer than that of the terrestrial network. FIG. 31 is a diagram illustrating an example of a difference of propagation delay between a terrestrial network and a satellite network. The delay time may vary depending on altitude and an elevation angle of the satellite in satellite network communication, and FIG. 31 illustrates the distance between the UE and the satellite and a propagation round trip time according to the elevation angle when the altitude of the satellite is 700 km. In a case of the satellite network, a low earth orbit satellite is assumed, and a radio round trip time (radio RTT) (possibly including a round trip time spent for transmission of a signal between transceivers and a processing time in a counterpart node) may be from 40.9 ms to 9.3 ms when an elevation angle falls within 0 to 180 degrees. This delay time is only an example and may vary depending on altitude and orbit of the satellite, and, for example, the delay time may further increase as altitude is higher.

In the terrestrial network, since a maximum delay time is within 1 or 2 ms, it is possible to match slot timing at which the base station performs downlink transmission and slot timing at which the base station performs uplink reception through timing advance provided in the LTE and 5G NT systems (i.e., indexes of the DL slot and the UL slot may match each other). That is, when the UE advances uplink transmission by a value of timing advance indicated by the base station from the downlink time point, a time point at which an uplink signal transmitted by the UE is received by the base station may become identical to the downlink time point of the base station. On the other hand, it is impossible to match slot timing at which the base station performs downlink transmission and slot timing at which the base station performs uplink reception through timing advance provided in the conventional LTE and 5G NR systems. This is because the propagation delay time generated in the satellite network is as large as tens of ms and thus is larger than a maximum value of timing advance provided in the conventional LTE and 5G NR systems.

A satellite navigation system may also be called a global navigation satellite system (GNSS), and the GNSS may include, for example, a GPS in the US, a GLONASS in Russia, Galileo in EU, Beidou in China, and the like. The GNSS may include a regional navigation satellite system (RNSS), and the RNSS may include, for example, IRNSS in India, QZSS in Japan, KPS in Korea, and the like. Meanwhile, a signal transmitted in the GNSS may include at least one of supplementary navigation information, a normal operation state of a satellite, a satellite time, satellite orbital power, a satellite altitude, a reference time, or information on various compensation documents.

Meanwhile, in various example embodiments of the disclosure, the NTN satellite may be a communication satellite serving to transmit a signal for the connection between the UE and the base station. Further, in various example embodiments of the disclosure, the GNSS satellite may be a satellite for transmitting a signal of the satellite navigation system. Meanwhile, the UE may receive a signal from each of one or more GNSS satellites, calculate the location of the UE itself, based on the signal received from each of the one or more GNSS satellites, and identify a reference time in each of the one or more GNSS satellites. In a case that the UE may calculate multiple locations of the UE, based on the signals received from multiple GNSS satellites, the UE may calculate the real location of the UE, based on an average of the multiple locations, a location corresponding to a received signal having the highest strength among the multiple locations, an average value of the multiple locations based on a signal strength (e.g., a method of applying a weighted value in the location corresponding to the signal having the highest signal strength), or the like. A scheme in which the UE calculates the location of the UE, based on the signals received from the multiple GNSS satellites may be implemented in various forms, and a detailed description thereof is omitted.

In various example embodiments of the disclosure, a time acquired from the GNSS or a time of the base station transferred by the base station may be, for example, based on a coordinated universal time (UTC), which is based on a time since 00:00:00 on Jan. 1, 1900 of the Gregorian calendar. This may vary depending on a type of the GNSS system, and the reference time as shown in Table 23 below may be used.

TABLE 23

| | |
|---|---|
| - | gnss-DayNumber |
| - | This field specifies the sequential number of days (with day count starting at 0) |

from the origin of the GNSS System Time as follows:

| | |
|---|---|
| - | GPS, QZSS, SBAS - Days from January 6^{th} 1980 00:00:00 UTC (USNO); |
| - | Galileo - Days from Galileo System Time (GST) start epoch, defined as 13 |

| | |
|---|---|
| seconds before midnight between 21^{st} | August and 22^{nd} |

August 1999; i.e., GST was equal to 13 seconds at August 22^{nd} 1999 00:00:00 UTC;

| | |
|---|---|
| - | GLONASS - Days from December 31^{st} 1995 21:00:00 UTC (SU), which is |

local UTC Moscow

| | |
|---|---|
| - | January 1^{st} 1996 00:00:00, defined as UTC(SU) |

+ 3 hours in [9];

| | |
|---|---|
| - | BDS - Days from January 1^{st} 2006 00:00:00 UTC (NTSC). |
| - | NavIC - Days from NavIC System Time start epoch, defined as 13 |

seconds before midnight between 21st

| | |
|---|---|
| - | August and 22nd. August 1999; i.e., NavIC System Time was equal to |

00:00:00 at August 21st, 1999

| | |
|---|---|
| - | 23:55:47 UTC (BIPM). |

In Table 23 above, NavIC may be NAVigation with Indian Constellation, QZS may be Quasi Zenith Satellite, QZSS may be Quasi-Zenith Satellite System, QZST may be Quasi-Zenith System Time, SBAS may be Space Based Augmentation System, and BDS may be BeiDou Navigation Satellite System.

Furthermore, the base station may indicate a type of the GNSS system which is a reference of the location or time information used by the base station itself through the satellite, and, for example, indications as shown in Table 24 below may be used.

TABLE 24

| Value of gnss-TO-ID | Indication |
|---|---|
| 1 | GPS |
| 2 | Galileo |
| 3 | QZSS |
| 4 | GLONASS |
| 5 | BDS |
| 6 | NavIC |
| 7-15 | reserved |

As described above, the UE may calculate a time spent while the signal is transferred from an NTN satellite to the UE, based on the location of the UE calculated by the UE and the location of the NTN satellite received from the NTN satellite and determine a TA value based on the time. If a distance from the NTN satellite to the base station on the ground or the corresponding signal is transferred to the base station on the ground via another NTN satellite when the UE determines the TA value, the UE may also consider the distance from the NTN satellite to another NTN satellite.

Unlike this, the UE may acquire reference time information from information transmitted by the GNSS satellite, compare time information transmitted by the NTN satellite with the reference time information acquired from the GNSS satellite, and calculate a time (propagation delay) required from the NTN satellite to the UE, based on the comparison result.

The location and time information of the NTN satellite may be transmitted by the base station to the UE through the SIB. The location and time information may be directly transmitted by the NTN satellite.

Assuming that the distance between the UE and the satellite or a value corresponding thereto is d_{UE,sat} (the unit is km) and the speed of light is v_{c} (the unit is km/sec), N_{TA,UE-specific} may be determined based on

$$\frac{{d}_{UE , sat}}{{v}_{c}}$$

(the unit is sec). For example,

$${N}_{TA , UE - specific} = ⌊ \frac{{d}_{UE , sat}}{{v}_{c}} \cdot \frac{1}{{T}_{c}} ⌋$$

may be determined and applied, which is a method of determining N_{TA,UE-specific} by making a value of

$$\frac{{d}_{UE , sat}}{{v}_{c}} \cdot \frac{1}{{T}_{c}}$$

into an integer. Alternatively/additionally, a method below may be used for determination and information of N_{TA,UE-specific} may be reported to the base station.
Method A1: It is determined that N_{TA,UE-specific}=(D+a)/T_{c}, D is an integer, and a is a decimal larger than or equal to 0 and smaller than 1. Here,

$$D = ⌊ \frac{{d}_{UE , sat}}{{v}_{c}} ⌋$$

$$and$$

$$a = \frac{{d}_{UE , sat}}{{v}_{c}} - ⌊ \frac{{d}_{UE , sat}}{{v}_{c}} ⌋ .$$

That is, the method may be a method of separating a propagation delay between the UE and the satellite into an integer part and a decimal part and reporting only the integer or a value corresponding thereto or separately reporting the integer or the decimal or values corresponding thereto. By using the method, it is possible to reduce the number of bits required to be reported for reporting the propagation delay. Although it has been described above that the decimal part becomes an integer multiple of T_{c}, the decimal part may be determined to be a multiple of 16·64·T_{c}/2^{μ}. Here, μ may be a current carrier, a BWP, or subcarrier spacing of a relevant CORESET. Alternatively, μ may be a value used for a transmission/reception signal such as a PDSCH or PUSCH for transmission/reception. In this case, μ=0, 1,2, 3, 4, 5 may be values corresponding to subcarrier spacing 15 kHz, 30 kHz, 60 kHz, 120 kHz, 240 kHz, and 480 kHz, respectively. Alternatively, μ may be configured by the based station to determine N_{TA,UE-specific} through higher signaling. Alternatively, a fixed value may be used for t, and for example, one of 0, 1,2, 3, 4, 5 may be fixedly used as =5.
Method A2: N_{TA,UE-specific} may be determined to be a multiple of 16·64/2^{μ}. It may be determined that

$${N}_{TA , UE - specific} = ⌊ \frac{{d}_{UE , sat}}{{v}_{c}} \cdot \frac{1}{16 \cdot 64 \cdot {T}_{c} / {2}^{μ}} ⌋ \cdot 16 \cdot 64 / {2}^{μ} .$$

In the disclosure, └x┘ may be a maximum integer which is not larger than x and may round the number down at the integer unit, that is, drop the decimal value. In the method, instead of rounding off using └x┘, round up or round off from the decimal point may be used. Here, μ may be a current carrier, a BWP, an SIB, or subcarrier spacing of a relevant CORESET. Alternatively, μ may be a value used for a transmission/reception signal such as a PDSCH or PUSCH for transmission/reception. In this case, μ=0, 1,2, 3, 4, 5 may be values corresponding to subcarrier spacing 15 kHz, 30 kHz, 60 kHz, 120 kHz, 240 kHz, and 480 kHz, respectively. Alternatively, μ may be configured by the base station to determine N_{TA,UE-specific} through higher signaling. Alternatively, a fixed value may be used for μ, and for example, μ=5 may be fixedly used. Alternatively, μ to be used for calculating N_{TA,UE-specific} may be separately configured by the base station through the SIB or higher signaling.
Method A3: It may be determined that N_{TA,UE-specific}=t_{A,UE-specific}·16·64/2^{μ}, and T_{A,UE-specific} may be determined as an integer which makes

$${N}_{TA , UA - specific}$$

$$the nearest to$$

$$\frac{{d}_{UE , sat}}{{v}_{c} \cdot {T}_{c}} .$$

Alternatively, a minimum integer satisfying

$${N}_{TA , UE - specific} \geq \frac{{d}_{UE , sat}}{{v}_{c} \cdot {T}_{c}}$$

may be determined or a maximum integer satisfying

$${N}_{TA , UE - specific} \leq \frac{{d}_{UE , sat}}{{v}_{c} \cdot {T}_{c}}$$

may be determined.
Method A4: It may be configured that N_{TA,UE-specific}=0 according to a base station configuration. This may be because UEs within the coverage in a specific beam of the satellite have little difference in propagation delays generated in a link (possibly called a service link) between the UEs and the satellite and thus uplink time synchronization may be performed by the conventional TA mechanism and N_{TA,common}. The base station may configure, through the SIB, whether the UE configures the value of N_{TA,UE-specific} as N_{TA,UE-specific}=0 or the UE uses the value of N_{TA,UE-specific} calculated based on the locations of the satellite and the UE and the speed of light according to a GNSS signal. For another example, the base station may configure, through the SIB or separate RRC signaling, whether the UE continuously uses the value of N_{TA,UE-specific} calculated based on a time point at which a PRACH preamble is transmitted based on the locations of the satellite and the UE and the speed of light according to the GNSS signal until there is a separate indication or configuration or uses a newly calculated value of N_{TA,UE-specific} at every uplink transmission time point. That is, the value of N_{TA,UE-specific} may be determined as described below through Equation 5 above.

N_{TA,UE-specific} is UE self-estimated TA to pre-compensate for the service link delay if configured, and N_{TA,UE-specific} is 0 otherwise.

Method A1 to method A4 are merely example methods of determining N_{TA,UE-specific}, based on the distance between the UE and the satellite (or a value corresponding thereto) and the speed of light, and there may be more various methods. For example, generally, in a case that the value of N_{TA,UE-specific} is defined as an integer or an expression based on an integer is defined,

$$⌊ \frac{{d}_{UE , sat}}{{v}_{c}} \cdot \frac{1}{{T}_{c}} \cdot \frac{1}{K} ⌋ \cdot K ,$$

$$d = ⌊ \frac{{d}_{UE , sat}}{{v}_{c}} \cdot \frac{1}{K} ⌋ \cdot K ,$$

or the like may be generally expressed to indicate the value of K as a multiple of a specific integer or rational number. K may be a predetermined value or a value determined by signaling parameters. Method 2 corresponds to the case of K=16·64/2^{μ}, and K may be determined according to at least one of the system parameters μ and T_{c}. The method has an advantage of expressing more various values through the same bit signaling instead of having a characteristic of sparse granularity of values of N_{TA,UE-specific}. Furthermore, in each of the methods, the values may be determined based on round up (┌x┐) or round off Round(x) operations from the decimal place instead of using the round down operation such as └x┘.

### Fourth Example Embodiment

The fourth example embodiment provides a method by which the base station transmits N_{TA,common} described through the first example embodiment and the second example embodiment to the UE and the UE performs calculations and application.

Hereinafter, methods by which the base station transfers N_{TA,common} information to the UE using configuration and indication are described, and one or more of the methods may be combined and applied.
Method B1: The base station may configure one offset value in the UE through RRC signaling. The configured value is T_{A,common} and N_{TA,common} may be determined based on same.
Method B2: The base station may indicate one offset value in the UE through a MAC CE. The configured value is T_{A,common}, and N_{TA,common} may be determined based on same. The method has an advantage compared to method B1 in that the base station and the UE may define a time point at which the base station and the UE apply N_{TA,common}. By way of example, N_{TA,common} may be applied after a predetermined time based on a time point at which the MAC CE is received or a time point at which ACK is transmitted in response of reception of the MAC CE. For example, the base station may transfer T_{A,common} in unit of msec through a 8-bit MAC CE and indicate 0 ms to 255 ms. Here, N_{TA,common} is determined as N_{TA,common}=T_{A,common}/(1000·T_{c})
Method B3: The base station may configure one or more offset values in the UE through higher-layer signaling. Alternatively, the values may be pre-configured. The configured values may become candidate values of T_{A,common}, and the base station may indicate one of the candidate values through a MAC CE.
Method B4: The base station may configure one offset value in the UE through an SIB. The configured value is T_{A,common}, and N_{TA,common} may be determined based on same. The UE calculates and applies TA by using the value when transmitting a PRACH preamble in an initial access process. Thereafter, ΔT_{A,common} may be indicated to the UE through a MAC CE, and the UE may calculate an amount of the change in N_{TA,common} using the same, thereby calculating as N_{TA,common(new)}+N_{TA,common(old)}+(ΔT_{A,common}−x)·y. In the above, x and y may be determined according to the number of bits and the unit for transfer of ΔT_{A,common}. For example, it may be determined that N_{TA,common(new)}=N_{TA,common(old)}+(ΔT_{A,common}−M)·16·64/2^{μ}. Here, a value of M may be 31, or may be a value larger than or equal to 31 when a maximum value of ΔT_{A,common} which may be indicated through the MAC CE is larger than 63, and may be a value equal to or smaller than 31 when the maximum value of ΔT_{A,common} is smaller than 63.
Method B5: The base station may indicate one offset value in the UE through a MAC CE. The configured value is T_{A,common}, and N_{TA,common} may be determined based on same. The method has an advantage compared to method B1 in that time points at which the base and the UE apply N_{TA,common} may be defined. By way of example, N_{TA,common} may be applied after a predetermined time based on a time point at which the MAC CE is received or a time point at which ACK is transmitted in response of reception of the MAC CE. For example, the base station may transmit T_{A,common} in units of 16·64·T_{c}/2^{μ} sec through a MAC CE of about 19 bits or 24 bits. Here, N_{TA,common} is determined as N_{TA,common}=T_{A,common}16·64/2^{μ}. The number of bits of the MAC CE is merely an example and another value may be applied.
Method B6: The base station may indicate one offset value in the UE through a MAC CE. The configured value is T_{A,common}, and N_{TA,common} may be determined based on an altitude of the satellite. The method has an advantage compared to method B5 in that the number of bits to be transmitted may be reduced. For example, the base station may transmit T_{TA,common} in units of 16·64·T_{c}/2^{μ} sec through a MAC CE of about 16 bits. Here, N_{TA,common} is determined as

$${N}_{TA , common} = \frac{{h}_{sat}}{{v}_{c}} \cdot \frac{1}{{τ}_{c}} + {T}_{A , common} \cdot 16 \cdot 64 / {2}^{μ} .$$

In the above, hₛₐₜ is an altitude of the satellite. This may mean that when the satellite is a specific altitude, the minimum distance between the UE and the satellite is the specific altitude and thus the base station signals only the remaining additional distance through T_{A,common}. The number of bits of the MAC CE is merely an example and another value may be applied. In the above equation, a value of

$$\frac{{h}_{s a t}}{{v}_{c}} \cdot \frac{1}{{τ}_{c}}$$

may be defined to be an integer or a rational number through a method similar to the third example embodiment. For example, various integer or rational number schemes may be applied based on a value of hₛₐₜ rather than a value of d_{UE,sat} in the third example embodiment as well as the integer or rational number using the round down operation such as

$$⌊ \frac{{h}_{s a t}}{{v}_{c}} \cdot \frac{1}{{τ}_{c}} ⌋ ,$$

$$⌊ \frac{{h}_{s a t}}{{v}_{c}} \cdot \frac{1}{{τ}_{c}} \cdot \frac{1}{K} ⌋ \cdot K ,$$

$$or$$

$$⌊ \frac{{h}_{s a t}}{{v}_{c}} \cdot \frac{1}{K} ⌋ \cdot K .$$

Of course, an integer scheme or a rational number scheme similar to the above description may be applied to a total value of

$$\frac{{h}_{s a t}}{{v}_{c}} \cdot \frac{1}{{τ}_{c}} + {τ}_{A , common} \cdot 16 \cdot 64 / {2}^{μ} .$$

For example, it may be defined that

$${N}_{TA , common} = \{ lfroor \frac{{h}_{sat}}{{v}_{c}} \cdot \frac{1}{{τ}_{c} \cdot 16 \cdot 64 / {2}^{μ}} ⌋ + {T}_{A , common} \} \cdot 16 \cdot 64 / {2}^{μ} ,$$

and this case is the same scheme as the case considering K=16·64/2^{μ} in

$$⌊ \frac{{h}_{s a t}}{{v}_{c}} \cdot \frac{1}{{τ}_{c}} \cdot \frac{1}{K} ⌋ \cdot K .$$

Further, for the operation used for the integer scheme or the rational number scheme, various other operations such as round up and round off as well as round down may be applied.
Method B7: The base station may transmit the value of N_{TA,common} at the time point of reception thereof through the SIB and information on a rate of the change in N_{TA,common}. The information may be transmitted to a specific UE through RRC signaling rather than the SIB, and the transmission method may vary depending on a state of the UE (RRC_idle, RRC_inactive, or RRC_connected). The information on the rate of the change in N_{TA,common} may be transmitted through one, two, or three parameters by the SIB. By way of example, assuming that the information on the change is transmitted through one parameter A, a time point at which N_{TA,common} is transmitted through the SIB is t1, and a time point at which uplink transmission is performed is t2, N_{TA,common(t2)} which is N_{TA,common} to be applied by the UE at t2 may be calculated as N_{TA,common(t2)}=N_{TA,common(t1)}+(t2−t1)·A. Here, units of t1 and t2 may be msec, and the unit of A may be Tc/msec. That is, A may indicate how many Tcs per 1 msec the value of N_{TA,common} has changed. For another example, assuming that the information on the change is transmitted through two parameters A and B, a time point at which N_{TA,common} is transmitted through the SIB is t1, and a time point at which uplink transmission is performed is t2, N_{TA,common(t2)} which is N_{TA,common} to be applied by the UE at t2 may be calculated as N_{TA,common(t2)}=N_{TA,common(t1)}+(t2−t1)²·B+(t2−t1)·A. (When the information on the rate of the change is transmitted through n parameters, it is possible to express in the form of an nth order polynomial with respect to difference t2−t1 between the two time points). Here, units of t1 and t2 may be msec, the unit of A may be T_{c}/msec, and the unit of B may be Tc/msec\hat{ }2. That is, A may indicate how many Tcs per 1 msec the value of N_{TA,common} has changed and B may indicate how many Tcs per 1 msec the rate of the change in N_{TA,common} value has changed. The UE may calculate an actual value of N_{TA,common} using a change rate of N_{TA,common} a first differential value (it may also be a second differential value of N_{TA,common}) of the change rate of N_{TA,common} or an instantaneous change rate, a second differential value (it may also be a third differential value of N_{TA,common}) of the change rate of N_{TA,common} or an instantaneous change rate, or the like. As such, in a case of determining N_{TA,common(t2)}, based on a nth order polynomial, an accurate polynomial may be defined based on information such as coefficients or derivatives (or the change rate, a differential value of the change rate, or an average change rate, etc.) for each term in the polynomial and the UE may calculate a value of N_{TA,common} assuming of 0 except for a value transferred from the base station. Of course, even in a case that a reference value or a value serving as a constant term, such as N_{TA,common}(tₗ), is not received, the value may be assumed to be 0 to calculate the value of N_{TA,common}.

### Fifth Example Embodiment

The fifth example embodiment provides a method and a device in which the base station transmits K_offset (K_{offset}) which is a parameter for determining timing at which the UE transmits a second signal in response to a first signal transmitted by the base station to the UE.

The base station transmits the first signal and indicates a time point at which the UE transmits the second signal corresponding thereto through higher signaling and DCI. For example, a PDSCH is transmitted and HARQ-ACK feedback therefor may be indicated by an HARQ-ACK timing-related indicator of bit fields of the DCI scheduling the PDSCH. However, in the satellite communication, a delay time between the UE and the base station is very large, and thus the offset value indicated by the conventional DCI may not indicate correct timing. Accordingly, the base station may transmit K_offset which is an additional timing offset to the UE through the SIB, and the UE may determine transmission timing of the second signal (uplink transmission) by adding the offset K_offset. The base station may update the K_offset value to the UE through RRC signaling in an RRC_connected state after initial access of the UE. However, when the update is performed only through RRC signaling, the base station and the UE may have different K_offset during a time interval in which an RRC reconfiguration is performed. In this case, the transmission and reception of the second signal may not be correctly performed. In order to remove such an ambiguity time interval, the base station may configure multiple values of K_offset in the UE and indicate one of the configured values of K_offset through a MAC CE. Accordingly, the UE may apply the updated K_offset value from a determined time point after the MAC CE is received.

For example, candidate values of K_offset values may be configured according to indexes shown in Table 25 below through RRC signaling.

TABLE 25

| index | K_offset |
|---|---|
| 0 | 100 |
| 1 | 120 |
| 2 | 140 |
| 3 | 160 |
| 4 | 180 |
| 5 | 200 |
| 6 | 220 |
| 7 | 240 |

[Table 25] shows an example in which K_offset is configured at regular intervals through 8 indexes and various other configurations are possible. When values of the index i are 0, 1, 2, . . . , 2^{M}−1 and thus the number of values is 2^{M} (M corresponding to an integer such as 2, 3, 4, . . . ) and when a value of K_offset in the case of index i is K_offset(i), it may be defined to have values at uniform intervals such as K_offset(i)=K_offset(0)+(i−1)*A (A corresponding to a positive constant) for i>0. Of course, a value of M may be variable according to a system configuration, and a value of A may also be variably configured according to the value of M. Further, some of the indexes may be defined as a reserved field. When a maximum value of K_offset except for the reserved field is K_offset(imax), the relation of A=(K_offset(imax)−K_offset(0))/imax may be possible.

This is merely an example configured of values having a uniform difference, and, generally, A may not be configured of values of uniform differences as a whole. For example, values having different differences may be configured according to an index range. (a value of i_m may be simply configured as 2^{M-1} or generally configured as another integer value.)
1≤i<i_m,
K_offset(i) K_offset(0)+(i−1)*A1
i_m≤i≤i_max,
K_offset(i)=K_offset(i_m)+(i−i_m)*A2
A1 and A2 are different positive constants, and A1=(K_offset(i_m−1)−K_offset(0))/(i_m−1), and A2=(K_offset(i_max)−K_offset(i_m))/(i_max−i_m).

Thereafter, the base station may transmit an index to the UE in slot n through a MAC CE, and the UE may transmit the second signal by applying K_offset indicated in slot n+k. A value of k may be configured or may be determined according to subcarrier spacing.

### Sixth Example Embodiment

The sixth example embodiment provides a method and a device for determining a time point at which the UE transmits a PRACH.

In a conventional NR system, the UE may generate and transmit an OFDM signal transmitting a PRACH as described below. The time-continuous signal s_{I}^{(p,μ)}(t) on antenna port p for PRACH is defined by

$${s}_{l}^{( p , μ )} ( t ) = {\sum }_{k = 0}^{{L}_{R A} - 1} {a}_{k}^{( p , RA )} {e}^{j 2 π ( k + K {k}_{1} + \overline{k} ) Δ {f}_{R A} ( t - {N}_{CP , l}^{R A} {T}_{c} - {t}_{start}^{R A} )}$$

$$K = Δ f / Δ {f}_{R A}$$

$${k}_{1} = {k}_{0}^{μ} + ( {N}_{B WP , i}^{start} - {N}_{grid}^{start , μ} ) {N}_{sc}^{R B} - {N}_{grid}^{size , μ} {N}_{s c}^{R B} / 2 + {n}_{R A}^{start} {N}_{sc}^{R B} + \{ \begin{matrix}{n}_{R A} {N}_{R B}^{R A} {N}_{sc}^{R B} & if {L}_{R A} ∈ \{ 139 , 839 \} \\ ( {N}_{RB , UL , {n}_{0} + {n}_{RA}}^{start , μ} - {N}_{RB , UL , {n}_{0}}^{start , μ} ) {N}_{s c}^{R B} & if {L}_{R A} ∈ \{ 5 \; 71 , 1151 \}\end{matrix}$$

$${k}_{0}^{μ} = ( {N}_{grid}^{start , μ} + {N}_{g r i d}^{s i ze , μ} / 2 ) {N}_{sc}^{R B} - ( {N}_{grid}^{start , {μ}_{0}} + {N}_{grid}^{size , {μ}_{0}} / 2 ) {N}_{sc}^{R B} {2}^{{μ}_{0} - μ}$$

where tₛₜₐᵣₜ^{RA}≤t<tₛₜₐᵣₜ^{RA}+(Nᵤ+N_{CP,l})T_{c}, and
k̅ is given by clause 6.3.3 of TS 38.211;
Δf is the subcarrier spacing of the initial uplink bandwidth part during initial access. Otherwise, Δf is the subcarrier spacing of the active uplink bandwidth part;
μ₀ is the largest μ value among the subcarrier spacing configurations by the higher-layer parameter scs-SpecificCarrierList;
N_{BWP,i}^{start} is the lowest numbered resource block of the initial uplink bandwidth part and is derived by the higher-layer parameter initialUplinkBWP during initial access. Otherwise, N_{BWP,i}^{start} is the lowest numbered resource block of the active uplink bandwidth part and is derived by the higher-layer parameter BWP-Uplink;
n_{RA}^{start} is the frequency offset of the lowest PRACH transmission occasion in frequency domain with respect to physical resource block 0 of the active uplink bandwidth part. The quantity n_{RA}^{start} is given by the higher-layer parameter msgA-RO-FrequencyStart if configured and a type-2 random-access procedure is initiated as described in clause 8.1 of [5, TS 38.213], otherwise by msg1-FrequencyStart as described in clause 8.1 of [5 TS 38.213];
n_{RA} is the PRACH transmission occasion index in frequency domain for a given PRACH transmission occasion in one time instance as given by clause 6.3.3.2 of TS 38.211;
N_{RB}^{RA} is the number of resource blocks occupied and is given by the parameter allocation expressed in number of RBs for PUSCH in Table 6.3.3.2-1 of TS 38.211.
N_{RB,UL,n}^{start,μ} is the start CRB index of uplink RB set n corresponding to the quantity RB_{n,UL}^{start,μ}. The UE assumes that the RB set is defined as when the UE is not provided IntraCellGuardBandsPerSCS for an UL carrier as described in Clause 7 of [6, TS 38.214]
n₀ is the index of the RB set which contains the lowest PRACH transmission occasion in frequency domain indicated by n_{RA}^{start}. The UE may assume that n_{RA}^{start} is configured such that each PRACH transmission occasion is fully contained within an RB set.
L_{RA} and Nᵤ are given by clause 6.3.3 of TS 38.211
N_{CP,l}^{RA}=N_{CP}^{RA}+n·16κ where
for Δf_{RA}∈{1.25,5}kHz, n=0
for Δf_{RA}∈{15,30,60,120}kHz, n is the number of times the interval [tₛₜₐᵣₜ^{RA}, tₛₜₐᵣₜ^{RA}+(Nᵤ^{RA}+N_{CP}^{RA})T_{c}) overlaps with either time instance 0 or time instance (ΔfₘₐₓN_{f}/2000)·T_{c}=0.5 ms in a subframe The starting position tₛₜₐᵣₜ^{RA} of the PRACH preamble in a subframe (for Δf_{RA}∈{1.25,5,15,30} kHz) or in a 60 kHz slot (for Δf_{RA}∈{60,120} kHz) is given by

$${t}_{start}^{R A} = {t}_{start , l}^{μ}$$

$${t}_{start , l}^{μ} = \{ \begin{matrix}0 & l = 0 \\ {t}_{start , l - 1}^{μ} + ( {N}_{u}^{μ} + {N}_{CP , l - 1}^{μ} ) \cdot {T}_{c} & otherwise\end{matrix}$$

where
the subframe or 60 kHz slot is assumed to start at t=0;
a timing advance value N_{TA}=0 shall be assumed;
Nᵤ^{μ} and N_{CP,l-1}^{μ} are given by clause 5.3.1 of TS 38.211;
μ=0 shall be assumed for Δf_{RA}∈{1.25, 5} kHz, otherwise it is given by Δf_{RA}∈{15, 30, 60, 120} kHz and the symbol position l is given by

l=l₀+nₜ^{RA}N_{dur}^{RA}+14nₛₗₒₜ^{RA}

where
l₀ is given by the parameter “starting symbol” in Tables 6.3.3.2-2 to 6.3.3.2-4 of TS 38.211;
nₜ^{RA} is the PRACH transmission occasion within the PRACH slot, numbered in increasing order from 0 to Nₜ^{RA,slot}−1 within a RACH slot where N^{RA}'s° is given Tables 6.3.3.2-2 to 6.3.3.2-4 of TS 38.211 for L_{RA}∈{139,571,1151} and fixed to 1 for L_{RA}=839;
N_{dur}^{RA} is given by Tables 6.3.3.2-2 to 6.3.3.2-4 of TS 38.211;
nₛₗₒₜ^{RA} is given by
if Δf_{RA}∈{1.25, 5, 15, 60} kHz, then nₛₗₒₜ^{RA}=0
if Δf_{RA}∈{30, 120} kHz and either of “Number of PRACH slots within a subframe” in Tables 6.3.3.2-2 to 6.3.3.2-3 of TS 38.211or “Number of PRACH slots within a 60 kHz slot” in Table 6.3.3.2-4 of TS 38.211 is equal to 1, then nₛₗₒₜ^{RA}=1
otherwise, nₛₗₒₜ^{RA}∈{0,1}
   If the preamble format given by Tables 6.3.3.2-2 to 6.3.3.2-4 of TS 38.211 is A1/B1, A2/B2 or A3/B3, then
if nₜ^{RA}=Nₜ^{RA,slot}−1, then the PRACH preamble with the corresponding PRACH preamble format from B1, B2 and B3 is transmitted in the PRACH transmission occasion;
otherwise the PRACH preamble with the corresponding PRACH preamble format from A1, A2 and A3 is transmitted in the PRACH transmission occasion

In the above description, t_{start,l}^{μ} may be a value indicating a time point at which the PRACH starts. In a conventional system rather than the NTN, t_{start,l}^{μ} is given when l=0. However, in NTN, since the UE may correct T_{A} with respect to a long delay time generated from the satellite communication as shown in Equation 5 above, it is possible to reflect a portion of the TA value when transmitting the PRACH. Accordingly, it may be required to transmit a PRACH by applying TA as much as the value of T_{TA} provided by Equation 7 below.

T_{TA}=N_{TA,UE-specific}+N_{TA,common})×T_{c} [Equation 7]

In Equation 7 above, Tc may be given as T_{C}=1/(Δfₘₐₓ·N_{f}), and Δfₘₐₓ=480·10³ Hz and N_{f}=4096. In Equation 7 above N_{TA,UE-specific} may be a TA correction value measured by the UE, based on locations of the UE and the satellite (or reference location), and N^{TA,common} may be a TA correction value configured or indicated using higher signaling or a physical layer signal. N^{TA,UE-specific} And N_{TA,common} may be determined through a combination of one or more of the embodiments described above.

In case of the NTN, a method of generating an OFDM signal for the PRACH transmission may adopt a value rather than 0 for t_{start,0}^{μ} as described below.
tₛₜₐᵣₜ^{RA}=t_{start,l}^{μ}

$${t}_{start}^{RA} = {t}_{start , l}^{μ}$$

$${t}_{start , l}^{μ} = \{ \begin{matrix}{T}_{T A} , l = 0 , for N T N \\ {t}_{start , l - 1}^{μ} + ( {N}_{u}^{μ} + {N}_{CP , j - 1}^{μ} ) \cdot {T}_{c} , otherwise\end{matrix}$$

In the above description, T_{TA} may be determined as Equation 7.

### Seventh Example Embodiment

The seventh example embodiment provides a method and a device for determining a start time point of ra-ResponseWindow, which corresponds to a maximum time acquired for reception, that is, a window (random access window) within which the UE transmits a random access preamble (or PRACH preamble) and receives a random access response (RAR). The UE may attempt DCI detection or the like to receive a RAR during the corresponding window period. That is, DCI reception for detecting a RAR may be omitted after the PRACH transmission before the corresponding window.

In the NR system, a start time point of the window for RAR reception (ra-ResponseWindow) may be determined as follows.

In response to a PRACH transmission, a UE attempts to detect a DCI format 1_0 with CRC scrambled by a corresponding RA-RNTI during a window controlled by higher layers [TS 38.321]. The window starts at the first symbol of the earliest CORESET the UE is configured to receive PDCCH for Type1-PDCCH CSS set, as defined in Clause 10.1 in TS 38.213, that is at least one symbol, after the last symbol of the PRACH occasion corresponding to the PRACH transmission, where the symbol duration corresponds to the SCS for Type1-PDCCH CSS set as defined in Clause 10.1 in TS 38.213. The length of the window in number of slots, based on the SCS for Type1-PDCCH CSS set, is provided by ra-ResponseWindow.

That is, the window starts from a first symbol of CORESET configured for receiving Type1-PDCCH CSS set, which appears first after at least one symbol after a last symbol that transmits the PRACH. Further, in a 2-step RACH step, the window (msgB-ResponseWindow) of the RAR may be determined as follows.

In response to a transmission of a PRACH and a PUSCH, or to a transmission of only a PRACH if the PRACH preamble is mapped to a valid PUSCH occasion, a UE attempts to detect a DCI format 1_0 with CRC scrambled by a corresponding MsgB-RNTI during a window controlled by higher layers [TS 38.321]. The window starts at the first symbol of the earliest CORESET the UE is configured to receive PDCCH for Type1-PDCCH CSS set, as defined in Clause 10.1 in TS 38.213, that is at least one symbol, after the last symbol of the PUSCH occasion corresponding to the PRACH transmission, where the symbol duration corresponds to the SCS for Type1-PDCCH CSS set. The length of the window in number of slots, based on the SCS for Type1-PDCCH CSS set, is provided by msgB-ResponseWindow.

In response to a transmission of a PRACH, if the PRACH preamble is not mapped to a valid PUSCH occasion, a UE attempts to detect a DCI format 1_0 with CRC scrambled by a corresponding MsgB-RNTI during a window controlled by higher layers [TS 38.321]. The window starts at the first symbol of the earliest CORESET the UE is configured to receive PDCCH for Type1-PDCCH CSS set, as defined in Clause 10.1 in TS 38.213, that is at least one symbol, after the last symbol of the PRACH occasion corresponding to the PRACH transmission, where the symbol duration corresponds to the SCS for Type1-PDCCH CSS set. The length of the window in number of slots, based on the SCS for Type1-PDCCH CSS set, is provided by msgB-ResponseWindow.

However, in the satellite communication system like the NTN, a delay time between the UE and the base station is very large, and thus it may take a very long time for the UE to transmit the PRACH and receive the RAR therefor. In the case of the LEO satellite, the RAR may be received after several tens of ms, and in the case of the GEO satellite, the RAR may be received after hundreds of ms. Therefore, it may be necessary to postpone the start time point of the window (ra-ResponseWindow or window having a length of msgB-ResponseWindow) for receiving the RAR. To this end, the start time point of the window may be applied as described below.

The window starts at the first symbol of the earliest CORESET the UE is configured to receive PDCCH for Type1-PDCCH CSS set, as defined in Clause 10.1 in TS 38.213, that is at least one symbol added by T_{TA}, after the last symbol of the PRACH occasion corresponding to the PRACH transmission, where the symbol duration corresponds to the SCS for Type1-PDCCH CSS set as defined in Clause 10.1 in TS 38.213, where T_{TA} is given by
T_{TA}=(N_{TA,UE-specific}+N_{TA,common})×T_{c}.

That is, the window may start from a first symbol of CORESET configured for receiving Type1-PDCCH CSS set, which exists first after at least one symbol after a last symbol that transmits the PRACH. Further, in a 2-step RACH step, the window (msgB-ResponseWindow) of the RAR may be determined as follows. This is because a round trip time of a signal between the base station and the UE may be considered as. When the base station configures and applies an additional offset value, the application may be performed as follows.

The window starts at the first symbol of the earliest CORESET the UE is configured to receive PDCCH for Type1-PDCCH CSS set, as defined in Clause 10.1 in TS 38.213, that is at least one symbol added by T_{TA}+T_{offset}^{RA}, after the last symbol of the PRACH occasion corresponding to the PRACH transmission, where the symbol duration corresponds to the SCS for Type1-PDCCH CSS set as defined in Clause 10.1 in TS 38.213, where T_{TA} is given by T_{TA}=(N_{TA,UE-specific}+N_{TA,common})×T_{c}
and T_{offset}^{RA} is given by higher layer signaling.

That is, the window starts from a first symbol of CORESET configured for receiving Type1-PDCCH CSS set, which appears first after at least one symbol+T_{TA}+T_{offset}^{RA} after a last symbol that transmits the PRACH. Further, in a 2-step RACH step, the window (msgB-ResponseWindow) of the RAR may be determined as follows. This is because a round trip time of a signal between the base station and the UE may be considered as T_{TA}+T_{offset}^{RA}. In the above, T_{offset}^{RA} may be a value transferred through the SIB.

Although, it is configured that the time required for a round trip of a signal between the base station and the UE is T_{TA} or T_{TA}+T_{offset}^{RA}, the time may be determined according to an integer time of T_{TA}, such as kT_{TA} or kT_{TA}+T_{offset}^{RA} (k>=2) and a start time point of the window is determined based on the value. This may follow the system configuration, a method or definition for determining T_{TA}. Furthermore, for reference, the TA value or each value related to the TA may be referred to as a value applied at the time of PRACH and in some cases may be referred to as a value having applied before that time.

The first example embodiment to the seventh example embodiment of the disclosure have been separately described for convenience of description, but the respective embodiments include operations associated with each other, and thus two or more embodiments may be combined. Further, methods of the respective embodiments are not mutually exclusive, and one or more methods may be combined and performed.

The transmission and reception method of the base station, the satellite, and the UE or a transmission terminal or a reception terminal for performing the embodiments of the disclosure is described, and a receiver, a processor, and a transmitter of the base station, the satellite, and the UE should operate according to each embodiment.

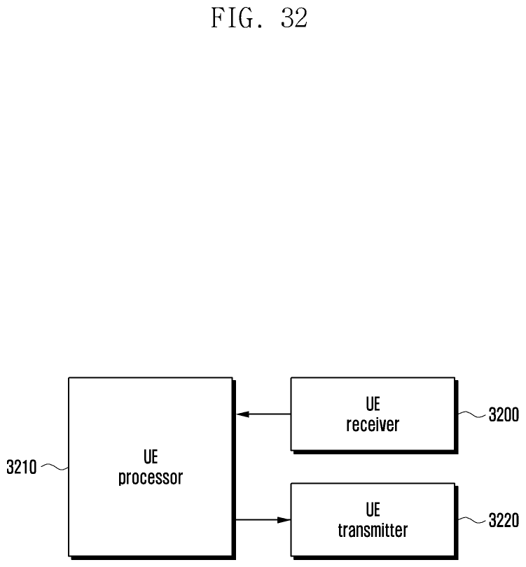

More specifically, FIG. 32 is a block diagram illustrating an internal structure of a UE according to an embodiment of the disclosure. As shown in FIG. 32, the UE of the disclosure may include a UE receiver 3200, a UE transmitter 3220, and a UE processor 3210. The UE receiver 3200 and the UE transmitter 3220 may be collectively referred to as a transceiver in an embodiment of the disclosure. The transceiver may transmit or receive a signal to or from a base station. Here, the signal may include control information and data. To this end, the transceiver may include an RF transmitter configured to up-convert and amplify the frequency of the transmitted signal, an RF receiver configured to amplify the received signal with low noise and down-convert the frequency, and the like. In addition, the transceiver may receive a signal through a wireless channel, output the signal to the UE processor 3210, and transmit a signal output from the UE processor 3210 through the wireless channel. The UE processor 3210 (including, e.g., processing circuitry) may control a series of processes so that the UE operates according to the above-described embodiment of the disclosure. For example, the UE receiver 3200 may receive a signal from the satellite or the ground base station and a signal from the GNSS, and the UE processor 3210 may transmit and receive a signal to the base station according to the method described in the disclosure. Thereafter, the UE transmitter 3220 may transmit a signal using a determined time point.

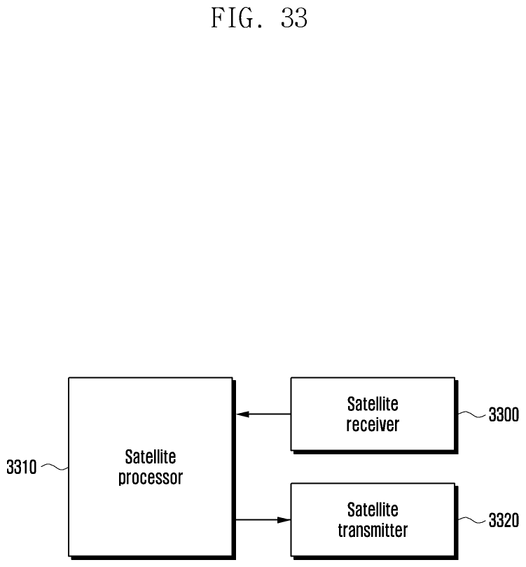

FIG. 33 is a block diagram illustrating an internal structure of a satellite according to an embodiment of the disclosure. As shown in FIG. 33, the satellite of the disclosure may include a satellite receiver 3300, a satellite transmitter 3320, and a satellite processor 3310. The receiver, the transmitter, and the processor may be plural. That is, a receiver and a transmitter for transmitting and receiving a signal to and from the UE and a transmitter and a receiver for transmitting and receiving a signal to and from the base station (and a receiver and a transmitter for transmitting and receiving a signal to and from another satellite) may be configured. The satellite receiver 3300 and the satellite transmitter 3320 may be collectively referred to as a satellite transceiver in an embodiment of the disclosure. The transceiver may transmit or receive a signal to or from the UE and the base station. Here, the signal may include control information and data. To this end, the transceiver may include an RF transmitter configured to up-convert and amplify the frequency of the transmitted signal, an RF receiver configured to amplify the received signal with low noise and down-convert the frequency, and the like. In addition, the transceiver may receive a signal through a wireless channel, output the signal to the satellite processor 3310, and transmit a signal output from the satellite processor 3310 through the wireless channel. The satellite processor 3310 (including, e.g., processing circuitry) may include a compensator (pre-compensator) for compensating for a frequency offset or Doppler shift and a device capable of tracking locations through a GPS or the like. Further, the satellite processor 3310 may include a frequency shift function for moving a center frequency of the reception signal. The satellite processor 3310 may control a series of processes so that the satellite, the base station, and the UE operate according to the above-described embodiments of the disclosure. For example, the satellite receiver 3300 may receive a PRACH preamble from the UE and transmit an RAR according thereto to the UE again, thereby determining transmission of TA information to the base station. Thereafter, the satellite transmitter 3320 may transmit corresponding signals at a determined time point.

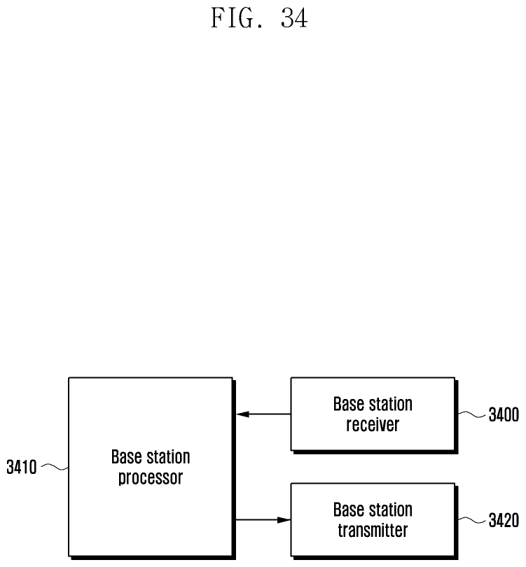

FIG. 34 is a block diagram illustrating an internal structure of a base station according to an embodiment of the disclosure. As shown in FIG. 34, the base station of the disclosure may include a base station receiver 3400, a base station transmitter 3420, and a base station processor 3410. The base station may be the ground base station or a part of the satellite. The base station receiver 3400 and the base station transmitter 3420 may be collectively referred to as a transceiver in an embodiment of the disclosure. The transceiver may transmit or receive a signal to or from a UE. Here, the signal may include control information and data. To this end, the transceiver may include an RF transmitter configured to up-convert and amplify the frequency of the transmitted signal, an RF receiver configured to amplify the received signal with low noise and down-convert the frequency, and the like. In addition, the transceiver may receive a signal through a wireless channel, output the signal to the base station processor 3410, and transmit a signal output from the based station processor 3410 through the wireless channel. The base station processor 3410 (including, e.g., processing circuitry) may control a series of processes so that the base station operates according to the above-described embodiment of the disclosure. For example, the base station processor 3410 may transmit an RAR including TA information.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. Furthermore, the above respective embodiments may be employed in combination, as necessary. In addition, other variants of the above embodiments, based on the technical idea of the embodiments, may also be implemented in LTE systems, 5G systems, or the like.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. A method performed by a user equipment (UE) in a non-terrestrial network (NTN) system, the method comprising:
receiving, from a base station, system information comprising at least one of position information of a satellite connected to the UE or information on a common timing advance (TA) offset;
determining a specific TA offset corresponding to a distance between the UE and the satellite;
determining a TA value, based on at least one of the common TA offset or the specific TA offset;
determining a transmission start time point of a preamble, based on the determined TA value; and
transmitting the preamble to the base station, based on the determined transmission start time point.

2. The method of claim 1, further comprising:
determining a start time point of a reception window with respect to a random access response (RAR) based on a multiple of the determined TA value; and
monitoring reception of the RAR on the reception window, based on the determined start time point.

3. The method of claim 1, wherein the distance between the UE and the satellite is determined based on position information of the satellite and position information of the UE,
wherein the position information of the satellite comprises at least one of orbit information of the satellite, altitude information of the satellite, or altitude angle information of the satellite, and
wherein the position information of the UE is determined based on signals received from multiple satellites.

4. The method of claim 1, further comprising transmitting, to the base station, message 3 on a physical uplink shared channel (PUSCH), based on a first TA value,
wherein the first TA value is determined based on the TA value and TA variation information included in the random access response (RAR), and
wherein message 3 comprises information on the first TA value.

5. The method of claim 1, further comprising receiving, from the base station, a radio resource control (RRC) message comprising at least one of information on a reference time point of TA report or information on a condition for the TA report,
wherein the condition for the TA report corresponds to a threshold value related to the distance between the UE and the satellite, and
wherein the TA report is performed in a case that the distance between the UE and the satellite exceeds the threshold value.

6. A user equipment (UE) in a non-terrestrial network (NTN) system, the UE comprising:
a transceiver configured to transmit or receive a signal; and
a processor connected to the transceiver,
wherein the processor is configured to:
receive, from a base station, system information comprising at least one of position information of a satellite connected to the UE or information on a common TA offset;
determine a specific TA offset corresponding to a distance between the UE and the satellite;
determine a TA value, based on at least one of the common TA offset or the specific TA offset;
determine a transmission start time point of a preamble, based on the determined TA value; and
transmit the preamble to the base station, based on the determined transmission start time point.

7. The UE of claim 6, wherein the processor is further configured to:
determine a start time point of a reception window with respect to a random access response (RAR) based on a multiple of the determined TA value; and
monitor reception of the RAR on the reception window, based on the determined start time point.

8. The UE of claim 6, wherein the distance between the UE and the satellite is determined based on position information of the satellite and position information of the UE,
wherein the position information of the satellite comprises at least one of orbit information of the satellite, altitude information of the satellite, or altitude angle information of the satellite, and
wherein the position information of the UE is determined based on signals received from multiple satellites.

9. The UE of claim 6, wherein the processor is further configured to transmit, to the base station, message 3 on a physical uplink shared channel (PUSCH), based on a first TA value,
wherein the first TA value is determined based on the TA value and TA variation information included in the random access response (RAR), and
wherein message 3 comprises information on the first TA value.

10. The UE of claim 6, wherein the processor is further configured to receive, from the base station, a radio resource control (RRC) message comprising at least one of information on a reference time point of TA report or information on a condition for the TA report,
wherein the condition for the TA report corresponds to a threshold value related to the distance between the UE and the satellite, and
wherein the TA report is performed in a case that the distance between the UE and the satellite exceeds the threshold value.

11. A method performed by a base station in a non-terrestrial network (NTN) system, the method comprising:
transmitting, to a user equipment (UE), system information comprising at least one of position information of the satellite connected to the UE or information on a common timing advance (TA) offset; and
receiving a preamble from the UE,
wherein the preamble is transmitted from the UE according to a transmission start time point determined based on a TA value,
wherein the transmission start time point is determined based on at least one of the common TA offset or a specific TA offset with respect to the UE, and
wherein the specific TA offset corresponds to a distance between the satellite and the UE.

12. The method of claim 11, further comprising transmitting a random access response (RAR) to the UE,
wherein a start time point of a reception window with respect to the random access response (RAR) is determined based on a multiple of the TA value.

13. The method of claim 11, wherein the distance between the UE and the satellite is determined based on position information of the satellite and position information of the UE,
wherein the position information of the satellite comprises at least one of orbit information of the satellite, altitude information of the satellite, and altitude angle information of the satellite, and
wherein the position information of the UE is determined by the UE, based on signals of multiple satellites.

14. The method of claim 11, further comprising receiving, from the UE, message 3 on a physical uplink shared channel (PUSCH),
wherein message 3 is transmitted based on a first TA value,
wherein the first TA value is determined based on the TA value and TA variation information included in the random access response (RAR), and
wherein message 3 comprises information on the first TA value.

15. The method of claim 11, further comprising transmitting, to the UE, a radio resource control (RRC) message comprising at least one of information on a reference time point of TA report or information on a condition for the TA report,
wherein the condition for the TA report corresponds to a threshold value related to the distance between the UE and the satellite, and
wherein the TA report is performed in a case that the distance between the UE and the satellite exceeds the threshold value.

16. A base station in a non-terrestrial network (NTN) system, the base station comprising:
a transceiver configured to transmit or receive a signal; and
a processor connected to the transceiver,
wherein the processor is configured to:
transmit, to a user equipment (UE), system information comprising at least one of position information of the satellite connected to the UE or information on a common timing advance (TA) offset, and
receive a preamble from the UE,
wherein the preamble is transmitted from the UE according to a transmission start time point determined based on a TA value,
wherein the transmission start time point is determined based on at least one of the common TA offset or a specific TA offset with respect to the UE, and
wherein the specific TA offset corresponds to a distance between the satellite and the UE.

17. The base station of claim 16, further comprising transmitting a random access response (RAR) to the UE,
wherein a start time point of a reception window with respect to the random access response (RAR) is determined based on a multiple of the TA value.

18. The base station of claim 16, wherein the distance between the UE and the satellite is determined based on position information of the satellite and position information of the UE,
wherein the position information of the satellite comprises at least one of orbit information of the satellite, altitude information of the satellite, and altitude angle information of the satellite, and
wherein the position information of the UE is determined by the UE, based on signals of multiple satellites.

19. The base station of claim 16, further comprising receiving, from the UE, message 3 on a physical uplink shared channel (PUSCH),
wherein message 3 is transmitted based on a first TA value,
wherein the first TA value is determined based on the TA value and TA variation information included in the random access response (RAR), and
wherein message 3 comprises information on the first TA value.

20. The base station of claim 16, further comprising transmitting, to the UE, a radio resource control (RRC) message comprising at least one of information on a reference time point of TA report or information on a condition for the TA report,
wherein the condition for the TA report corresponds to a threshold value related to the distance between the UE and the satellite, and
wherein the TA report is performed in a case that the distance between the UE and the satellite exceeds the threshold value.
